(19) United States
(12) Patent Application Publication
(10) Pub. No.: US 2004/0043901 A1
(43) Pub. Date: Mar. 4, 2004

(54) Thermal recording material

(75) Inventor: Makoto Ono, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/646,747

(22) Filed: Aug. 25, 2003

(30) Foreign Application Priority Data
Aug. 26, 2002 (JP) 2002-244816
Mar. 19, 2003 (JP) 2003-75601
Aug. 27, 2002 (JP) 2002-246952
Aug. 28, 2002 (JP) 2002-248295

(51) Int. Cl. B41M 5/30

(52) U.S. Cl. 503/200

(57) ABSTRACT

The invention provides a thermal recording material comprising, on a support, at least a thermal recording layer and a protective layer containing a water-soluble resin, wherein the thermal recording material includes a water-soluble or oil-soluble compound of a transition element of the group 4, and preferably, the protective layer includes ultrafine inorganic particles and the compound of transition element of a group 4 is a water-soluble zirconium compound.

### CROSS-REFERENCE TO RELATED APPLICATIONS

This application claims priority under 35 USC 119 from Japanese Patent Application (JP-A) No. 2002-244816, No. 2003-75601, No. 2002-246952 and No. 2002-248295, the disclosures of which are incorporated by reference herein.

### BACKGROUND OF THE INVENTION

1. Field of the Invention

The present invention relates to a thermal recording material for recording an image with a thermal head, more particularly, to a thermal recording material adapted for recording images multiple times on the same surface under high-speed and high-energy conditions.

2. Description of the Related Art

The need for thermal recording systems is expanding in the fields of various recording technologies such as facsimiles, printers, and labeling devices, and accompanying that need is a demand for thermal recording materials of higher performance.

Thermal recording is recently showing remarkable expansion because the recording apparatuses therefor are simple, highly reliable and practically maintenance-free. Well-known thermal recording materials for such systems include a material utilizing the reaction of an electron donating colorless dye and an electron accepting compound, or a material utilizing the reaction of a diazonium compound and a coupler.

In thermal recording materials for image recording by imagewise heating with a thermal head, it is important that the materials not only have properties matching the thermal head, the material and the shape of the protective film of the thermal head, but that they also stably produce high-quality images over a prolonged period of time without generating dirt or abrasions in the thermal head.

A protective layer is often provided on an outermost print surface of a thermal recording material, therefore, the suitability of a thermal recording material is often determined by its performance in relations to the protective layer of the thermal head. The glossiness of the thermal recording material can be improved to a certain extent by increasing the content of the hardening agent in the protective layer. However, if the amount of hardening agent exceeds a certain level, this results in the drawback of deteriorating the surface condition of the image recording surface (causing surface coarseness), thereby deteriorating surface gloss.

Various investigations and improvements have been made for protective layers. For example, the addition of a pigment is considered effective for preventing a protective layer from sticking to the thermal head, and improving the image recording property. It is also considered necessary to increase the proportion of the pigment or to increase the particle size of the pigment, in order to reduce dirt or smudging in the thermal head. However, an increase in the proportion or particle size of the pigment results in a loss of glossiness due to decreased surface smoothness of the protective layer, thereby leading to quality deterioration. Further, when a diazo compound is employed as a color forming agent, the permeability of gases such as oxygen increases, which in turn causes an increase in unwanted background coloration when the material is exposed to light.

Moreover, when high-speed printing is executed while the interior of the printing apparatus is cold, for example, at the start of a printing operation, water drops condensed on the surface of the thermal head may stick to the outermost print surface. Such water drops sticking to the outermost print surface cause gloss unevenness, thus constituting a factor in image quality deterioration.

It has therefore been a major issue to provide a thermal recording material capable of realizing high surface gloss and improved color forming sensitivity, and able to stably provide high-quality images.

In order to solve these issues, JP-A No. 2002-307834 proposes a thermal recording material with improved glossiness realized by including a long-chain alkyl ether-modified polyvinyl alcohol and ultrafine inorganic particles of two or more kinds with different particle sizes in the protective layer. However, even such a thermal recording material does not provide adequate surface conditions for the image.

In order to improve the glossiness of thermal recording materials, it is important to improve the smoothness of the protective layer, which constitutes the outermost print surface. However, an increase in the surface smoothness of the protective layer increases frictional force with the thermal head, thereby elevating the printing torque. The term printing torque refers to a dynamic friction coefficient when printing with a thermal head. An elevated printing torque results in unevenness in developed color density when printing, or what is also referred to as unevenness due to loading change, thereby deteriorating the image quality.

It is therefore important to reduce the printing torque in order to record a high-quality image. Printing torque can be lowered to a certain extent by increasing the amount of lubricant, or by increasing the hardness of the protective layer. However, an increased amount of the lubricant induces, when printing, a large deformation resulting from plasticization of the thermal recording material surface, thereby deteriorating the surface gloss. Also, an increased amount of hardening agent for the binder can elevate the hardness of the protective layer, however, it also lowers the hydrophobicity of the protective layer, whereby the lubricant on the surface of the protective layer tends to diffuse when printing and cannot be retained on such a surface. Decreased lubricant on the surface of the protective layer results in a coarse surface, whereby torque cannot be reduced and the glossiness of the thermal recording material deteriorates.

In contrast to an ordinary monochromatic thermal recording material, a full-color thermal recording material is subjected to three consecutive printing operations on the same surface, under high-speed and high-energy conditions. Therefore, the surface temperature of the thermal head reaches a high temperature and the lubricant on the surface of the thermal recording material decreases when printing, and dirt or smudging tends to be generated in the thermal head. Moreover, when considering quality, it is difficult to adopt the aforementioned known technologies (such as increasing the proportion of the pigment or increasing the particle size of the pigment), in order to achieve high surface gloss and low background coloration by exposure to light.

### SUMMARY OF THE INVENTION

A first object of the present invention is to provide a thermal recording material having excellent water-resistance and high glossiness, being capable of preventing deterioration in the surface condition of an image, and stably providing a high-quality image.

A second object of the invention is to provide a thermal recording material capable of recording a high-quality image while maintaining high glossiness, even when multiple printing operations on the same surface at high speed and under high energy.

A third object of the invention is to provide a thermal recording material having high glossiness and the capability to prevent dirtying of the thermal head, thereby improving the durability of the thermal head and stably providing high-quality images.

The aforementioned objects can be attained in following manner.

In the first aspect, the present invention provides a thermal recording material comprising, on a support, at least a thermal recording layer and a protective layer containing a water-soluble resin, wherein the thermal recording material comprises a water-soluble or oil-soluble compound of a transition element of the group IV in the long-form periodic table.

In the second aspect, the invention provides a thermal recording material comprising, on a support, a thermal recording layer and a protective layer which comprises at least polyvinyl alcohol and ultrafine inorganic particles, wherein the thermal recording material comprises boric acid and a water-soluble zirconium compound.

In the third aspect, the invention provides a thermal recording material comprising, on a support, a thermal recording layer and a protective layer which comprises at least polyvinyl alcohol and two or more kinds of ultrafine inorganic particles having different average particle sizes, wherein the thermal recording material further comprises boric acid and a water-soluble zirconium compound.

### DETAILED DESCRIPTION OF THE INVENTION

First Embodiment

<<Thermal Recording Material>>

A first embodiment of the thermal recording material of the present invention is characterized in that it includes, on a support, a thermal recording layer and a protective layer containing a water-soluble resin, and includes a water-soluble or oil-soluble compound of transition element of a group 4. In the first embodiment of the thermal recording material of the invention, it is preferred that the protective layer includes ultrafine inorganic particles and that the transition element compound is a water-soluble zirconium compound. In the first embodiment of the thermal recording material of the invention, it is particularly preferable that the amount of water-soluble zirconium compound contained in the protective layer is 0.1 to 25% by mass based on the water-soluble resin.

In the thermal recording material of the invention, the presence of the water-soluble or oil-soluble compound of transition element of a group 4 can improve water-resistance and image quality. As a result, the thermal recording material of the present invention can maintain surface smoothness, thereby providing high gloss. Further, even with high-speed printing when the interior of the printing apparatus is cold, for example, at the start of a printing operation, it is possible to reduce image quality deterioration resulting from water drops condensed on the surface of the thermal head, thereby stably providing a high-quality image.

Another layer suitably selected according to purpose may be provided between the aforementioned support and protective layer. Examples of such other layers include an undercoat layer provided between the support and the thermal recording layer, an intermediate layer provided between the thermal recording layers, and a light transmittance control layer provided between the thermal recording layer and the protective layer.

Hereafter, the first embodiment of the thermal recording material of the invention will be explained in detail.

(A Compound of Transition Element of a Group 4)

The first embodiment of the invention is characterized by the fact that the aforementioned the compound of transition element of a group 4 is contained in a water-soluble state or an oil-soluble state in the thermal recording material. As the compound of transition element of a group 4 in the invention, it is preferable to use a zirconium compound or a titanium compound, more preferable to use a zirconium compound, and particularly preferable to use a water-soluble zirconium compound.

Preferred examples of the water-soluble zirconium compound include ZrOCO₃, ZrO(CO₃)₂, ZrO(NO₃)₂, ZrOSO₄, ZrO(CH₃COO)₂, (NH₄)₂ZrO (CO₃)₂, Zr(OC₄H₉)₃(C₅H₇O₂), Zr(OC₄H₉)₂(C₅H₇O₂)₂, Zr(OC₄H₉)₃(C₆H₉O₃), Zr(OC₄H₉)(C₅H₇O₂)(C₆H₉O₃)₂, and Zr(OC₄H₉)₃(OCOC₁₇H₃₅). Among these, as the water-soluble zirconium compound, ZrO(NO₃)₃, ZrOSO₄, and (NH₄)₂ZrO(CO₃)₂ are more preferred.

Preferred examples of the oil-soluble zirconium compound include ZrO(C₁₈H₃₅O₂)₂, ZrO(C₁₄H₂₇O₂)₂, ZrO(C₁₂H₂₃O₂)₂, and ZrO(C₈H₁₅O₂)₂, and ZrO(C₁₈H₃₅O₂)₂ is more preferred as the oil-soluble zirconium compound.

Preferred examples of the water-soluble titanium compound include (OH)₂Ti (C₃H₅O₃)₂, (C₆H₁₄O₃N)₂Ti(C₃H₇O)₂, (C₈H₁₇O)₂Ti (C₈H₁₇O₂)₂, (C₃H₇O)₂Ti(C₆H₉O₃)₂, Ti(C₅H₇O₂)₄, and (C₃H₇O₂)Ti(C₅H₇O₂)₂. Also, preferred examples of the oil-soluble titanium compound include Ti(OH)₂(OCOC₁₇H₃₅)₂ and Ti(OH)₂(OCOC₁₉H₃₉)₂.

In the thermal recording material of the invention, a layer which includes the aforementioned water-soluble or oil-soluble compound of transition element of a group 4 is not particularly limited. However, the compound of transition element of a group 4 is preferably included in the protective layer or the intermediate layer, more preferably in the protective layer. In case of adding the water-soluble compound of transition element of a group 4 in the protective layer, it is necessary to pay attention to liquid stability, including reactivity thereof. Also in case of adding the oil-soluble compound of transition element of a group 4 in the protective layer, it is necessary to pay attention to dispersion stability since the oil-soluble compound of transition element of a group 4 is added in a dispersed state.

In case of adding the compound of transition element of a group 4 in the protective layer, the content of the oil-soluble compound of transition element of a group 4 is preferably 0.1 to 25% by mass based on a water-soluble resin, which will be explained later, more preferably 0.5 to 20% by mass and further preferably 1 to 15% by mass. If the content of the compound of transition element of a group 4 is within a range of 0.1 to 25% by mass based on a water-soluble resin, adequate water-resistance can be obtained and deterioration of the gloss, resulting from inferior surface smoothness when coating and drying, does not occur.

In the present invention, it is particularly preferred that the amount of water-soluble zirconium compound contained in the protective layer is 0.1 to 25% by mass based on the water-soluble resin, more preferably 0.5 to 20% by mass, and further preferably 1 to 15% by mass.

When the amount of water-soluble zirconium compound contained in the protective layer is 0.1 to 25% by mass based on the water-soluble resin, it can elevate the thermal sensitivity of the thermal recording layer closest to the protective layer, without deteriorating storability properties such as fog level. An increase in the thermal sensitivity of the thermal recording layer closest to the protective layer makes reducing the coating amount of the thermal recording layer possible. Such reduction in the coating amount improves thermal conductivity, whereby a thermal sensitivity increases in succession in underlying thermal recording layers.

Furthermore, reduction in the coating amount in the thermal recording layer closest to the protective layer decreases coloration of unprinted areas (background portion), which results from decomposition of a color forming component. This aspect will be explained later. Moreover, when employing a diazonium compound and a coupler as color forming components, the whiteness degree improves with the reduction in the coating amount of the diazonium compound.

Thus, incorporation of the water-soluble zirconium compound in the protective layer, in an amount of 0.1 to 25% by mass based on the water-soluble resin, can improve the whiteness degree of the thermal recording material of the invention and can decrease coloration of the unprinted area (background portion), thereby further improving the image quality.

<Protective Layer>

The protective layer in the thermal recording material of the invention is provided for preventing sticking of the thermal recording layer and for protecting the thermal recording layer from solvent or external air. The protective layer includes a water-soluble resin, and preferably includes ultrafine inorganic particles and a heat melting lubricant, in addition to the water-soluble resin. The protective layer may contain other various additives if necessary.

(Water-Soluble Resin)

The aforementioned water-soluble resin is preferably polyvinyl alcohol, more preferably modified polyvinyl alcohol, and particularly preferably a long-chain alkyl ether-modified polyvinyl alcohol. The use of long-chain alkyl ether-modified polyvinyl alcohol improves dispersibility of the ultrafine inorganic particles, thereby maintaining the smoothness of the surface of the thermal recording material and suppressing decreases in glossiness resulting from the addition of the ultrafine inorganic particles.

The long-chain alkyl ether-modified polyvinyl alcohol preferably includes an alkyl group with 8 to 20 carbon atoms. The long-chain alkyl ether-modified polyvinyl alcohol is more preferably a long-chain alkyl ether-modified polyvinyl alcohol represented by the following general formulae (A-1) to (A-4):

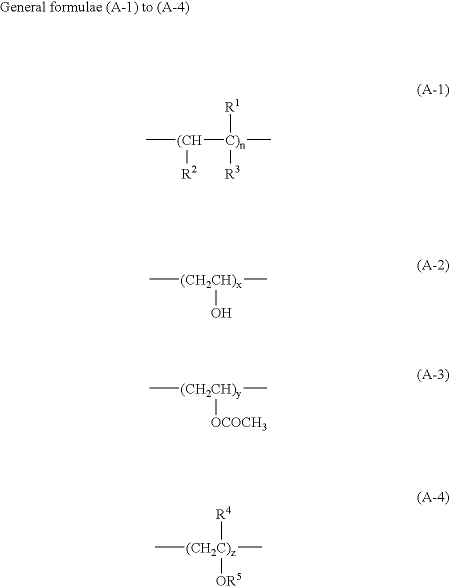

In general formulae (A-1) to (A-4), R¹ represents a hydrogen atom, a methyl group or —CH₂CO₂M; R² represents a hydrogen atom, or —CO₂M; R³ represents a hydrogen atom, —CO₂M, an amino group, an amido group, a substituted amido group, a hydroxyl group, a glycidyl group, a sulfonic acid group, a polyethylene oxide group, a polypropylene oxide group or a group having at least one of these functional groups; and R⁴ represents a hydrogen atom or a methyl group.

In the foregoing general formulae (A-1) to (A-4), the combination is preferred in which R¹, R² and R⁴ are hydrogen atoms and R³ is —CO₂M, or a combination in which R² and R⁴ are hydrogen atoms, R¹ is —CH₂CO₂M and R³ is —CO₂M.

In the foregoing general formulae (A-1) to (A-4), M represents a hydrogen atom, an alkyl group, an aryl group, an aralkyl group, Na, K or Li.

In the foregoing general formulae (A-1) to (A-4), R⁵ represents a long-chain alkyl group (with 8 or more carbon atoms, preferably 8 to 20 carbon atoms). The long-chain alkyl group may be a normal chain or a branched chain. Also, the long-chain alkyl group may have a substituent such as an aryl group. The long-chain alkyl group is more preferably an alkyl group with 8 to 16 carbon atoms for improving a lubricating property, and particularly preferably, a dodecyl group with 12 carbon atoms.

In the foregoing general formulae (A-1) to (A-4), n, x, y and z each represent a degree of polymerization. n is preferably 0 to 20, more preferably 0 to 10. A large value of n increases acidic groups, thereby improving mutual solubility with gelatin. In order to exploit the characteristics of polyvinyl alcohol, such as a gas barrier property at or under Tg (glass transition point), x is preferably 60 to 99, more preferably 75 to 95. Also, y is preferably 0 to 20. A value of z is preferably larger in consideration of friction resistance with the thermal recording head and lubricating property. However, since z is limited by the solubility and viscosity of an aqueous solution, it is preferably within a range of 0.5 to 10% based on the total sum of n, x, y and z, more preferably 1 to 5%.

The aforementioned long-chain alkyl ether-modified polyvinyl alcohol preferably has a Tg of 50° C. or higher, more preferably 60° C. or higher. Scratch resistance is also not deteriorated when the glass transition point (Tg) is equal to or higher than 50° C.

The long-chain alkyl ether-modified polyvinyl alcohol is preferably contained in an amount of 50% by mass or higher in the total binder of the protective layer, and more preferably at 80% by mass or higher. Adjusting the content of the long-chain alkyl ether-modified polyvinyl alcohol so as to be equal to or higher than 50% by mass allows the polyvinyl alcohol to fully exhibit the aforementioned characteristics.

Long-chain alkyl groups tend to orient easily on the surface of a protective layer employing the long-chain alkyl ether-modified polyvinyl alcohol. Such a surface reduces printing torque, thereby avoiding printing failure, and it is therefore possible to improve smoothness (glossiness) of the print surface and color developing density. Also, decreased static friction and dynamic friction on the surface of the protective layer provide good running ability of a medium on a printer. Furthermore, the long-chain alkyl ether-modified polyvinyl alcohol not only exhibits characteristics of excellent light fastness and film strength, which characterize the polyvinyl alcohol system, but also has hydrophobic groups oriented on the surface, which improves the water-resistance of the protective layer.

In the protective layer, in addition to the long-chain alkyl ether-modified polyvinyl alcohol, another binder may also be employed if necessary. Examples of such binders include a water-soluble polymer such as silicon-modified polyvinyl alcohol, starch, denatured starch, methyl cellulose, carboxymethyl cellulose, hydroxymethyl cellulose, gelatin, gum Arabic, casein, a hydrolysate of a styrene-maleic acid copolymer, a hydrolysate of a styrene-maleic acid copolymer half ester, a hydrolysate of an isobutyrene-maleic anhydride copolymer, polyvinylpyrrolidone, sodium polystyrenesulfonate, and sodium alginate, and a synthetic rubber latex or a synthetic resin emulsion such as a styrene-butadiene rubber latex, an acrylonitrile-butadiene rubber latex, or a vinyl acetate emulsion.

Among these binders, polyvinyl alcohol or a derivative thereof are preferred (hereinafter, collectively referred to as “polyvinyl alcohol”), and specific examples include those described in JP-A No. 2000-118133.

A polymer constituting the aforementioned binder has a Tg of 150° C. or lower, preferably of 0° C. to 130° C. and particularly preferably of 40° C. to 100° C.

The content amount of the binder in the protective layer is preferably 25 to 80% by mass based on the entire protective layer, and more preferably 40 to 70% by mass.

(Ultrafine Inorganic Particles)

The protective layer of the invention preferably includes ultrafine inorganic particles. The inclusion of ultrafine inorganic particles having small particle sizes make it possible to maintain high hardness without varying the smoothness of the surface.

The term “ultrafine inorganic particles” refers to fine inorganic articles with an average primary particle size of 0.5 μm or less, preferably 0.2 μm or less and more preferably, of 0.15 μm or less. Any fine inorganic particles fulfilling these conditions may be employed without any particular restriction, however, they preferably have a maximum particle size in a dispersion (i.e., a threshold level at a larger side in the particle size distribution in a dispersion) of 0.5 μm or less, more preferably 0.4 μm or less, and particularly preferably of 0.35 μm or less. In the ultrafine inorganic particles, it is preferred that the frequency of (coagulated) particles having an average particle size of 0.35 μm or larger in a dispersion is 5% or less, preferably 1% or less. It is particularly preferred that the frequency of (coagulated) particles having an average particle size of 0.25 μm or larger in a dispersion is 5% or less. Such particle size can be measured by known methods, for example, by using a submicron particle size analyzer Coulter N4 manufactured by Nikkaki Co.

The ultrafine inorganic particles can be, for example, colloidal silica, barium sulfate, zinc oxide, magnesium oxide, lead oxide, zirconium oxide, or alumina, among which preferred are colloidal silica, barium sulfate or alumina, and particularly preferred are colloidal silica or barium sulfate.

Specific examples of ultrafine inorganic particles advantageously employable in the invention include barium sulfate (trade name: BARIFINE BF-21, BF-20, manufactured by Sakai Chemical Industries, Co.), colloidal silica (trade name: Snotex O, manufactured by Nissan Chemical Ltd.), zirconium oxide (trade name: NZR-A, manufactured by Nissan Chemical Ltd.), zinc oxide (trade name: FINEX-75, Sakai Chemical Industries, Co.), titanium oxide (trade name: TTO-55, manufactured by Ishihara Sangyo Co.), and silica (trade name: AEROSIL 200, manufactured by Nippon Aerosil Co.).

The protective layer of the invention preferably includes two or more types of ultrafine inorganic particles of different particle sizes, such as the preferable combination of barium sulfate and colloidal silica. Use of colloidal silica of small particle size maintains high hardness without varying the smoothness of the surface, however, if colloidal silica alone are used, the lubricant may diffuse and may not be retained on the surface of the thermal recording material due to colloidal silica's high hydrophilicity. However, a combined use of barium sulfate retains the necessary amount of lubricant stably on the surface of the thermal recording material. Thus, the thermal recording material of the invention maintains surface smoothness, thereby achieving high gloss while maintaining high hardness on the surface. Further, the thermal recording material of the invention, which stably retains the lubricant on the surface, is capable of preventing dirtying of the thermal head, thereby being capable of stably providing a high-quality image.

The average particle size of barium sulfate is preferably 0.05 to 0.20 μm, and more preferably 0.10 to 0.15 μm. The average particle size of colloidal silica is preferably 10 to 50 nm, more preferably 10 to 30 nm, and particularly preferably 15 to 25 nm. The content of the colloidal silica in the protective layer is preferably 8 to 24% by mass based on barium sulfate, more preferably 8 to 16% by mass, and particularly preferably 8 to 10% by mass. If the particle sizes of barium sulfate and colloidal silica are not within the above-mentioned ranges, and the proportion of contents of barium sulfate and colloidal silica is not within the above-mentioned range, it may become impossible to maintain high glossiness, or the recording head may exhibit enhanced dirt, thereby making the formation of a plurality of good images difficult.

The barium sulfate and colloidal silica are preferably contained in an amount of 60% by mass or higher in the total ultrafine inorganic particles, more preferably 75% by mass or higher and particularly preferably 85% by mass or higher. Presence of barium sulfate and colloidal silica in an amount of 60% by mass or higher ensures that the aforementioned effects can be fully exhibited.

Upon considering the obtained effects and practical manufacturing, it is preferable to add the ultrafine inorganic particles by employing a method of addition utilizing a resin solution containing an aqueous dispersible resin such as carboxymethyl cellulose, gelatin or polyvinyl alcohol; or a method of addition utilizing colloidal dispersion prepared in various mills. These methods are preferably employed in order to avoid mutual coagulation of the fine particles and to achieve a uniform adsorption on the surface of the resin particles.

Also a proportion of the binder and the ultrafine inorganic particles (binder/ultrafine inorganic particles) in a mass ratio is preferably 0.8/0.5 to 0.8/0.15, and more preferably 0.8/0.45 to 0.8/0.3.

An inorganic layered compound such as mica, or a pigment such as calcium oxide, zinc oxide, titanium oxide, aluminum hydroxide, caolin, a synthetic silicate salt, amorphous silica or an urea-formalin resin powder may be added to the protective layer.

(Hardening Agent)

In the protective layer of the invention, a hardening agent is preferably employed in combination with the binder in order to elevate the degree of hardening of the protective layer. Examples of such hardening agents include a vinylsulfone compound, an aldehyde compound (such as formaldehyde or glutaraldehyde), an epoxy compound, an oxazine compound, a triazine compound, a methylated melamine, a blocked isocyanate, a methylol compound, a carbodimide resin or a boron compound.

Among these hardening agents, a boron compound is preferred as it causes a prompt crosslinking reaction with polyvinyl alcohol without requiring the addition of a reaction accelerator or a high-temperature process. Particularly preferred boron compounds include boric acid or borax.

When coating the protective layer and the thermal recording layer in a multilayer coating (simultaneous coating), the hardening agent need not necessarily be added in a coating solution for the protective layer. The hardening agent may be contained, for example, in a coating solution for an intermediate layer. Also, when employing boric acid as the hardening agent, the amount is preferably 18 to 30% by mass, and more preferably 20 to 27% by mass, based on the total amount of the long-chain alkyl ether-modified polyvinyl alcohol, polyvinyl alcohol employed as the binder of the protective layer, and polyvinyl alcohol contained in the thermal recording layer, intermediate layer, etc., which will be further explained later (i.e., the total amount of polyvinyl alcohol contained in layers on the recording surface side of the thermal recording material). Boric acid, contained in the aforementioned range based on the total mount of polyvinyl alcohol employed in the thermal recording material, can sufficiently harden the protective layer, etc., and further serves to hinder diffusion of the lubricant when printing. Boric acid helps prevent deterioration of image quality or glossiness caused by the lowered hydrophobicity of the protective layer surface.

(Heat Melting Lubricant)

In order to achieve smooth printing without printing failures such as sticking, the protective layer of the invention preferably includes a heat melting lubricant, so as to reduce friction between the surface of the thermal recording material and the thermal head when printing. The term “heat melting lubricant” refers to a fatty acid derivative having a melting point of 30° C. or higher.

Well-known heat melting lubricants suitably selected for their heat melting properties may be used. Specific examples include a higher alcohol, a higher fatty acid, a higher fatty acid metal salt, a higher fatty acid ester, and a higher fatty acid glyceride, the preferred being the higher fatty acid metal salt.

The content of the heat melting lubricant in the protective layer of the invention is preferably within a range of 10 to 40% by mass based on the binder of the protective layer, and more preferably 15 to 25% by mass. When within these ranges, the heat melting lubricant can sufficiently reduce printing torque, and can sufficiently prevent deteriorations of various characteristics such as decreased glossiness resulting from excessive print surface deformation, or increased background coloration when irradiated by light.

(Method for Forming Protective Layer)

The protective layer of the invention can be formed on a thermal recording layer (described below) by coating a protective layer coating solution, which includes a binder and ultrafine inorganic particles, etc., with a coating apparatus such as a bar coater, an air knife coater, a blade coater or a curtain coater, and then drying the layer. However, the protective layer may also be simultaneously coated with the other layers such as the thermal recording layer via a superposition method, or by coating after the other layers have been coated and dried. The amount of dry coating of the protective layer is preferably within a range of 0.1 to 3 g/m², and more preferably 0.3 to 2.0 g/m². An excessive amount of coating may result in significant loss of thermal sensitivity, while an excessively low amount may be unable to exhibit the desired functions (e.g., friction resistance, lubricating property, scratch resistance, etc.) of the protective layer. After the coating, the protective layer may be subjected to a calendaring process if necessary.

In the protective layer, in addition to the ultrafine inorganic particles (pigment), it is also preferable to add components such as another pigment, a wax, a catalyst, a releasing agent, a surfactant, or a water-repellent agent if necessary.

<Thermal Recording Layer>

The thermal recording layer may have a single-layer structure or a multi-layer structure. The thermal recording layer may have a layer structure suitably selected according to the purpose.

The thermal recording layer includes a color forming component and is designed so as to form an image of a desired color by a color forming reaction of the color forming component. The color forming component is not particularly limited, and known component may be advantageously employed. The color forming reaction is also not particularly restricted, for example, the color forming reaction of a diazonium compound and a coupler, or the color forming reaction of an electron donating colorless dye and an electron accepting compound can be advantageously employed.

When the thermal recording layer includes a diazonium compound and a coupler capable of color formation by reacting therewith when heated, a basic substance capable of accelerating the color forming reaction of the diazonium compound and the coupler is advantageously added to the thermal recording layer.

The aforementioned diazonium compound is a compound represented by the following general formula (B). In the compound represented by general formula (B), the maximum absorption wavelength thereof can be controlled by adjusting the position and type of substituent in the Ar portion.

General Formula (B):

Ar—N₂⁺X⁻

In general formula (B), Ar represents an aryl group, and X⁻ represents an acid anion.

Specific examples of the diazonium compound include acid anion salts such as:

4-(N-(2-(2,4-di-tert-amylphenoxy)butyryl)piperadino) benzene diazonium;

4-dioctylaminobenzene diazonium;

4-(N-(2-ethylhexanoyl)piperadino)benzene diazonium;

4-dihexylamino-2-hexyloxybenzene diazonium;

4-N-ethyl-N-hexadecylamino-2-ethoxybenzo diazonium;

3-chloro-4-dioctylamino-2-octyloxybenzene diazonium;

2,5-dibutoxy-4-morpholinobenzene diazonium;

2,5-dioctoxy-4-morpholinobenzene diazonium;

2,5-dibutoxy-4-(N-(2-ethylhexanoyl)piperadino)benzene diazonium;

2,5-diethoxy-4-(N-(2-(2,4-di-tert-amylphenoxy)butyryl)-piperadino)benzene diazonium;

2,5-dibutoxy-4-tolylthiobenzene diazonium; or

3-(2-octyloxyethoxy)-4-morpholinobenzene diazonium, and the following diazonium compounds (D-1 to D-5). These compounds may be used singly or in combination of two or more types.

Among these, particularly preferred are a hexafluorophosphate salt, a tetrafluoroborate salt and a 1,5-naphthalenesulfonate salt.

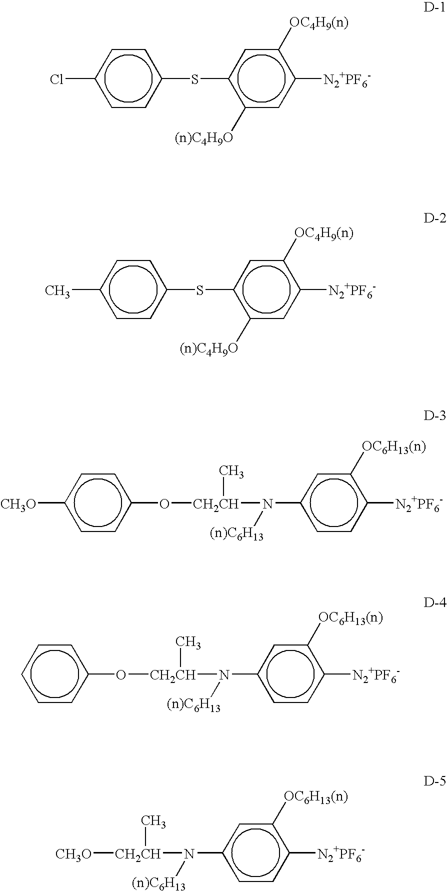

Among these diazonium compounds, particularly preferred are those decomposable by light of a wavelength of 300 to 400 nm, which are 4-(N-(2-(2,4-di-tert-amylphenoxy)butyryl)piperadino) benzene diazonium;

4-dioctylaminobenzene diazonium;

4-(N-(2-ethylhexanoyl)piperadino)benzene diazonium;

4-dihexylamino-2-hexyloxybenzene diazonium;

4-N-ethyl-N-hexadecylamino-2-ethoxybenzo diazonium;

2,5-dibutoxy-4-(N-(2-ethylhexanoyl)piperadino)benzene diazonium;

2,5-diethoxy-4-(N-(2-(2,4-di-tert-amylphenoxy)butyryl)-piperadino)benzene diazonium, and the diazonium compounds D-3 to D-5.

The maximum absorption wavelength of the diazonium compound is obtained by measurement of each diazonium compound in a coated film of a coating amount of 0.1 to 1.0 g/m², with a spectrophotometer (trade name MPS-2000, manufactured by Shimadzu Mfg. Co.).

Examples of couplers capable of color formation by reaction with the diazonium compound in a heated state include resorcin; phloroglucin; sodium 2,3-dihydroxynaphthalene-6-sulfonate; 1-hydroxy-2-naphthoic acid morpholinopropylamide; 1,5-dihydroxynaphthalene; 2,3-dihydroxynaphthalene; 2,3-dihydroxy-6-sulfanylnaphthalene; 2-hydroxy-3-naphthoic acid anilide; 2-hydroxy-3-naphthoic acid ethanolamide; 2-hydroxy-3-naphthoic acid octylamide; 2-hydroxy-3-naphthoic acid N-dodecyloxypropylamide; 2-hydroxy-3-naphthoic acid tetradecylamide; acetanilide; acetoacetanilide; benzoylacetanilide; 2-chloro-5-octylacetoacetanilide; 1-phenyl-3-methyl-5-pyrazolone; 1-(2′-octylphenyl)-3-methyl-5-pyrazolone; 1-(2′,4′,6′-trichlorophenyl)-3-benzamide-5-pyrazolone; 1-(2′,4′,6′-trichlorophenyl)-3-anilino-5-pyrazolone; 1-phenyl-3-phenylacetamide-5-pyrazolone; and the following compounds (C-1 to C-6). These couplers may be used singly or in combination of two or more types.

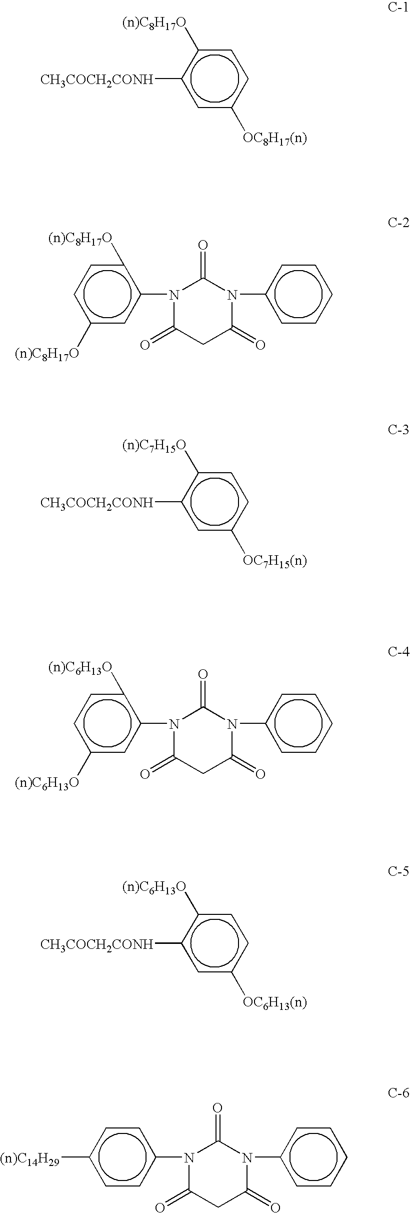

The basic substance is not particularly limited but can be suitably selected from those already known, depending on the purpose, and include not only inorganic and organic basic compounds but also compounds capable of releasing an alkali substance under heating, for example, by decomposition. Representative examples of such alkali-releasing compounds include a nitrogen-containing compound such as an organic ammonium salt, an organic amine, an amide, urea or thiourea and a derivative thereof, a thiazole, a pyrrole, a pyrimidine, a piperadine, a guanidine, an indol, an imidazole, an imidazoline, a triazole, a morpholine, a piperidine, an amidine, a formazine or a pyridine.

Specific examples of such compounds include tricyclohexylamine, tribenzylamine, octadecylbenzylamine, stearylamine, allylurea, thiourea, methylthiourea, allylthiourea, ethylenethiourea, 2-benzylimidazole, 4-phenylimidazole, 2-phenyl-4-methylimidazole, 2-undecylimidazoline, 2,4,5-trifuryl-2-imidazoline, 1,2-diphenyl-4,4-dimethyl-2-imidazoline, 2-phenyl-2-imidazoline, 1,2,3-triphenylguanidine, 1,2-dicyclorohexylguanidine, 1,2,3-tricyclohexylguanidine, guanidine trichloroacetic acid salt, N,N′-dibenzylpiperadine, 4,4′-dithiomorpholine, morpholinium trichloroacetic acid salt, 2-aminobenzothiazole, and 2-benzoylhydrazinothiazole. These basic substances may be used singly or in combination of two or more types.

The electron donating colorless dye is not particularly limited and can be suitably selected in accordance with the purpose from those already known. In the invention, an electron donating colorless dye precursor can be employed as the electron donating colorless dye.

The electron donating colorless dye precursor can be, for example, a triarylmethane compound, a diphenylmethane compound, a thiazine compound, a xanthene compound or a spiropyran compound. Such compounds may be employed singly or in a combination of two or more types, and, among these compounds, a triarylmethane compound and a xanthene compound are preferred because these compounds are useful in producing high developed color density. Examples of these compounds include 3,3-bis(p-dimethylaminophenyl)-6-dimethylamino phthalide (namely crystal violet lactone), 3,3-bis(p-dimethylamino) phthalide, 3-(p-dimethylaminophenyl)-3-(1,3-dimethylindol-3-yl) phthalide, 3-(p-dimethylaminophenyl)-3-(2-methylindol-3-yl) phthalide, 3-(o-methyl-p-diethylaminophenyl)-3-(2-methylindol-3-yl) phthalide, 4,4′-bis(dimethylamino)benzhydrin benzyl ether, N-halophenyl leucoauramin, N-2,4,5-trichlorophenyl leucoauramin, rhodamin-B-anilinolactam, rhodamin(p-nitroanilino) lactam, rhodamin-B-(p-chloroanilino) lactam, 2-benzylamino-6-diethylaminofluoran, 2-anilino-6-diethylaminofluoran, 2-anilino-3-methyl-6-diethylaminofluoran, 2-anilino-3-methyl-6-cyclohexylmethylaminofluoran, 2-anilino-3-methyl-6-isoamylethylaminofluoran, 2-(o-chloroanilino)-6-diethylaminofluoran, 2-octylamino-6-diethylaminofluoran, 2-ethoxyethylamino-3-chloro-2-diethylaminofluoran, 2-anilino-3-chloro-6-diethylaminofluoran, benzoyl leuco methylene blue, p-nitrobenzyl leuco methylene blue, 3-methyl-spiro-dinaphthopyran, 3-ethyl-spiro-dinaphthopyran, 3,3′-dichloro-spiro-dinaphthopyran, 3-benzyl-spiro-dinaphthopyran, and 3-propyl-spiro-dibenzopyran.

The electron accepting compound can be a phenol derivative, a salicylic acid derivative or a hydroxybenzoic acid ester. For the electron accepting compound, particularly preferred are a bisphenol and a hydroxybenzoic acid ester. Specific examples of particularly preferred electron accepting compounds include:

2,2-bis(p-hydroxyphenyl)propane (namely bisphenol-A),

4,4′-(p-phenylenediisopropylidene)diphenyl (namely bisphenol-P), 2,2-bis(p-hydroxylphenyl)pentane,

2,2-bis(p-hydroxyphenyl)ethane,

2-2-bis(p-hydroxyphenyl)butane,

2,2-bis(4′-hydroxy-3′,5′-dichlorophenyl)propane,

1,1-(p-hydroxyphenyl)cyclohexane,

1,1-(p-hydroxyphenyl)propane,

1,1-(p-hydroxylphenyl)pentane,

1,1-(p-hydroxyphenyl)-2-ethylhexane,

3,5-di(α-methylbenzyl)salicylic acid and a polyvalent metal salt thereof,

3,5,-di(tert-butyl)salicylic acid and a polyvalent metal salt thereof,

3-α,α-dimethylbenzylsalicylic acid and a polyvalent metal salt thereof, butyl p-hydroxybenzoate, benzyl p-hydroxybenzoate, 2-ethylhexyl p-hydroxybenzoate, p-phenylphenol and p-cumylphenol.

In the present invention, the thermal recording layer preferably includes a sensitizer. The sensitizer is preferably a low-melting organic compound suitably having an aromatic group and a polar group in the molecule. Specific examples of the sensitizer include benzyl p-benzyloxybenzoate, α-naphthyl benzyl ether, β-naphthyl benzyl ether, β-naphthoic acid phenyl ester, α-hydroxy-β-naphthoic acid phenyl ester, β-naphthnol-(p-chlorobenzyl) ether, 1,4-butanediol phenyl ether, 1,4-butanediol-p-methylphenyl ether, 1,4-butanediol-p-ethylphenyl ether, 1,4-butandiol-m-methylphenyl ether, 1-phenoxy-2-(p-tolyloxy)ethane, 1-phenoxy-2-(p-ethylphenoxy)ethane, 1-phenoxy-2-(p-chlorophenoxy)ethane and p-benzylbiphenyl.

Further, the thermal recording layer preferably includes a compound represented by the following general formula (C) in an amount of 0.05 g/m² or higher. In case the thermal recording layer is formed of plural layers, a layer in which the compound represented by the following general formula (C) is included and is not particularly restricted and can be suitably selected according to the purpose. However, the layer in which the compound represented by general formula (C) is included is preferably a layer configured by a solid dispersant.

General Formula (C)

R—SO₃M

In general formula (C), R represents an alkyl group, an aryl group, an alkoxyl group, an aryloxy group, a polyoxyethylenearyl group or a polyoxyethylenealkyl group. R is preferably an alkyl group with 1 to 20 carbon atoms, an aryl group with 1 to 30 carbon atoms, an alkoxyl group with 1 to 20 carbon atoms, an aryloxy group with 1 to 30 carbon atoms, a polyoxyethylenearyl group with 1 to 30 carbon atoms or a polyoxyethylenealkyl group with 1 to 20 carbon atoms. M represents an alkali metal, which is preferably sodium or potassium.

Specific examples of the compound represented by general formula (C) include sodium laurylsulfate, sodium higher alcohol sulfonate, sodium dodecylbenzenesulfonate, sodium alkylnaphthalenesulfonate, sodium dialkylsulfosuccinate, sodium alkyldiphenyl ether disulfonate, sodium polyoxyethylene lauryl ether sulfonate, sodium polyoxyethylene alkyl ether sulfonate, sodium polyoxyethylene alkyl phenyl ether sulfonate, sodium alkanesulfonate, sodium salt of naphthalenesulfonic acid-formalin condensate and sodium salf of a specific aromatic sulfanic acid-formalin condensate. The compound represented by general formula (C) may be used singly or in a combination of two or more kinds. In the invention, among these compounds, sodium dodecylbenzenesulfonate represented by the following formula is preferred in order to reduce coloration in a background portion by exposure to light.

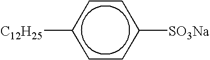

The content of the compound represented by general formula (C) in the thermal recording layer is preferably 0.05 g/m² or higher, more preferably 0.05 to 0.50 g/m² and particularly preferably 0.05 to 0.20 g/m².

A content of less than 0.05 g/m² [symbol] may result in insufficient light resistance of the thermal recording material, thus causing background coloration by exposure to light, while on the other hand, a content of equal to or greater than 0.05 g/m² does not encounter such defects and can actually significantly improve the thermal recording material's weather resistance, thereby effectively suppressing background coloration by exposure to light.

In the thermal recording layer, the mode of inclusion of components such as the diazonium compound, the coupler capable of color formation by reacting with the diazonium compound in a heated state, the basic substance, the electron donating colorless dye, the electron accepting compound, and the sensitizer is not particularly limited but can be suitably selected according to the purpose. For example, these components may be included by (1) a method of inclusion by solid dispersion; (2) a method of inclusion by emulsification; (3) a method of inclusion by polymer dispersion; (4) a method of inclusion by latex dispersion; or (5) a method of inclusion by microencapsulation.

Among these methods, the preferred method is inclusion by microencapsulation, in consideration of the storability. When utilizing the color forming reaction of the diazonium compound and the coupler, the diazonium compound is preferably microencapsulated and included in the thermal recording layer. When utilizing the color forming reaction of the electron donating colorless dye and the electron accepting compound, the electron donating colorless dye is preferably microencapsulated and included in the thermal recording layer. Microencapsulation can be performed by utilizing a microencapsulating method according to the second embodiment, which will be explained later.

In case the thermal recording layer is constructed with a multi-layered structure, a multi-color thermal recording material can be obtained by employing different color hues in such recording layers. The layer configuration is not particularly restricted and can be suitably selected according to the purpose. In the invention, it is preferable to employ laminated multi-color thermal recording layers, including two thermal recording layers in which two diazonium compounds having different photosensitive wavelengths are respectively combined with couplers capable of forming different color hues by reaction under heating with the respective diazonium compounds, and a recording layer in which an electron donating colorless dye and an electron accepting compound are combined. More specifically, it is preferable to use a multi-color thermal recording material in which, on the aforementioned support, are laminated a thermal recording layer A including an electron donating colorless dye and an electron accepting compound; a thermal recording layer B-1 including a diazonium compound having a maximum absorption wavelength of 360±20 nm and a coupler capable of forming a color by reaction with the diazonium compound under heating; and a thermal recording layer B-2 including a diazonium compound having a maximum absorption wavelength of 400±20 nm and a coupler capable of forming a color by reaction with the diazonium compound under heating, in this order.

A recording method using such a multi-color thermal recording material is executed as follows. First, the thermal recording layer B-2 is heated to execute color formation by the diazonium compound and the coupler in layer B-2. Next, after irradiation with light of a wavelength of 400±20 nm for decomposing the unreacted diazonium compound contained in the thermal recording layer B-2, sufficient heat is added for color formation in the thermal recording layer B-1, thereby causing color formation with the diazonium compound and the coupler included layer B-1. At the same time, the thermal recording layer B-2 is also strongly heated, but no further color formation takes place because the diazonium compound is already decomposed and color forming ability is lost. Next, irradiation with light of a wavelength of 360±20 nm is executed for decomposing the diazonium compound included in the thermal recording layer B-1, and lastly, sufficient heat is added for color formation in thermal recording layer A, thereby forming a color therein. At the same time, the thermal recording layers B-2 and B-1 are also strongly heated, but no further color formation takes place because the diazonium compounds are already decomposed and the color forming ability is lost.

In the present invention, it is also preferable to employ laminated multi-color thermal recording layers, including three thermal recording layers in which three diazonium compounds having different photosensitive wavelengths are respectively combined with couplers capable of forming different color hues by reaction under heating with the respective diazonium compounds. More specifically, it is preferable to use a multi-color thermal recording material in which are laminated, on the aforementioned support, a thermal recording layer A-1 including a diazonium compound having a maximum absorption wavelength of 350 nm or less, and preferably of 340 nm or less, and a coupler capable of forming a color by reaction under heating with the diazonium compound; a thermal recording layer A-2 including a diazonium compound having a maximum absorption wavelength of 360±20 nm and a coupler capable of forming a color by reaction under heating with the diazonium compound; and a thermal recording layer A-3 including a diazonium compound having a maximum absorption wavelength of 400±20 nm and a coupler capable of forming a color by reaction under heating with the diazonium compound, in this order.

In such multi-color thermal recording layers, full-color image recording is possible by selecting three primary colors in the subtractive color mixing, namely yellow, magenta and cyan, for the color hues to be formed in these recording layers.

<Support>

The aforementioned support can be, for example, a polyester film such as of polyethylene terephthalate or polybutylene terephthalate; a cellulose derivative film such as a cellulose triacetate film; a polyolefin film such as a polystyrene film, a polypropylene film or a polyethylene film; a plastic film such as a polyimide film, a polyvinyl chloride film, a polyvinylidene chloride film, an acrylic acid copolymer film or a polycarbonate film; paper, synthetic paper or paper having a plastic resin layer, and it is preferred to use a support having a layer made of one of the above-mentioned plastic films. Such a support may be transparent or opaque, and may be used singly or in combination of two or more kinds.

It is advantageous for such a support having the plastic layer to be a base paper having, on either both surfaces or at least one surface where the recording layer is to be formed, a layer formed by a thermoplastic resin. Such a support can be, for example, (1) a base paper on which a thermoplastic resin is coated by melt extrusion; (2) a base paper having a melt-extruded thermoplastic resin on which a gas barrier layer is coated; (3) a base paper adhered to a plastic film of low oxygen permeability; (4) a base paper adhered to a plastic film on which a thermoplastic resin is coated by melt extrusion; or (5) a base paper coated with a thermoplastic resin by melt extrusion, and then adhered to a plastic film.

The thermoplastic resin to be melt extrusion coated on the base paper can advantageously be an olefinic polymer, for example, a single polymer of alpha-olefin such as polyethylene or polypropylene or a mixture of such polymers, or a random copolymer of ethylene and vinyl alcohol. The polyethylene mentioned above can be, for example, low density polyethylene (LDPE), high density polyethylene (HDPE), or linear low density polyethylene (L-LDPE).

The method of adhering the plastic film to the base paper is not particularly limited, and can be suitably selected from known lamination methods such as those described in Shin-laminate Kako Binran (New Lamination Work Handbook) edited by Kako Gijutsu Kenkyukai. Advantageous examples include so-called dry lamination, solventless dry lamination, dry lamination utilizing an electron beam- or ultraviolet-curable resin, or hot dry lamination.

Among the supports mentioned in the foregoing, it is particularly preferable in the present invention to use a base paper formed from natural pulp as the main component and which has an olefinic polymer coating on both surfaces.

<Undercoat Layer>

In the invention, an undercoat layer is preferably provided between the support and the thermal recording layer.

The undercoat layer is not particularly restricted, and can be suitably selected from known layers, according to the purpose. The undercoat layer particularly preferably includes gelatin having a PAGI method viscosity of 10 to 30 mP and a PAGI method jelly strength of 15 to 70 g (hereinafter, simply referred to as “gelatin”) and a layered inorganic compound. In the invention, it is also preferred that the above-described layer be provided as an intermediate layer or the like, and will be explained later.

The PAGI method viscosity and the PAGI method jelly strength are measured by a test based on PAGI Method: Test Methods for Photographic Gelatin; 7th edition (1992); published by the United Association for Photographic Gelatin Test Method.

The above-mentioned gelatin is obtained by reducing the molecular weight of a known gelatin produced by an ordinary method (hereinafter referred to as “ordinary gelatin”). The ordinary gelatin mentioned above is produced by processing a raw material such as cow bone, cow hide or pig hide with lime or an acid, as described in Glue and Gelatin, edited by Yoshihiro Abiko, Japan Glue and Gelatin Industry Association (1987), and has a viscosity and a jelly strength far greater than those of the aforementioned gelatin.

Ordinary gelatin is characterized and influenced by conditions such as the raw materials used, the processing method (e.g., lime processing or acid processing), and extracting conditions (e.g., temperature, number of extractions, etc.). The aforementioned gelatin may be obtained by molecular weight reduction from any gelatin. However, it is preferable to use a gelatin extracted with a fewer number of extractions and at a lower temperature, in order to simultaneously attain low viscosity and jelly strength within the aforementioned ranges.

For the molecular weight reduction method, a method of employing an enzyme or a method of utilizing heat can be employed. Among these methods, the method employing an enzyme is preferred. In the method of utilizing heat, the jelly strength may become low when the viscosity is lowered to the desired value. An example of a usable includes papain, which can be advantageously employed.

The aforementioned gelatin has a PAGI method viscosity of 10 to 30 mP and a PAGI method jelly strength of 15 to 70 g. A PAGI method viscosity of less than 10 mP may cause a large reduction of viscosity in the coating solution, thereby possibly deteriorating a dispersed state of a pigment (mica) in the coating solution, while a viscosity exceeding 30 mP elevates the viscosity of the coating solution, thereby resulting in coating defects. Also a PAGI method jelly strength of less than 15 g lowers a coated film strength, thereby resulting in lowered adhesion strength with the support, while a jelly strength exceeding 70 g may increase curling of the coated film by changes in environmental conditions.

The aforementioned gelatin may be crosslinked with a hardening agent if necessary. In such a case, a known hardening agent may be employed for the gelatin. Examples of such known hardening agents include a vinylsulfone compound, an active halogen compound, an isocyanate compound, and an epoxy compound. Among these, use of an epoxy compound is particularly preferred, and preferred examples of such epoxy compounds are shown below:

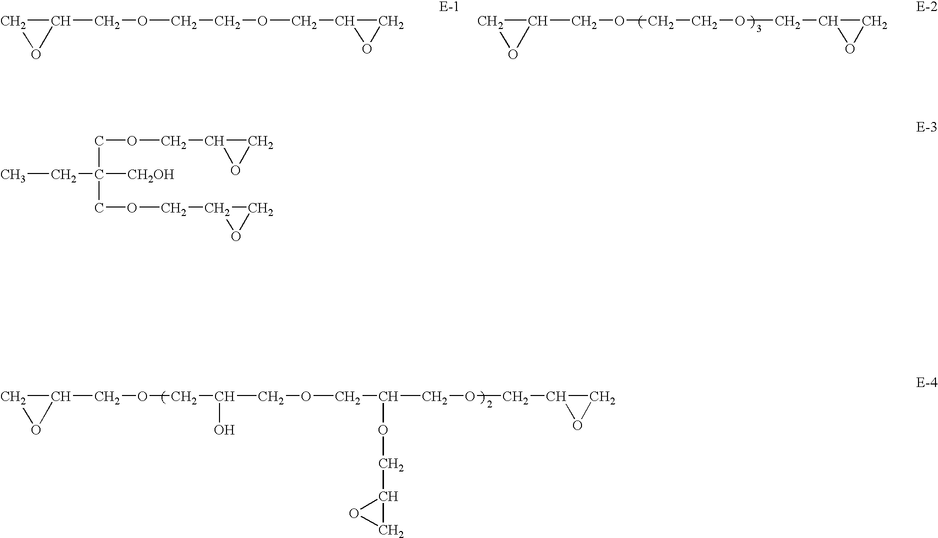

A coating amount of the gelatin in the undercoat layer is preferably 0.5 g/m² or higher, in view of suppressing blisters (small swellings formed by the heat of the thermal head during printing).

A swelling inorganic layered compound can be advantageously employed as the aforementioned layered inorganic compound. Specific examples of such compounds include a swelling clay mineral such as bentonite, hectorite, saponite, biedellite, nontronite, stevensite, beidellite or montmorillonite, swelling synthetic mica, and swelling synthetic smectite.

Such swelling layered has a layered structure constituted by a unit crystal lattice layer of a thickness of about 10 to 15 Angstroms, and shows significantly larger in-lattice metal atom substitutions than other clay minerals. As a result, the lattice layer generates a deficiency in a positive charge, and cations such as Na⁺, Ca²⁺ or Mg²⁺ are adsorbed between the layers in order to compensate such charge deficiency. Such cations present between the layers are called “exchangeable cations”, which can be exchanged with various cations. When these interlayer cations are Li⁺, Na⁺ etc., because of the small ionic radius thereof, the bond between the layered crystal lattices is weak and water causes large swelling. When a shearing force is applied to the crytsal in such a state, the crystal is easily cleaved to form a stable sol in water. Among the aforementioned specific examples of the swelling inorganic layered compounds, bentonite and swelling synthetic mica are preferred because they tend to cause the above-described phenomenon, and the swelling synthetic mica is particularly preferred.

Preferred examples of swelling synthetic mica include:

Na tetrasic mica NaMg_{2.5}(Si₄O₁₀)F₂,

Na/Li teniolite (NaLi)Mg₂(Si₄O₁₀)F₂, and

Na/Li hectorite (NaLi)/₃Mg_{2/3}Li_{1/3}(Si₄O₁₀)F₂.

The swelling synthetic mica generally has a thickness of 1 to 50 nm and a flat plane size of 1 to 20 μm. The thickness is preferably as small as possible for diffusion control, and the flat plane size is preferably as large as possible, as long as it does not exceed the extent where it would deteriorate the smoothness and transparency of the coated surface. The swelling synthetic mica usually has an aspect ratio of 100 or larger, preferably 200 or larger and more preferably 500 or larger.

In case of employing the aforementioned ordinary gelatin, when the ratio of the mica is increased (1.5-10% or higher to gelatin), viscosity increases and gelation at a constant solid concentration accelerates (e.g., 5 to 10%), so that reduction of the viscosity becomes necessary. In order to reduce the gelatin viscosity, a method of decreasing the concentration may be adopted, but reduction in the concentration increases a drying load for the coated film, eventually resulting in a deteriorated surface condition by thicker coating.

Also, there is known a method of adding urea or a salt to the coating solution, but such methods cannot attain sufficient reduction of the viscosity and cannot provide satisfactory surface state after coating. In contrast, the aforementioned gelatin is free from such drawbacks and is advantageous in significantly reducing the viscosity increase and the gelation, even when mica is used in combination.

A content of the water swelling synthetic mica in the undercoat layer is preferably 1/20 to 1/2 in a mica/gelatin mass ratio.

With the content of the water swelling synthetic mica within such a range, the undercoat layer can satisfactorily function as an oxygen intercepting layer, and can also prevent deterioration of manufacturing properties such as a coating property.

In the undercoat layer, the coating amount of the mica is usually 0.01 g/m² or higher, preferably 0.02 g/m² or higher. With the coating amount within such range, the mica provides sufficient oxygen intercepting ability in the undercoat layer and can exhibit a property of preventing coloration in the background portion.

<Light Transmittance Control Layer>

In the thermal recording material of the invention, a light transmittance control layer is preferably provided in order to improve light fastness.

The light transmittance control layer may include an ultraviolet absorber precursor, which does not function as an ultraviolet absorber prior to irradiation with light of a wavelength region required for fixation of a photo-fixable thermal recording layer, hence the layer shows a high optical transmittance. Also at the fixation of the photo-fixable thermal recording layer, the light transmittance control layer sufficiently transmits the light of the wavelength region required for fixation, and also shows a high light transmittance in the visible region, thereby not hindering the fixation of the thermal recording layer. This ultraviolet absorber precursor is preferably included in microcapsules. The compound to be included in the light transmittance control layer can be those described in JP-A No. 9-1928.

After irradiation with light of the wavelength region required for the fixation of the thermal recording layer by light irradiation, the ultraviolet absorber precursor is reacted by light or heat to become functionable as an ultraviolet absorber. Most of the light of the ultraviolet wavelength region required for the fixation is absorbed by the ultraviolet absorber, whereby the transmittance is lowered. Therefore the light fastness of the thermal recording material is improved, but the transmittance for visible light remains substantially unchanged because the ultraviolet absorber lacks an absorbing effect for visible light.

The light transmittance control layer can be provided in at least one layer in the thermal recording material. It is most preferably provided between a thermal recording layer and an outermost protective layer. The light transmittance control layer may also be constructed so as to serve as a protective layer. Characteristics of the light transmittance control layer can be selected according to the characteristics of the thermal recording layer.

The coating solution for forming the light transmittance control layer (light transmittance control layer coating solution) can be obtained by mixing the components explained in above. The light transmittance control layer can be formed by coating the thus-obtained coating solution with a known coating method such as bar coating, air knife coating, blade coating or curtain coating. The light transmittance control layer may be coated simultaneously with the thermal recording layer, or coated and formed on the thermal recording layer after the coating solution for forming the thermal recording layer is coated and dried.

The dry coating amount of the light transmittance control layer is preferably within a range of 0.8 to 4.0 μm².

<Intermediate Layer>

When superposing multiple thermal recording layers, an intermediate layer is preferably provided between the thermal recording layers. The intermediate layer may contain, as in the protective layer, various binders, a pigment, a lubricant, a surfactant, a dispersant, a fluorescent whitening agent, a metal soap, an ultraviolet absorber, etc. The binder can be similar to those used in the protective layer. Also, in order to increase the film strength of the thermal recording material, a hardening agent such as a crosslinking agent such as boric acid capable of causing a crosslinking reaction with the binder of the protective layer can be added in a coating solution for the intermediate layer.

The thermal recording layer, the light transmittance control layer, the intermediate layer, etc. can be formed, on a support, by coating and drying with known coating methods such as blade coating, air knife coating, gravure coating, roll coating, spray coating, dip coating or bar coating.

(Antioxidant)

In the invention, in order to further improve light fastness, known antioxidants as shown in the following patent documents may be added to the thermal recording material.

Examples of such antioxidants include those described in EP-A No. 310551, GP-A No. 3435443, EP-A No. 310552, JP-A No. 3-121449, EP-A No. 459416, JP-A Nos. 2-262654, 2-71262 and 63-163351, U.S. Pat. No. 4,814,262, JP-A Nos. 54-48535, 5-61166 and 5-119449, U.S. Pat. No. 4,980,275, JP-A Nos. 63-113536 and 62-262047, EP-A Nos. 223739, 309402 and 309401. Specific examples of the antioxidant are shown below.

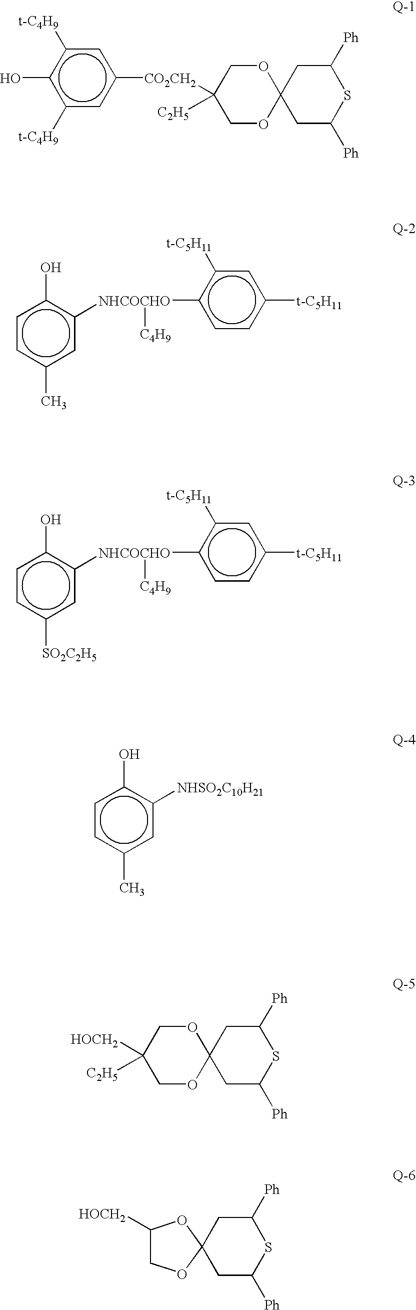

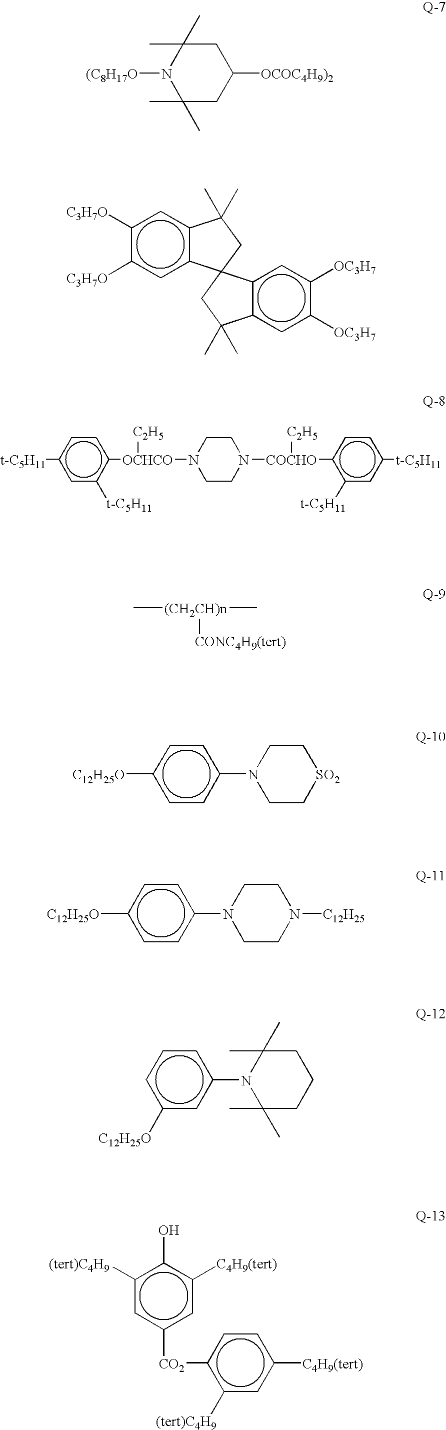

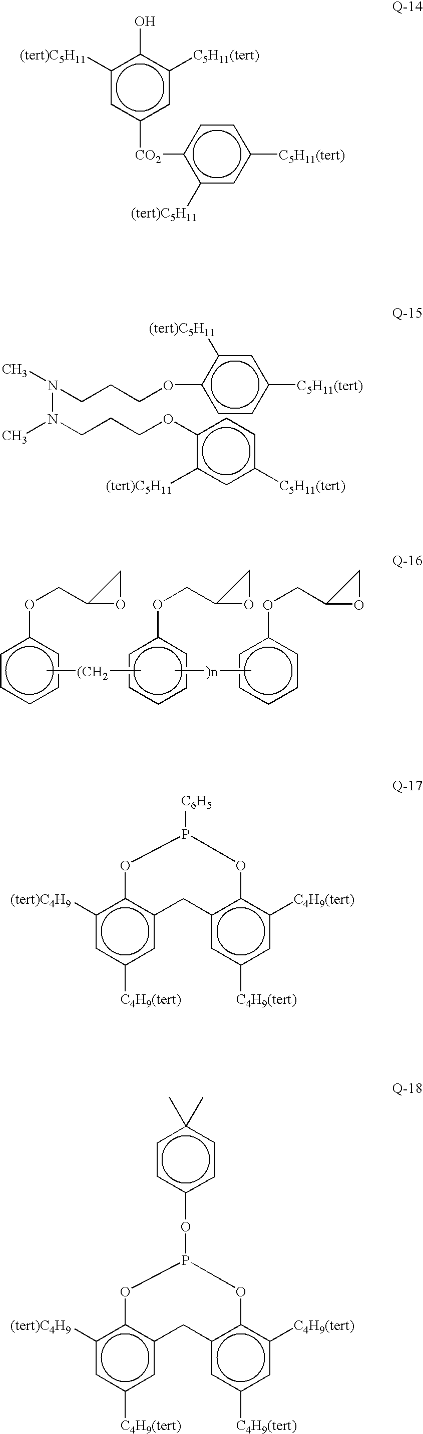

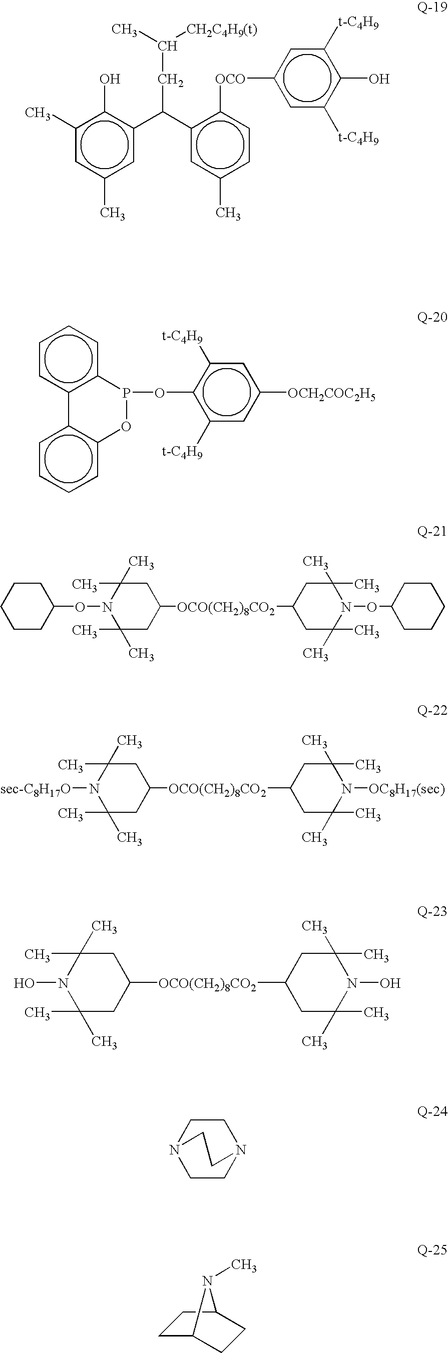

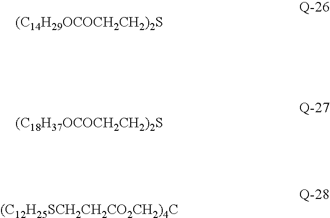

Examples of the antioxidant include those described in JP-A Nos. 60-125470, 60-125471, 60-125472, 60-287485, 60-287486, 60-287487, 62-146680, 60-287488, 62-282885, 63-89877, 63-88380, 63-088381, 01-239282, 04-291685, 04-291684, 05-188687, 05-188686, 05-110490, 05-1108437, 05-170361, 63-203372, 63-224989, 63-267594, 63-182484, 60-107384, 60-107383, 61-160287, 61-185483, 61-211079, 63-251282 and 63-051174, JP-B Nos. 48-043294 and 48-033212.

Specific examples of the antioxidant include

6-ethoxy-1-phenyl-2,2,4-trimethyl-1,2-dihydroquinoline,

6-ethoxy-1-octyl-2,2,4-trimethyl-1,2-dihydroquinoline,

6-ethoxy-1-phenyl-2,2,4-trimethyl-1,2,3,4-tetrahydroquinoline,

6-ethoxy-1-octyl-2,2,4-trimethyl-1,2,3,4-tetrahydroquinoline,

nickel cyclohexanate,

2,2-bis-4-hydroxyphenylpropane,

1,1-bis-4-hydroxyphenyl-2-ethylhexane,

2-methyl-4-methoxy-diphenylamine, and

1-methyl-2-phenylindole.

Such antioxidant may be added in the thermal recording layer, the intermediate layer, the light transmittance control layer or in the protective layer.

Second Embodiment

A second embodiment of the thermal recording material of the invention is that it includes, on a support, a thermal recording layer and a protective layer containing at least polyvinyl alcohol and ultrafine inorganic particles, and further includes boric acid and a water-soluble zirconium compound. Due to this configuration, the thermal recording material of the second embodiment is capable of reducing unevenness due to loading change when printing while maintaining high glossiness, and also reducing printing torque, thereby avoiding density unevenness and providing a high-quality recorded image. Also, due to improvement in the water-resistance on the surface of the thermal recording material, deterioration in the image quality can be prevented, resulting from transfer of water drops generated by condensation in the recording apparatus (e.g., at the start of a printing operation) onto the print surface of the thermal recording material.

The thermal recording material of this embodiment, as in the first embodiment, has a thermal recording layer and a protective layer in this order on a support, but there may also be provided another layer suitably selected according to the purpose, such as an undercoat layer provided between the support and the thermal recording layer, an intermediate layer provided between the multiple thermal recording layers, or a light transmittance control layer provided between the thermal recording layer and the protective layer.

In the present embodiment, the boric acid and the water-soluble zirconium compound may be included in a coating solution for the protective layer or in a coating solution for the thermal recording layer. Otherwise, the boric acid and the water-soluble zirconium compound may be included in a coating solution for forming other layers. However, in case an undesirable reaction or interaction with another component is anticipated, it is possible to adopt a method of including them, for example, in the coating solution for the intermediate layer and transferring them to a desired layer by diffusion.

A detailed description on principal layers constituting the invention and components thereof will be given below.

(Protective Layer)

The protective layer is provided for improving sticking characteristics of the thermal recording layer and for protecting the thermal recording layer from solvent or external air. The protective layer in the present embodiment at least includes polyvinyl alcohol resin as a binder, and ultrafine inorganic particles as a filler, and may contain other various additives or fillers if necessary.

(Polyvinyl Alcohol)

Polyvinyl alcohol is employed as a binder resin for the protective layer of the invention. The polyvinyl alcohol can be suitably selected among known polyvinyl alcohols as long as they do not hinder the effect of the invention, and specific examples include those described in JP-A No. 2000-118133.

The polyvinyl alcohol in the invention preferably has an average polymerization degree of 600 to 2000, and more preferably 1200 to 1800.

Polyvinyl alcohol to be employed in the invention includes a derivative thereof. This derivative is preferably alkyl ether-modified polyvinyl alcohol, silanol-modified polyvinyl alcohol, carboxyl-modified polyvinyl alcohol, a hydrdophobic group-modified polyvinyl alcohol, ethylene-modified polyvinyl alcohol, or itaconic acid-modified polyvinyl alcohol, and alkyl ether-modified polyvinyl alcohol is particularly preferred.

In the protective layer of the invention, another binder may be used in combination with polyvinyl alcohol, if necessary. This binder can be employed in the protective layer of the foregoing first embodiment. In addition, a water-soluble polymer such as a vinyl acetate-acrylamide copolymer or a polyacrylamide derivative, or a methyl acrylate-butadiene rubber may also be used.

In the polyvinyl alcohol constituting the binder of the invention, the preferred range of glass transition temperature (Tg) and the preferred range of the content of polyvinyl alcohol in the protective layer are similar to those in the foregoing first embodiment. In case another binder is employed in combination, it is preferred that all the binders meet the aforementioned content.

(Long-Chain Alkyl Ether-Modified Polyvinyl Alcohol)

As in the first embodiment, the present embodiment preferably employs a long-chain alkyl ether-modified polyvinyl alcohol, as the alkyl ether-modified polyvinyl alcohol. The use of such long-chain alkyl ether-modified polyvinyl alcohol improves dispersibility of the ultrafine inorganic particles employed as the filler, thereby improving the surface smoothness of the thermal recording material and compensating for loss in glossiness resulting from addition of the ultrafine inorganic particles.

The long-chain alkyl ether-modified polyvinyl alcohol is preferably an alkyl ether-modified polyvinyl alcohol, which is modified with an alkyl ether group with 8 to 20 carbon atoms. The long-chain alkyl ether-modified polyvinyl alcohol can be similar to that employed in the protective layer of the foregoing first embodiment, and the description thereof is also similar. In particular, there is preferred alkyl ether-modified polyvinyl alcohol represented by general formulae (A-1) to (A-4) explained in the first embodiment. Also, regarding general formulae (A-1) to (A-4), the preferred range of Tg of the long-chain alkyl ether-modified polyvinyl alcohol, and a content of the alkyl ether-modified polyvinyl alcohol in the protective layer based on the entire binder, are also similar to those in the first embodiment.

In the protective layer of the present embodiment, in addition to the aforementioned long-chain alkyl ether-modified polyvinyl alcohol, a combination of another polyvinyl alcohol or another binder may be used, if necessary. Another binder to be employed in combination with the long-chain alkyl ether-modified polyvinyl alcohol is preferably polyvinyl alcohol or a derivative thereof (hereinafter, collectively referred to as “polyvinyl alcohol”), and preferred specific examples include those described in JP-A No. 2000-118133.

The content of the binder in the protective layer of the present embodiment is preferably 25 to 80% by mass with respect to the entire protective layer, more preferably 40 to 70% by mass.

(Boric Acid)

Boric acid, which is a hardening agent for the aforementioned polyvinyl alcohol, is included in the thermal recording material of the present embodiment in order to increase the hardness and strength of the protective layer.

The content of boric acid in the thermal recording material is preferably 10 to 30% by mass based on the total amount of polyvinyl alcohol employed in layers at a recording surface side of the thermal recording material (i.e., a side of the thermal recording layer on the support), more preferably 14 to 28% by mass and most preferably 18 to 24% by mass. Boric acid contained within the aforementioned ranges based on the total amount of polyvinyl alcohol employed in the thermal recording material can sufficiently harden the protective layer and the like, and can inhibit diffusion of the lubricant when printing, thereby preventing a decrease in the hydrophobicity of the surface of the protective layer, which leads to deterioration in image quality or glossiness.

In the process of forming various layers on the support, the boric acid to be employed in the invention may be added in a coating solution for any layer. It can be added to a coating solution for any layer employing polyvinyl alcohol resin, including the protective layer, by regulating the pH value of such a coating solution. Among these, boric acid functioning as a hardening agent in the invention is preferably added to a coating solution for the intermediate layer in order to prevent an undesirable reaction or an undesirable interaction with another component. Boric acid added in the coating solution for the intermediate layer or the like can promptly diffuse to other layers, almost simultaneously with the coating of each coating solution on the support for forming the protective layer, the thermal recording layer and the intermediate layer on the support, thereby causing a crosslinking reaction with polyvinyl alcohol contained in the coating solution for the protective layer, etc.

In the present embodiment, a known crosslinking agent other than boric acid may be employed in combination as long as it does not inhibit the effect of the invention. Examples of such known crosslinking agents include a vinyl sulfone compound, an aldehyde comopound (e.g., formaldehyde, glutaraldehyde, etc.), an epoxy compound, an oxazine compound, a triazine compound, the polymer hardening agent described in JP-A No. 62-234157, a methylated melamine, a blocked isocyanate, a methylol compound and a carbodimide resin.

(Water-Soluble Zirconium Compound)

In the thermal recording material of the invention, a water-soluble zirconium compound is included in addition to the boric acid mentioned above for the purpose of reducing image unevennness due to load change and decreasing printing torque, thereby reducing unevenness in the density.

The content of the water-soluble zirconium compound in the thermal recording material is preferably 0.1 to 10% by mass based on the total amount of polyvinyl alcohol employed in layers at a recording surface side of the thermal recording material (i.e., a side of the thermal recording layer on the support), more preferably 0.3 to 8% by mass and most preferably 0.5 to 6% by mass. A content within these ranges can sufficiently reduce printing torque in the protective layer. Also, the content within the aforementioned ranges can prevent inducing loss in the glossiness by interaction with a dispersion of fine inorganic particles or an emulsion of lubricant fine particles present together.

The water-soluble zirconium compound to be employed in the thermal recording material of the invention can be a metal salt or a complex of zirconium. In the present specification, a “water-soluble zirconium compound” means a compound having a solubility of 1 g or higher in 100 g of water of 25° C., the solubility being preferably 5 g or higher and more preferably 10 g or higher.

Specific examples of the water-soluble zirconium compound include zirconium acetylacetonate, zirconyl acetate, zirconyl sulfate, zirconium ammonium carbonate, zirconium potassium carbonate, zirconyl octylate, zirconyl nitrate, zirconium oxychloride, and zirconium hydroxychloride.

Also, the water-soluble zirconium compounds employable in the first embodiment is also usable in the present embodiment.

Among these, zirconyl acetate, zirconium ammonium carbonate, zirconium potassium carbonate or zirconyl nitrate are particularly preferred.

Also, commercially available water-soluble zirconium compounds can be advantageously employed, such as those manufactured by Newtex Co. under the trade names Zircosol AC7, Zircosol HA, Zircosol ZA-2 and Zircosol ZN.

In a process of forming various layers on the support, the water-soluble zirconium compound to be employed in the invention may be added in a coating solution for any layer. Among these, the water-soluble zirconium compound may be directly added to a coating solution for the protective layer, in case no undesirable reaction or interaction with another component is anticipated. Otherwise, it may be added in a coating solution for the intermediate layer. In this case, the water-soluble zirconium compound added to the coating solution diffuses to other layers, almost simultaneously with the coating of each coating solution on the support for forming different layers. Thus the water-soluble zirconium compound promptly moves to the protective layer and exhibits its effect.

In the present embodiment, the water-soluble zirconium compound may be used in combination with a known water-soluble metal salt or a known hydrophobic metal salt compound, as long as it does not inhibit the effect of the invention. Examples of such usable compounds include metal salt or a complex of magnesium, aluminum, calcium, scandium, titanium vanadium, manganese, iron, nickel, copper, zinc, gallium, germanium, strontium, yttrium, molybdenum, indium, barium, lanthanum, cerium, praseodymium, neodymium, samarium, europium, gadolinium, dysprosium, erbium, ytterbium, hafnium, tungsten and bismuth.

(Ultrafine Inorganic Particles)

The protective layer of the invention includes ultrafine inorganic particles together with the aforementioned polyvinyl alcohol. Ultrafine inorganic particles having a small particle size make maintaining high hardness without affecting the smoothness of the surface possible.

The “ultrafine inorganic particles” can be the same as those in the first embodiment, hence the description, preferred embodiments and specific examples thereof are also the same.

The ultrafine inorganic particles to be employed in the present embodiment can be, for example, colloidal silica, barium sulfate, zinc oxide, magnesium oxide, lead oxide, zirconium oxide, or alumina, among which preferred is colloidal silica, barium sulfate or alumina and particularly preferred is barium sulfate having an average particle size of 0.05 to 0.20 μm, since such material is less susceptible to the influence of a charge or pH and shows high dispersion stability in the coating solution for the protective layer.

(Thermal Recording Layer)

In the present embodiment, there are preferably provided, as photo-fixable thermal recording layers, a photo-fixable thermal recording layer including a diazonium compound having a maximum absorption wavelength at 365±40 nm and a coupler capable of forming a color by reaction with the diazonium compound, and a photo-fixable thermal recording layer including a diazonium compound having a maximum absorption wavelength of 425±40 nm and a coupler capable of forming a color by reaction with the diazonium compound.

The thermal recording material of the present embodiment is applicable also to a configuration including a photo-fixable thermal recording layer including a diazonium compound having a maximum absorption wavelength of less than 380 nm and a coupler capable of forming a color by reaction with the diazonium compound, and a photo-fixable thermal recording layer including a diazonium compound having a maximum absorption wavelength exceeding 390 nm and a coupler capable of forming a color by reaction with the diazonium compound.

Also, in the case of multiple photo-fixable thermal recording layers, a multi-color thermal recording material can be obtained by changing the color hues of the photo-fixable thermal recording layers. More specifically, full-color image recording is possible by selecting three primary colors in the subtractive color mixing, namely yellow, magenta and cyan, for the color hues to be formed in these photo-fixable thermal recording layers. In this case, the color forming mechanism of a photo-fixable thermal recording layer to be directly laminated on the support (i.e., the lowermost photo-fixable thermal recording layer) is not limited to a combination of an electron donating dye and an electron accepting dye, but can also be a diazo color forming system based on a diazonium salt and a coupler capable of reacting with the diazonium salt to form a color, a base color forming system for forming a color by contact with a basic compound, a chelate color forming system or a color forming system capable of causing a cleavage reaction in contact with a nucleophilic agent to form a color. In such a photo-fixable thermal recording layer, there are preferably provided two or more photo-fixable thermal recording layers, each containing a diazonium compound having a respectively different maximum absorption wavelength and a coupler capable of forming a color by reaction with the diazonium compound.

In the invention, any well-known component may be used as a color forming component in the photo-fixable thermal recording layer. In particular, it is preferred to use a color forming component utilizing a reaction of a diazonium compound and a coupler, or utilizing a reaction of an electron donating colorless dye and an electron accepting compound. Examples of compounds to be employed in a photo-fixable thermal recording layer including the diazonium compound and the coupler include, in addition to such diazonium compound and such coupler, a base substance capable of accelerating the reaction of the diazonium compound and the coupler. These diazonium compounds, couplers and base substances are described in detail, for example, in JP-B Nos. 4-75147, 6-55546 and 6-79867, JP-A Nos. 4-201483, 60-49991, 60-242094, 61-5983, 63-87125, 4-59287, 5-185717, 7-88356, 7-96671, 8-324129, 9-38389, 5-185736, 5-8544, 59-190866, 62-55190, 60-6493, 60-259492, 63-318546, 4-65291, 5-185736, 5-204089, 8-310133, 8-324129, 9-156229 and 9-175017. Specific examples of these materials are shown below, but the invention is not limited to such examples, and the diazonium compound, the coupler and the base substance explained in the first embodiment may also be used.

Specific Examples of Diazonium Compound

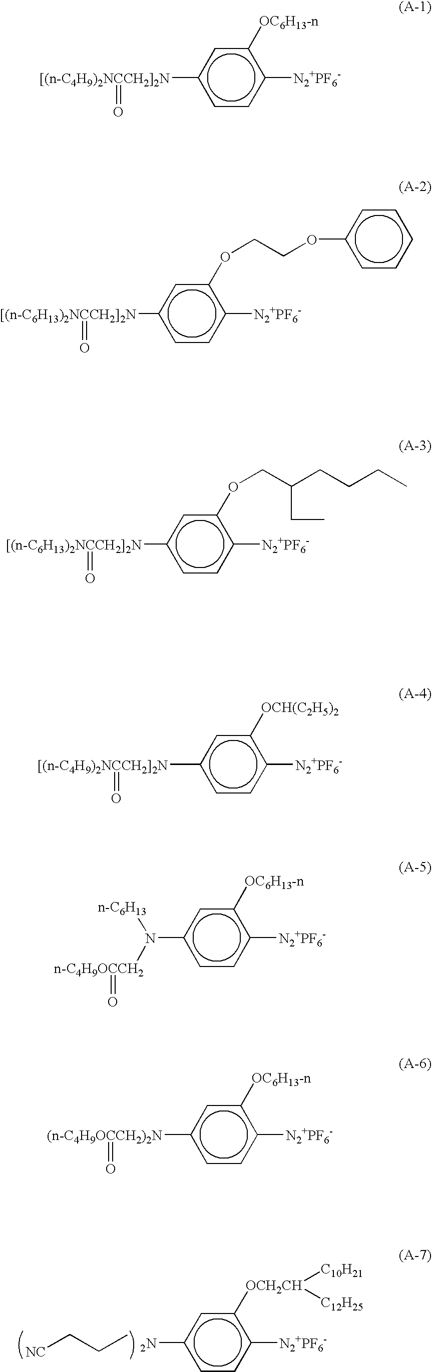

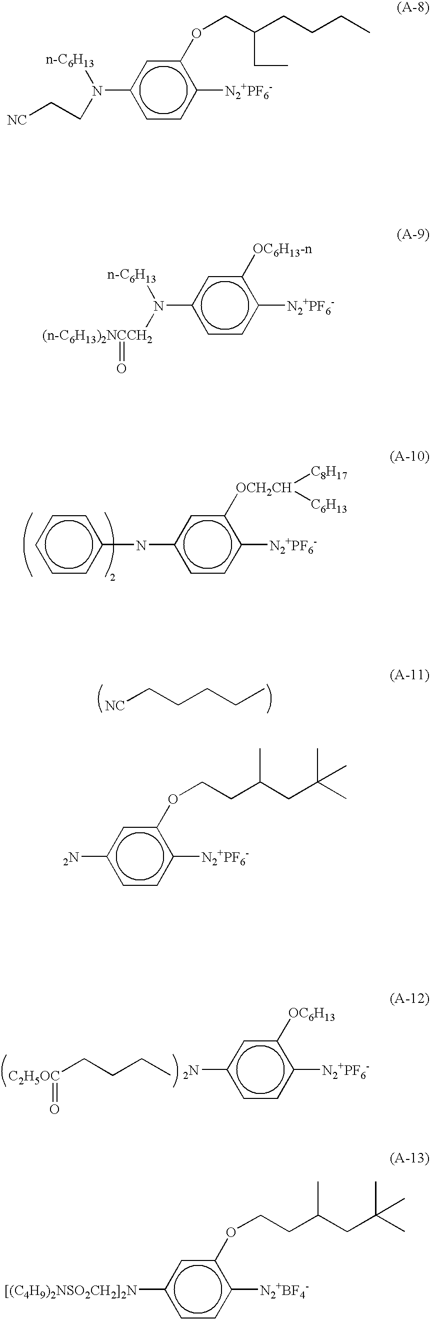

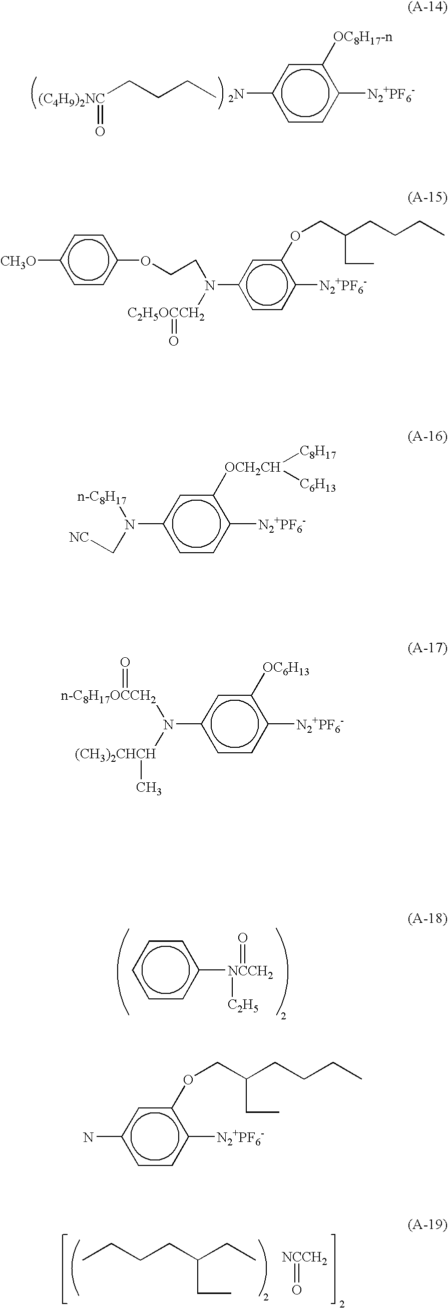

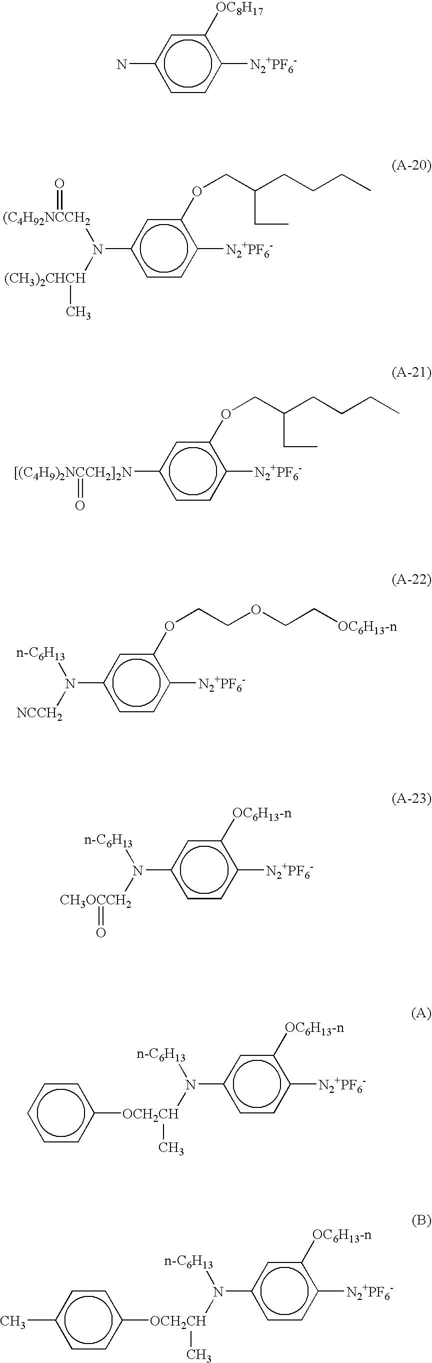

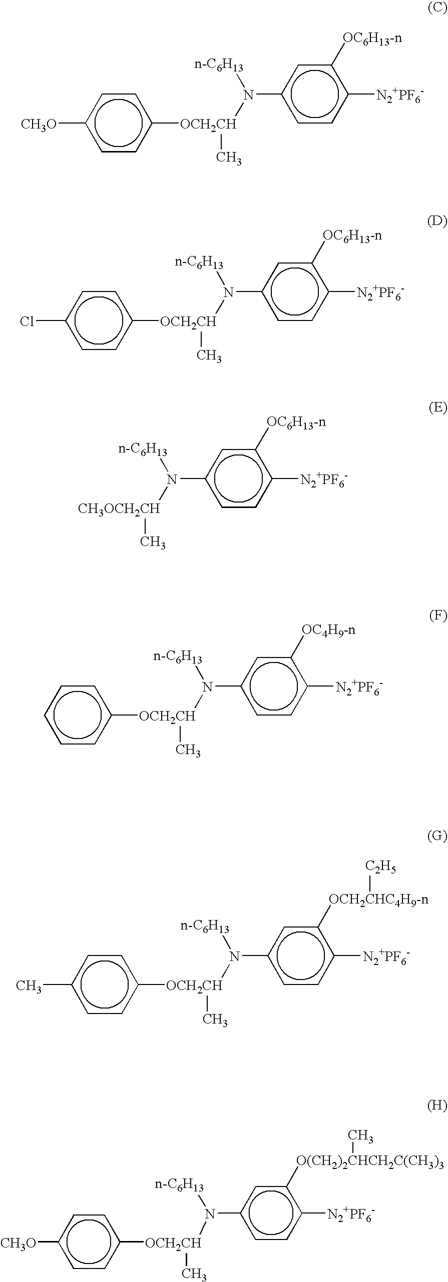

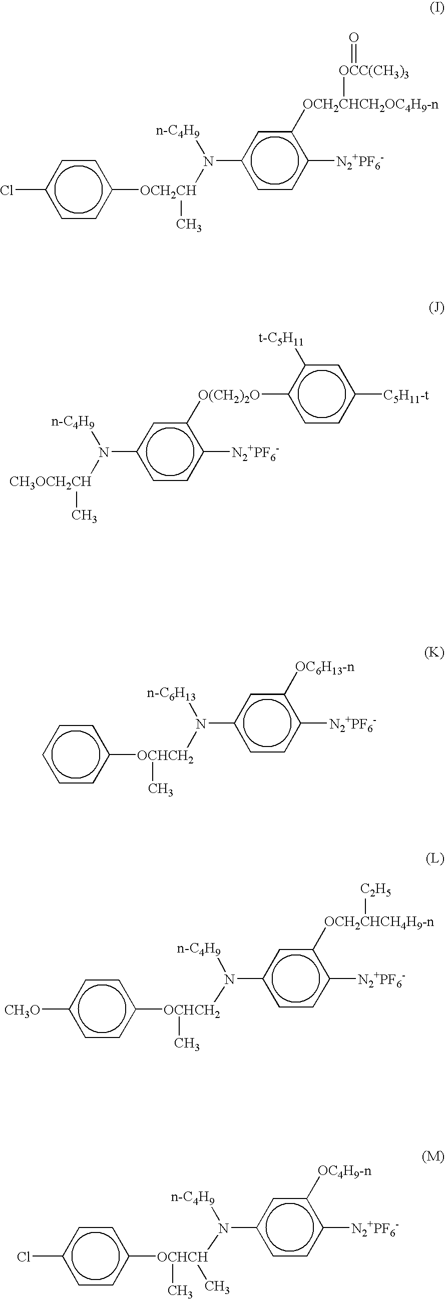

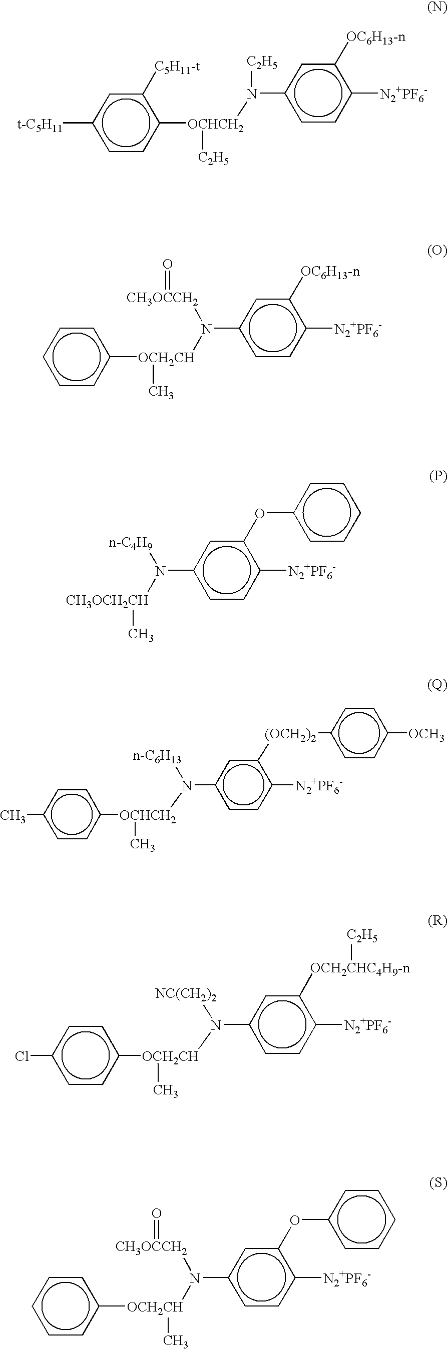

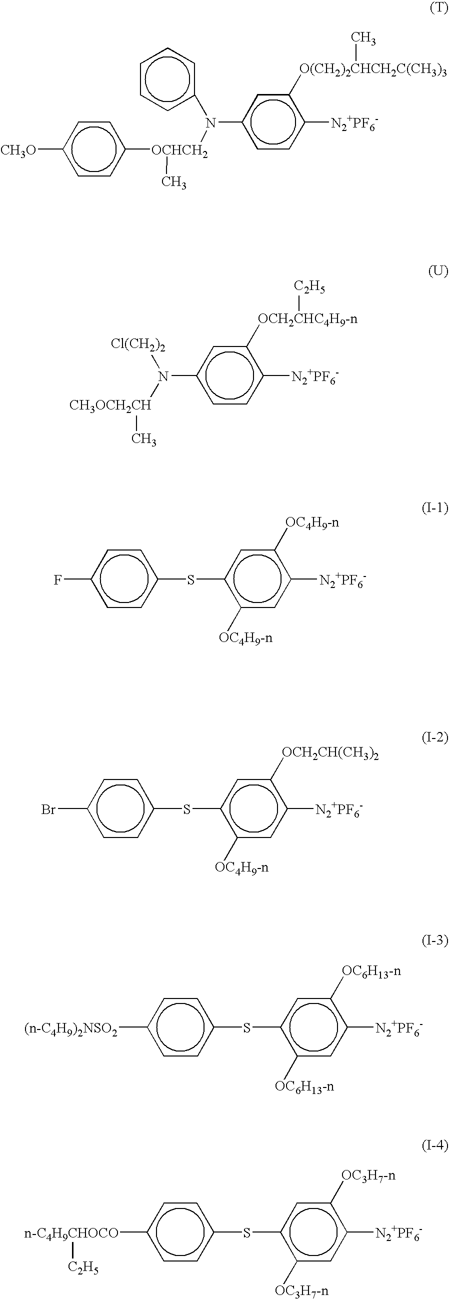

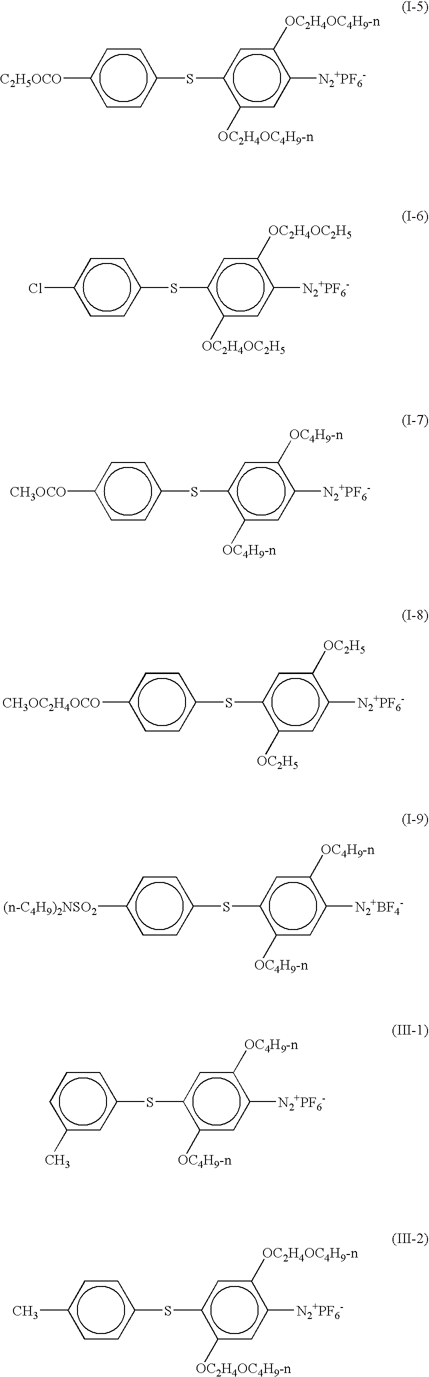

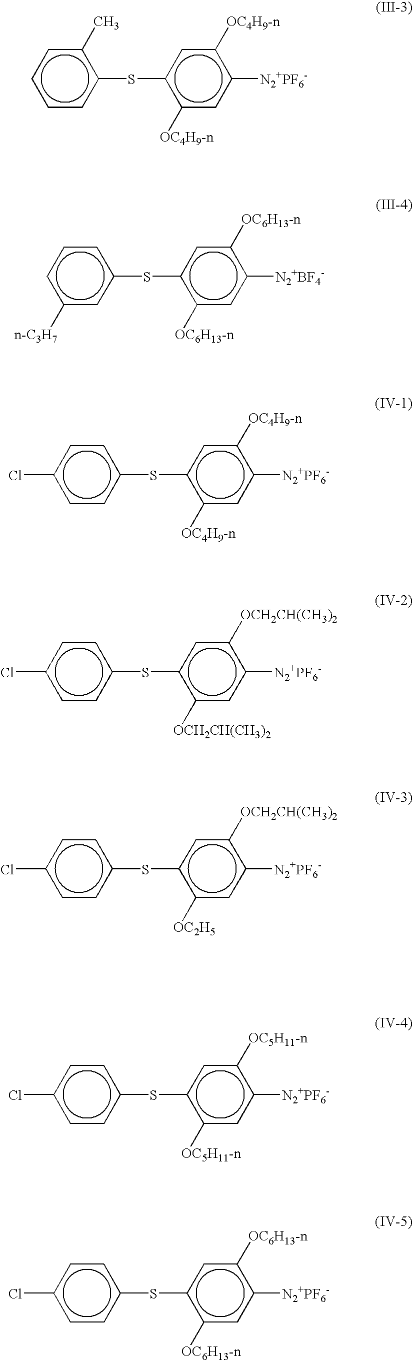

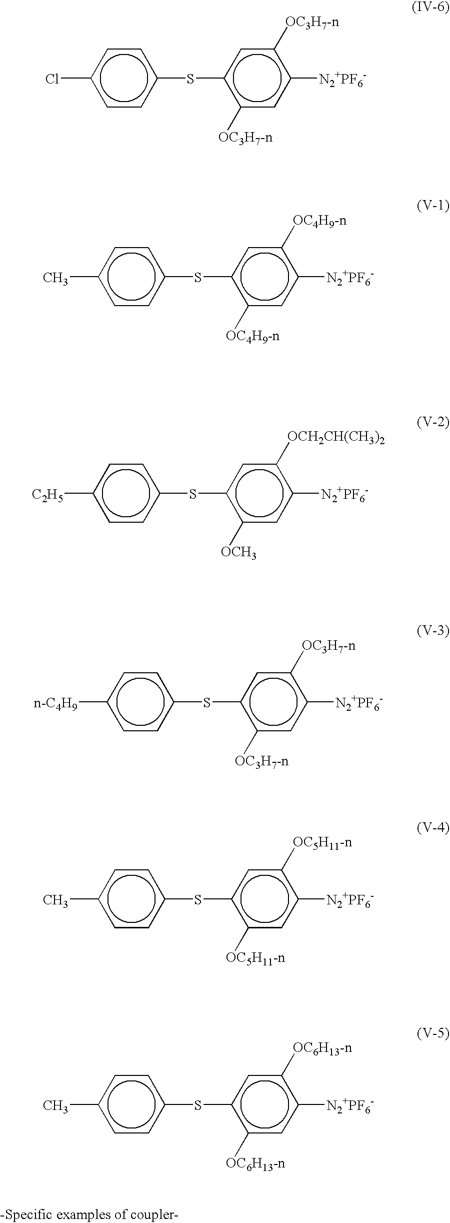

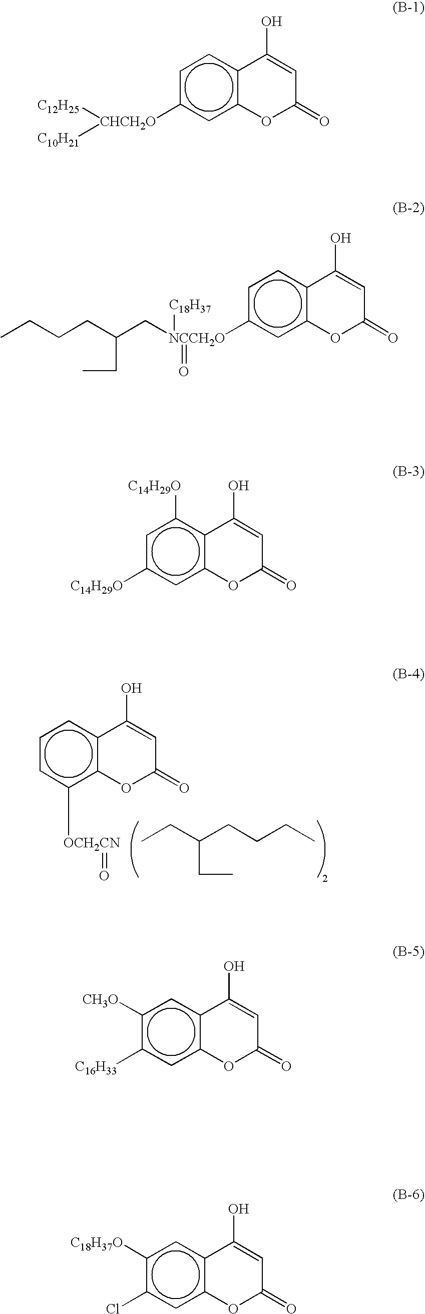

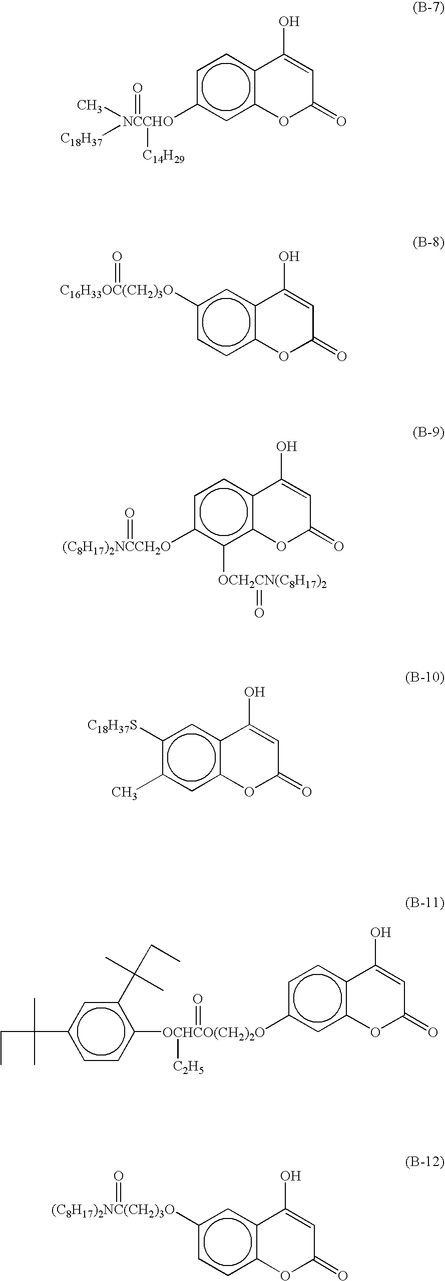

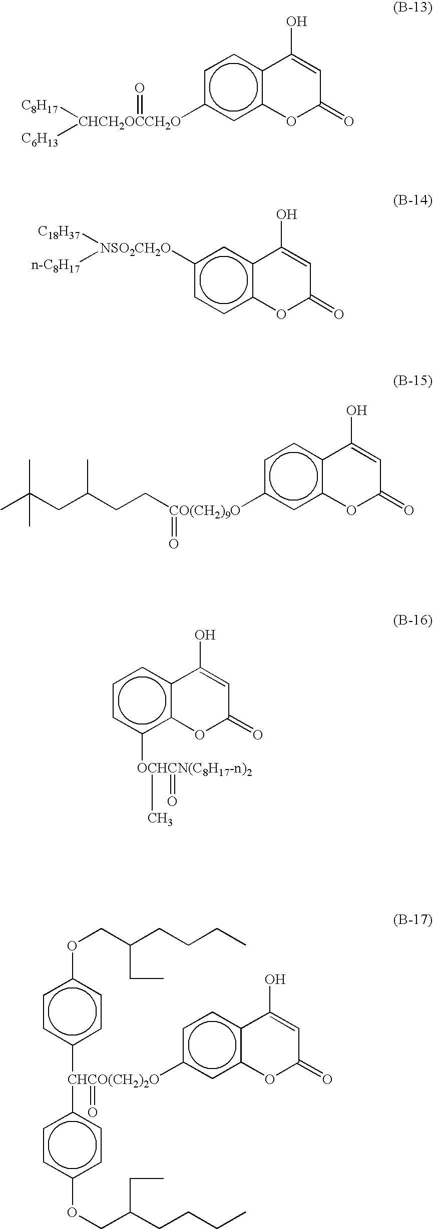

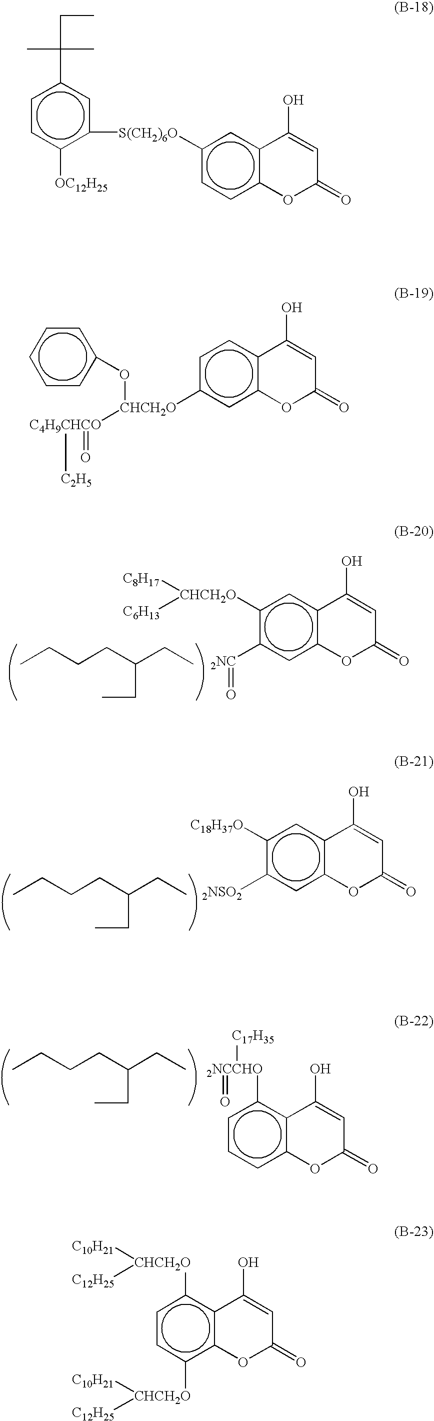

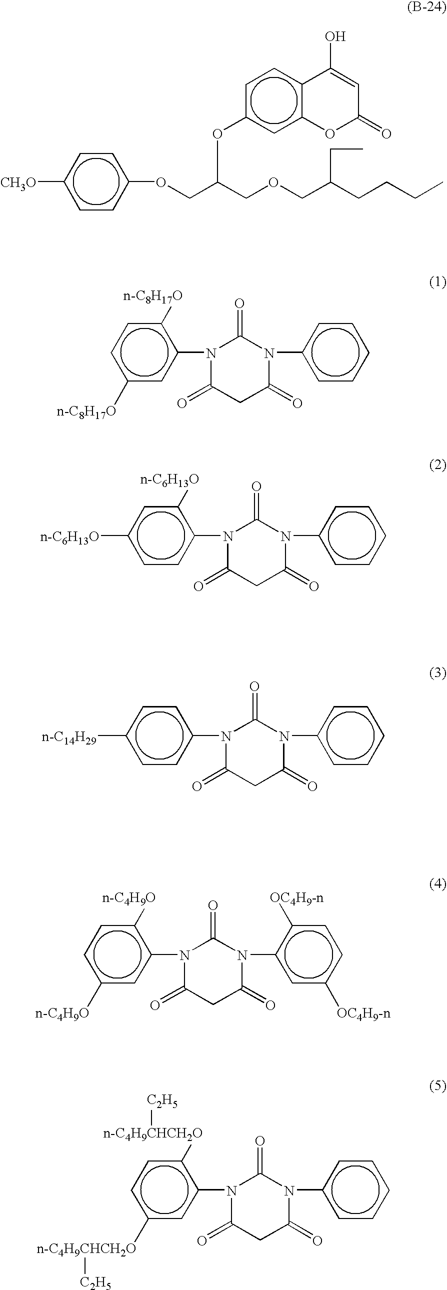

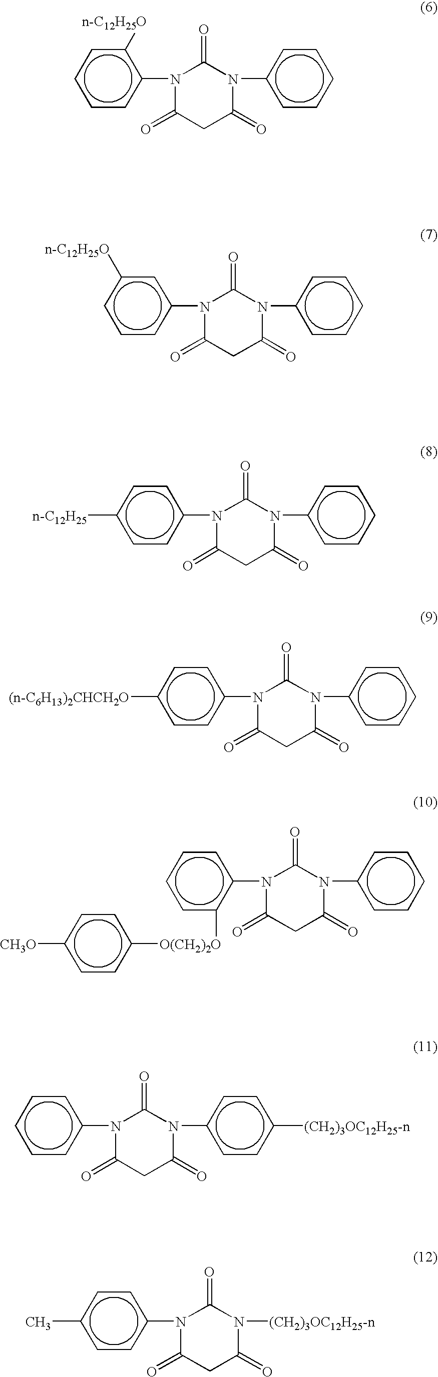

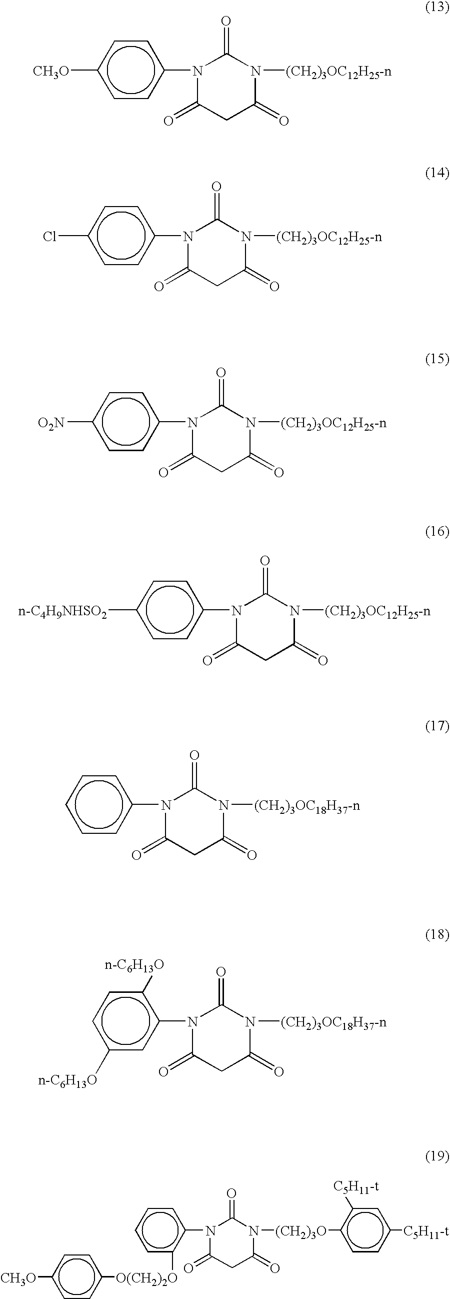

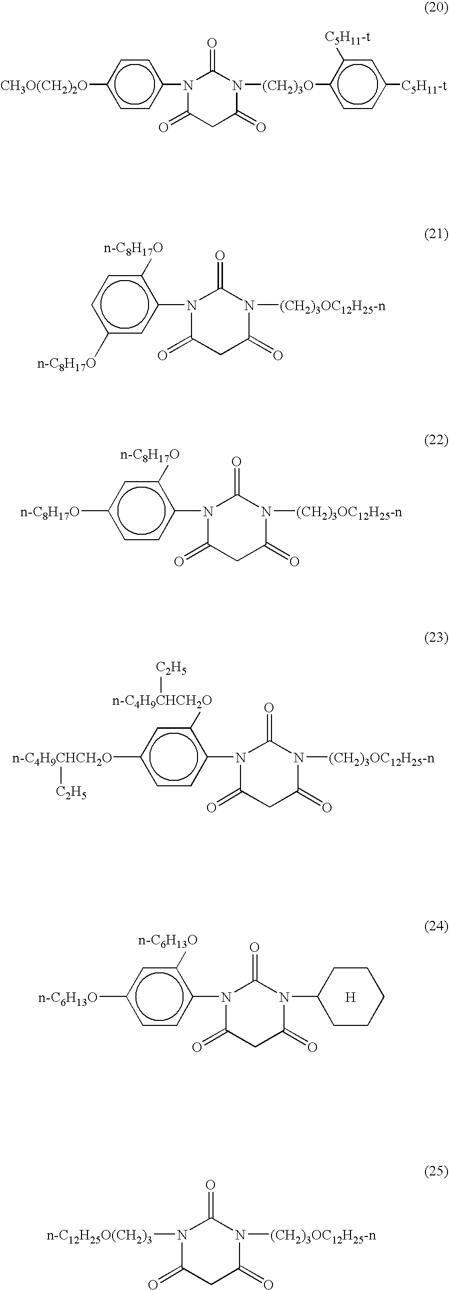

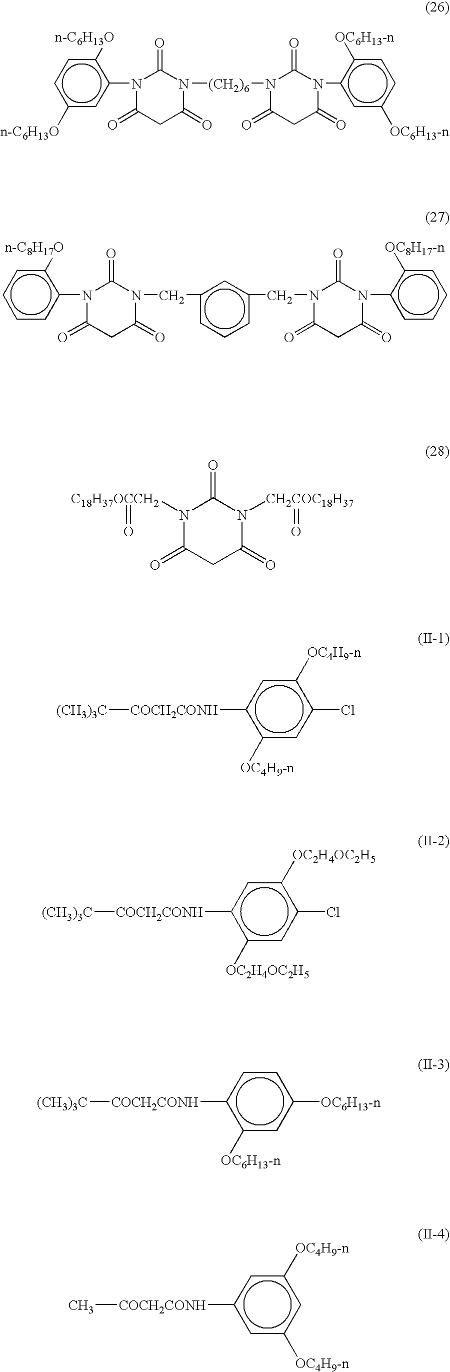

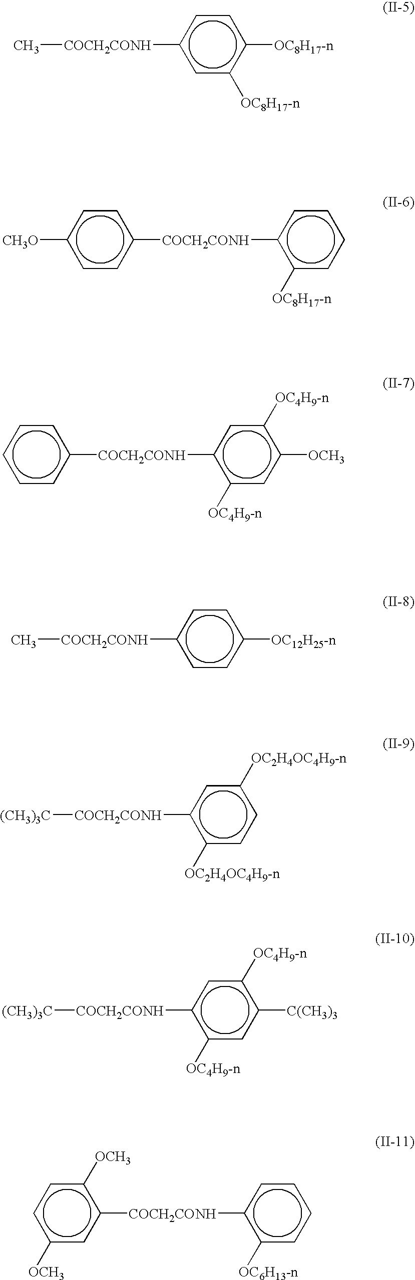

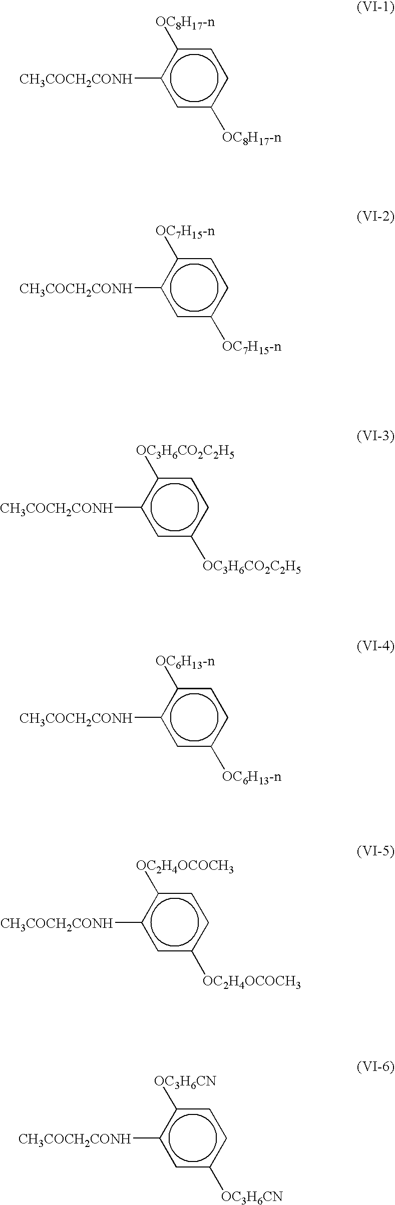

Specific Example of Base Substance

The base substance may be used singly or in combination of two or more types. Examples of the base substance include a nitrogen-containing compound such as a tertiary amide, a piperidine, a piperadine, an amidine, a formamidine, a pyridine, a guanidine, and a morpholine.

Particularly preferred examples of the base substance include:

a piperadine such as N,N′-bis(3-phenoxy-2-hydroxypropyl)piperadine, N,N′-bis(3-(p-methylphenoxy)-2-hydroxypropyl)piperadine, N,N′-bis(3-(p-methoxyphenoxy)-2-hydroxypropyl)piperadine, N,N′-bis(3-phenylthio-2-hydroxypropyl)piperadine, N,N′-bis(3-(β-naphthoxy)-2-hydroxypropyl)piperadine, N-3-(β-naphthoxy)-2-hydroxypropyl-N′-metghylpiperadine, or 1,4-bis((3-N-methylpiperadino)-2-hydroxy)propyloxy)benzene,

a morpholine such as N-(3-(β-naphthoxy)-2-hydroxy)propylmorpholine, 1,4-bis((3-morphoilino-2-hydroxy)propyloxy)benzene or 1,3-bis((3-morpholino-2-hydroxy)propyloxy)benzene; a piperidine such as N-(3-phenoxy-2-hydroxypropyl)piperidine or N-dodecylpiperidine; or a guanidine such as triphenylguanidine, tricyclohexylguanidine, or dicyclohexylphenylguanidine.

The electron donating colorless dye and the electron accepting compound mentioned in the foregoing are described in detail, for example, in JP-A Nos. 6-328860, 7-290826, 7-314904, 8-324116, 3-37727, 9-31345, 9-111136, 9-118073, and 11-157221. Specific examples are shown below, however, the invention is not limited to such examples, and the electron donating colorless dye and the electron accepting compound in the first embodiment may also be used.

Specific Examples of Electron Donating Colorless Dye

TABLE 1

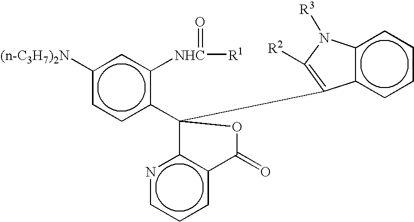

| | R¹ | R² | R³ |
|---|---|---|---|
| i-1 | —CH₃ | —CH₃ | —C₂H₅ |
| i-2 | —C₂H₅ | —CH₃ | —C₂H₅ |
| i-3 | —CH(CH₃)₂ | —CH₃ | —C₂H₅ |
| i-4 | —C(CH₃)₃ | —CH₃ | —C₂H₅ |
| i-5 | 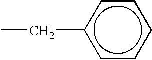 | —CH₃ | —C₂H₅ |
| i-6 | 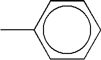 | —CH₃ | —C₂H₅ |
| i-7 | —CH₂OCH₃ | —CH₃ | —C₂H₅ |
| i-8 | —CH₂Cl | —CH₃ | —C₂H₅ |
| i-9 | —CCl₃ | —CH₃ | —C₂H₅ |
| i-10 | —CF₃ | —CH₃ | —C₂H₅ |
| i-11 | 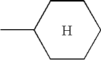 | —CH₃ | —C₂H₅ |
| i-12 | 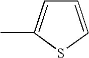 | —CH₃ | —C₂H₅ |
| i-13 | —C₃H₇(n) | —CH₃ | —C₂H₅ |
| i-14 | —CH₃ | —CH₃ | —C₄H₉(n) |
| i-15 | —CH₃ | —CH₃ | —C₈H₁₇(n) |
| i-16 | —CH(CH₃)₂ | —CH₃ | —C₄H₉(n) |
| i-17 | 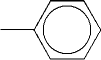 | —CH₃ | —C₅H₁₁(n) |
| i-18 | —CH₂OCH₃ | —CH₃ | —C₈H₁₇(n) |

TABLE 2

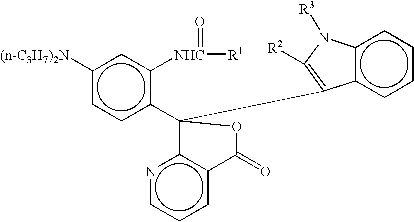

| | R¹ | R² | R³ |
|---|---|---|---|
| i-19 | —CH₃ | —CH₃ | 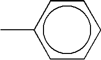 |
| i-20 | 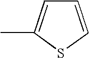 | —CH₃ | —C₆H₁₃(n) |
| i-21 | —CH₃ | 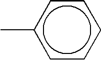 | —C₂H₅ |
| i-22 | —CH₃ | 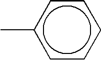 | —C₈H₁₇(n) |
| ia-1 | —C₅H₁₁(n) | —CH₃ | —C₂H₅ |
| ia-2 | —C₇H₁₅(n) | —CH₃ | —C₂H₅ |
| ia-3 | —C₁₇H₃₅(n) | —CH₃ | —C₂H₅ |
| ia-4 | 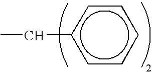 | —CH₃ | —C₂H₅ |
| ia-5 | 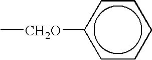 | —CH₃ | —C₂H₅ |
| ia-6 | 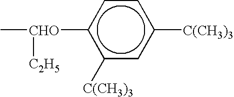 | —CH₃ | —C₂H₅ |
| ia-7 | —CH₃ | —CH₃ | —C₅H₁₁(n) |
| ia-8 | —Ch₃ | —CH₃ | —CH(CH₃)₂ |
| ia-9 | —C₃H₇(n) | —CH₃ | —C₈H₁₇(n) |
| ia-10 | —C₄H₉(n) | —CH₃ | —C₈H₁₇(n) |

TABLE 3

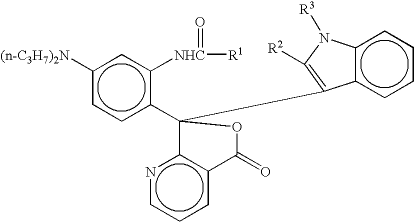

| | R¹ | R² | R³ |
|---|---|---|---|
| ia-11 | —CH(CH₃)₂ | —CH₃ | —C₈H₁₇(n) |
| ia-12 | —C₃H₇(t) | —CH₃ | —C₈H₁₇(n) |
| ia-13 | —C₄H₉(t) | —CH₃ | —C₈H₁₇(n) |
| ia-14 | 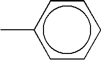 | —CH₃ | —C₈H₁₇(n) |
| ia-15 | 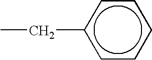 | —CH₃ | —C₈H₁₇(n) |
| ia-16 | 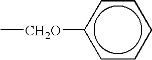 | —CH₃ | —C₈H₁₇(n) |
| ia-17 | —C₃H₇(n) | —Ch₃ | 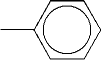 |
| ia-18 | —CH₃ | —CH₃ | 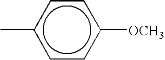 |

i-23

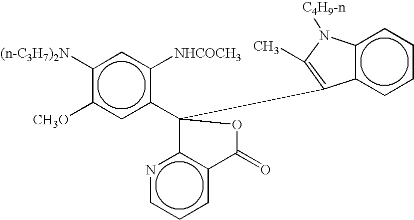

i-24

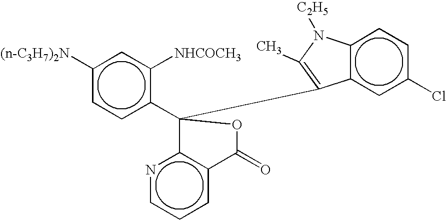

i-25

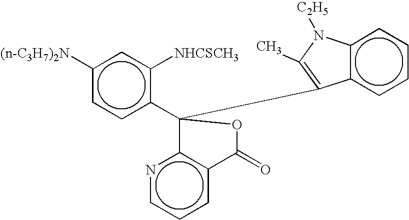

i-26

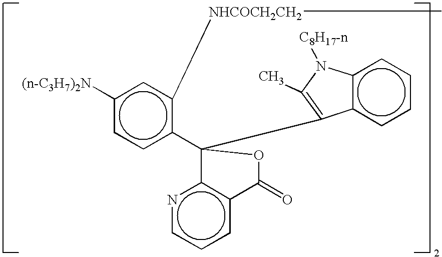

Further, the electron accepting compound can be the same as that in the first embodiment.

(Microcapsules)

In the invention, the mode of use of the diazonium compound, the coupler, the basic substance, the electron donating colorless dye, the electron accepting compound, the sensitizer, etc. is not particularly limited but can be suitably selected from (1) a method using solid dispersion; (2) a method using emulsification; (3) a method using polymer dispersion; (4) a method using latex dispersion; or (5) a method using microencapsulation. Among these methods, it is particularly preferable to use method (4) utilizing microencapsulation, in consideration of unprocessed stock storability. Particularly in a color forming system utilizing the reaction of a diazonium compound and a coupler, it is preferred to encapsulate the diazonium compound, and in a color forming reaction utilizing a reaction of an electron donating colorless dye and an electron accepting compound, it is preferred to encapsulate the electron donating colorless dye.

For microencapsulation, there can be utilized a known microencapsulating method Known methods can be used to form the microcapsules. A polymer substance forming a microcapsule wall must be impermeable at room temperature and become permeable when heated. The polymer substance preferably has a glass transition temperature within a range of 60 to 200° C. Specific examples of such substances include polyurethane, polyurea, polyamide, polyester, a urea-formaldehyde resin, a melamine resin, polystyrene, a styrene-methacrylate copolymer, a styrene-acrylate copolymer, and mixed systems thereof.

For forming the microcapsules, an interfacial polymerization method or an internal polymerization method can be used. Details of these methods and specific examples of reactants are described, for example, in U.S. Pat. Nos. 3,726,804 and 3,796,669. For example, when employing polyurea or polyurethane as the microcapsule wall material, the microcapsule wall can be prepared by mixing a polyisocyanate and a second material capable of reacting therewith to form a capsule wall (e.g., polyol or polyamine) in an aqueous medium or an oil medium to be encapsulated, emulsifying such materials in water and heating to induce a polymer forming reaction at the interface of oil droplets, thereby forming a microcapsule wall. A polyurea can be generated even when dispensing with the addition of the second material.

In the invention, the polymer substance forming the microcapsule wall is preferably at least one selected from polyurethane and polyurea.

Below, a method of preparing microcapsules will be explained using an example of microcapsules (with a polyurea/polyurethane wall) containing a diazo compound.

In the above-described method, firstly, a diazo compound is dissolved or dispersed in a high-boiling organic solvent to prepare an oil phase constituting a core of the microcapsules. In the invention, the high-boiling organic solvent is preferably employed in a proportion of 0.25 to 10 parts by mass per 1 part by mass of the diazo compound, more preferably in a proportion of 0.5 to 5 parts by mass. When the amount of the high-boiling organic solvent is within the aforementioned range, the background fog tends to remain at a low level and sufficiently high color density can be obtained. When preparing the oil phase, a polyisocyanate is added as a wall material.

The high-boiling solvent can be alkylbiphenyl, alkylnaphthalene, alkyldiphenylethane, alkyldiphenylmethane, chlorinated paraffin, tricresyl phosphate, a maleic acid ester, an adipic acid ester or a phthalic acid ester. Such high-boiling solvents can be employed in combination of two or more kinds.

In the preparation of the oil phase, the diazo compound is usually dissolved in a core oil and used. However, if the diazo compound has a low solubility in the high-boiling solvent, it is preferable to employ in combination a low-boiling organic solvent (i.e., with a boiling point of 100° C. or lower) with a high solubility as an auxiliary solvent. The low-boiling organic solvent can be ethyl acetate, butyl acetate, methylene chloride, tetrahydrofuran or acetone. In such a case, the low-boiling solvent evaporates during the capsule forming reaction and does not remain in the completed capsules, therefore, there is no particular limitation on the amount used.

It is preferred that the diazo compound has an appropriate solubility in the low-boiling organic solvent and the high-boiling organic solvent mentioned above. More specifically, it is preferred that the diazo compound has a solublity of 5% or higher in such solvents and a solubility of 1% or less in water.

On the other hand, for an aqueous phase, an aqueous solution is used in which a water-soluble polymer is dissolved, and the aforementioned oil phase is added therein and emulsified with a high-speed rotation means such as a homogenizer. The water-soluble polymer also functions as a dispersant for homogenizing and facilitating the dispersion and stabilizing the emulsified aqueous solution. Further, in order to achieve further uniform emulsification and stabilization, a surfactant may be added to at least one of the oil phase and the aqueous phase. In this regard, known emulsifying surfactants can be used. The amount of the surfactant is preferably 0.1 to 5% based on the entire mass of the oil phase, and particularly preferably 0.5 to 2%.

The water-soluble polymer, to be added to the aqueous solution used in the emulsification, preferably has a solubility of 5% or higher in water at the emulsification temperature. Specific examples of the water-soluble polymer include polyvinyl alcohol and a deviate thereof, poly acrylamide and a derivative thereof, an ethylene-vinyl acetate copolymer, a styrene-maleic anhydride copolymer, an ethylene-maleic anhydride copolymer, an isobutylene-maleic anhydride copolymer, polyvinylpyrrolidone, an ethylene-acrylic acid copolymer, a vinyl acetate-acrylic acid copolymer, carboxymethyl cellulose, methyl cellulose, casein, gelatin, a starch derivative, gum Arabic and sodium alginate.

The water-soluble polymer preferably has little to no reactivity with an isocyanate compound to be added as a wall material, and, for example in a material having a reactive amino group in a molecular chain such as gelatin, it is necessary to eliminate the reactivity by a denaturing or the like in advance.

The aforementioned polyisocyanate group-having compound is preferably a tri- or higher-functional isocyanate compound, but a bi-functional isocyanate compound may be used in combination therewith. Specific examples of a diisocyanate main material include xylene diisocyanate and hydrogenated products thereof, hexamethylene diisocyanate, tolylene diisocyanate and hydrogenated products thereof, an isophoronediisocyanate, or dimers or trimers of these (e.g., biuret or isocyanulate) or a polyfunctional adduct with a polyol such as trimethylol propane, and a formalin condensate of benzene isocyanate.

The amount of the polyisocyanate mentioned above is determined so that the microcapsules have an average particle size of 0.3 to 12 μm and a capsule wall thickness of 0.01 to 0.3 μm. The diameter of the dispersed particles is generally about 0.2 to 10 μm. A polymerization reaction of polyvalent isocyanate takes place at the interface between the oil phase and the aqueous phase in the emulsion, to form a polyurethane wall.

Further, a polyol or a polyamine may be added in the aqueous phase or in the hydrophobic solvent, thereby reacting with the polyvalent isocyanate and being utilized as one of the materials for the microcapsule wall. In the reaction, it is preferable to maintain a high reaction temperature or to add an appropriate polymerization catalyst in order to increase the reaction speed.

Specific examples of polyol and/or polyamine include propylene glycol, glycerin, trimethylol propane, triethanolamine, sorbitol, and hexamethylenediamine. When adding a polyol a polyurethane wall is formed.

Polyisocyanate, polyol, reaction catalyst, and polyamine forming a part of the wall material are described in detail in a reference (Polyurethane Handbook, Nikkan Kogyo Shimbun-sha, edited by Keiji Iwata (1987)).

The emulsifying operation can be executed with a known emulsifying apparatus such as a homogenizer, a manton-Goulin, an ultrasonic disperser, a dissolver or a KD mill. After the emulsification, the emulsion is heated to 30 to 70° C. in order to accelerate the capsule wall forming reaction. Also, during the reaction, it is necessary to add water, so as to lower the probability of mutual collision of the microcapsules or to execute sufficient agitation, in order to prevent mutual coagulation of the microcapsules.

During the reaction, another dispersion for preventing coagulation may be added. Generation of carbon oxide gas is observed with the progress of the polymerization reaction, and the end point of the capsule wall forming reaction can be judged approximately based on the end of the gas generation. Usually, the desired microcapsules containing the diazo compound can be obtained by a reaction of several hours.

(Configuration of Thermal Recording Material)

In the present embodiment, as in the foregoing embodiments, the thermal recording material may be provided with a plurality of laminated thermal recording layers. A multi-color thermal recording material can be obtained by changing the color hues of the photo-fixable thermal recording layers. The layer configuration in such a case is not particularly restricted. However, it is preferred that the multi-color thermal recording material has superposed thereon photo-fixable thermal recording layers (two layers) in which two diazonium compounds having different photosensitive wavelengths are respectively combined with couplers capable of forming different color hues by reaction under heating with the respective diazonium compounds, and a photo-fixable thermal recording layer in which an electron donating colorless dye and an electron accepting compound are combined. More specifically it has, on a support, a first photo-fixable thermal recording layer including an electron donating colorless dye and an electron accepting compound; a second photo-fixable thermal recording layer including a diazonium compound having a maximum absorption wavelength of 365±40 nm and a coupler capable of forming a color by reaction under heating with the diazonium compound; and a third photo-fixable thermal recording layer including a diazonium compound having a maximum absorption wavelength of 425±40 nm and a coupler capable of forming a color by reaction under heating with the diazonium compound. In this example, full-color image recording is possible by selecting three primary colors in the subtractive color mixing, namely yellow, magenta and cyan, for the color hues to be formed in these recording layers.

The recording method in this multi-color thermal recording material is executed as follows. First, the third photo-fixable thermal recording layer is heated to execute color formation by the diazonium compound and the coupler, which are in the layer. Then, after irradiation with light of a wavelength of 425±40 nm to decompose the unreacted diazonium compound contained in the third photo-fixable thermal recording layer, heat sufficient for color formation in the second photo-fixable thermal recording layer is added thereto, thereby causing color formation by the diazonium compound and the coupler, which are in the layer. At this time, the third photo-fixable thermal recording layer is also simultaneously strongly heated, but no further color formation takes place because the diazonium compound is already decomposed and the color forming ability is lost. Then, irradiation with light of a wavelength of 365±40 nm is executed to decompose the diazonium compound included in the second photo-fixable thermal recording layer, and heat sufficient for color formation in the first photo-fixable thermal recording layer is added, thereby forming a color therein. At the same time, the third and second photo-fixable thermal recording layers are also strongly heated, but no further color formation takes place because the diazonium compounds are already decomposed so that the color forming ability is lost.

In the invention, in order to improve light fastness, a known antioxidant, such as that described in the foregoing first embodiment, can be used.

It is also effective to use various additives already known for thermal recording materials or pressure-sensitive recording materials. Examples of such antioxidants include those described in JP-A Nos. 60-125470, 60-125471, 60-125472, 60-287485, 60-287486, 60-287487, 62-146680, 60-287488, 62-282885, 63-89877, 63-88380, 63-088381, 01-239282, 04-291685, 04-291684, 05-188687, 05-188686, 05-110490, 05-1108437, 05-170361, 63-203372, 63-224989, 63-267594, 63-182484, 60-107384, 60-107383, 61-160287, 61-185483, 61-211079, 63-251282 and 63-051174, JP-B Nos. 48-043294 and 48-033212.

A conventional binder resin can be used in the thermal recording layer, but is preferable to use polyvinyl alcohol. A water-soluble polymer such as gelatin or a polymer latex can also be employed.

<Light Transmittance Control Layer>

As with the aforementioned embodiments, a light transmittance control layer may be provided in the present embodiment in order to improve light fastness. For this purpose, the light transmittance control layer described in the foregoing first embodiment can be employed.

<Intermediate Layer>

When superposing multiple thermal recording layers, it is preferable to provide an intermediate layer between the thermal recording layers. For this purpose, the intermediate layer described in the foregoing first embodiment can be employed.

<Support>

Examples of materials for the support include polyethylene terephthalate (PET), polyethylene naphthalate (PEN), triacetyl cellulose (TAC), paper, paper laminated with a plastic resin, or synthetic paper. In order to obtain a transparent thermal recording material, it is necessary to use a transparent support, such as a synthetic polymer film. Examples of these include polyester films such as polyethylene terephthalate or polybutylene terephthalate, and cellulose triacetate films or polyolefin films such as polypropylene or polyethylene.

These support may be used individually or in a mutually adhered state. The synthetic polymer film preferably has a thickness of 25 to 300 μm, and more preferably of 100 to 250 μm.

The synthetic polymer film may be colored. Coloring methods for the polymer film include a method of blending a dye in a resin in advance and then forming a film, or a method of preparing a coating solution by dissolving a dye in an appropriate solvent and coating and drying the solution on a transparent colorless resinous film, by a known coating method such as gravure coating, roller coating or wire bar coating. Among these, there is preferred a support obtained by molding a polyester resin such as PET or PEN, in which a blue dye is blended, into a film shape and applying thereto heat-resistance treatment, drawing treatment and antistatic treatment.

The thermal recording layer, protective layer, light transmittance control layer, intermediate layer, etc. can be formed, on a support, by coating with a known coating method such as blade coating, air knife coating, gravure coating, roll coating, spray coating, dip coating or bar coating, and then dried.

Third Embodiment

A third embodiment of the present invention is characterized in that it includes, on a support, a thermal recording layer and a protective layer containing at least polyvinyl alcohol and two or more kinds of ultrafine inorganic particles with different average particle sizes, and further includes boric acid and a water-soluble zirconium compound.

Owing to the configuration using polyvinyl alcohol as the binder resin of the protective layer and including two or more kinds of ultrafine inorganic particles with different average particle sizes as fillers, the thermal recording material of the invention is capable of exhibiting high hardness while maintaining surface smoothness. Further, boric acid and a water-soluble zirconium compound used in combination provide high hardness while stably realizing the desired lubricating property on the surface of the thermal recording material.

The thermal recording material of the present embodiment exhibits high glossiness by maintaining high surface smoothness, also, the high surface hardness and stable lubricating property on the surface helps prevent dirtying of the thermal head. This serves to improve the durability of the head and to stably provide high-quality images.

In the thermal recording material of this embodiment, a thermal recording layer and a protective layer are provided in this order on a support, but another layer may also be provided suitably selected according to the purpose, such as an undercoat layer provided between the support and the thermal recording layer, an intermediate layer provided between the plurality of thermal recording layers, or a light transmittance control layer provided between the thermal recording layer and the protective layer.

Further, as in the second embodiment, the boric acid and the water-soluble zirconium compound may be included in a coating solution for the protective layer or in a coating solution for the thermal recording layer. Alternatively, they may be included in a coating solution for forming other layers. In case no particular inconvenience is encountered, they may be included in the coating solution for the protective layer or for the thermal recording layer. However, in case an undesirable reaction or interaction with another component is anticipated, it is possible to adopt a method of including them, for example, in the coating solution for the intermediate layer and transferring them to the desired layer by diffusion.

<Protective Layer>

The protective layer is provided in order to improve sticking characteristics of the thermal recording layer and to protect the thermal recording layer from solvent or external air. The protective layer in the invention at least includes polyvinyl alcohol resin as a binder, and two or more kinds of ultrafine inorganic particles, acting as fillers, having different average particle sizes, and may contain other various additives or fillers if necessary.

(Ultrafine Inorganic Particles)

In order to realize high hardness while maintaining surface smoothness, the protective layer of the invention includes two or more types of ultrafine inorganic particles having different average particle sizes, in addition to polyvinyl alcohol.

As explained in the foregoing, the term “ultrafine inorganic particles” refers to ultrafine inorganic particles with an average primary particle size of 0.5 μm or less, preferably 0.2 μm or less and more preferably of 0.15 μm or less. Any fine inorganic particles meeting these conditions may be used, without any particular restriction. However, these fine inorganic particles preferably have a maximum particle size in a dispersion (i.e., a threshold level at a larger side of the particle size distribution in a dispersion) of 0.5 μm or less, more preferably 0.4 μm or less and particularly preferably 0.35 μm or less. It is also preferred that the frequency of (coagulated) particles having an average particle size of 0.35 μm or greater in a dispersion is 5% or less, preferably 1% or less, and it is particularly preferable that the frequency of (coagulated) particles having an average particle size of 0.25 μm or greater in a dispersion is 5% or less. Such particle size can be measured by known methods, for example, using a submicron particle size analyzer Coulter N4 manufactured by Nikkaki Co.

The ultrafine inorganic particles employed in the present embodiment can be, for example, colloidal silica, barium sulfate, zinc oxide, magnesium oxide, lead oxide, zirconium oxide, or alumina, among which preferred are colloidal silica, barium sulfate and alumina. Particularly preferred are colloidal silica with an average particle size of 10 to 50 nm and barium sulfate with an average particle size of 0.05 to 0.20 μm, as these are less susceptible to the influence of a charge or a pH value and show high dispersion stability in a coating solution for the protective layer.

Specific examples of the ultrafine inorganic particles advantageously employable in the invention include barium sulfate (trade name: BARIFINE BF-21, BF-20, manufactured by Sakai Chemical Industries, Co.); colloidal silica (trade name: Snowtex O, manufactured by Nissan Chemical Ltd.); zirconium oxide (trade name: NZR-A, manufactured by Nissan Chemical Ltd.); zinc oxide (trade name: FINEX-75, Sakai Chemical Industries, Co.); titanium oxide (trade name: TTO-55, manufactured by Ishihara Sangyo Co.); and silica (trade name: AEROSIL 200, manufactured by Nippon Aerosil Co.).

The protective layer includes two or more kinds of the ultrafine inorganic particles of different average particle sizes. As at least one type of ultrafine inorganic particle, colloidal silica with an average particle size of 10 to 50 nm are preferably included. It is preferred to employ a combination of such colloidal silica and, as the other type, barium sulfate with an average particle size of 0.05 to 0.20 μm, and it is also preferred that the amount of colloidal silica is 8 to 24% by mass based on the barium sulfate.

Use of colloidal silica of such ultra-small particle size makes it possible to achieve high hardness while maintaining the smoothness of the surface. In case colloidal silica are used alone, the lubricant may diffuse and may not be retained on the surface of the thermal recording material, due to the high hydrophilicity thereof. However, combined use of barium sulfate makes stable retention of the necessary lubricating property on the surface of the thermal recording material possible. Thus, the thermal recording material of the present embodiment maintains surface smoothness thereby achieving high glossiness, and also maintains high hardness on the surface. Further, the thermal recording material of the invention, by stably retaining the lubricating property on the surface, is capable of preventing dirtying of the thermal head and improving the durability of the head. This makes it possible to stably obtain high-quality images.

The average particle size of the barium sulfate is preferably 0.05 to 0.20 μm, and more preferably 0.10 to 0.15 μm. The average particle size of the colloidal silica is preferably 10 to 50 nm, more preferably 10 to 30 nm, and most preferably 15 to 25 nm.

Moreover, the amount of the colloidal silica in the protective layer is preferably 8 to 24% by mass based on the barium sulfate, more preferably 8 to 16% by mass, and particularly preferably 8 to 10% by mass. If the average particle sizes of the barium sulfate and colloidal silica are within the above-mentioned ranges and the content proportion of colloidal silica to barium sulfate is within the above-mentioned range, the thermal recording material can maintain high glossiness and avoid conspicuous dirt of the head, thereby enabling trouble-free formation of a multitude of images.

In the invention, the preferred amount of barium sulfate and colloidal silica is 60% by mass or higher in the total ultrafine inorganic particles, more preferably 75% by mass or higher and particularly preferably 85% by mass or higher. The presence of barium sulfate and colloidal silica in an amount of 60% by mass or higher ensures full exhibition of the aforementioned effects.

In the present invention, for the method of adding the ultrafine inorganic particles, it is preferable to add a resin solution containing an aqueous dispersible resin such as carboxymethyl cellulose, gelatin or polyvinyl alcohol, or to use a method of addition where the colloidal dispersion of ultrafine inorganic particles prepared in various mills is added. This is in order to avoid mutual coagulation of the particles, and achieve uniform adsorption on the surface of the resin particles, thereby obtaining the desired effects and facilitating manufacture.

Also, the proportion of the binder and the ultrafine inorganic particles (binder/ultrafine inorganic particles) in a mass ratio is preferably 0.8/0.5 to 0.8/0.15, and more preferably 0.8/0.45 to 0.8/0.3.

(Polyvinyl Alcohol)

The present embodiment employs polyvinyl alcohol as a binder resin for the protective layer. This polyvinyl alcohol can be similar to that explained in the foregoing, hence the description, preferred embodiments and specific examples thereof are also similar. More specifically, a long-chain alkyl ether-modified polyvinyl alcohol is preferred for this polyvinyl alcohol. The long-chain alkyl ether-modified polyvinyl alcohol is preferably modified with an alkyl ether group with 8 to 20 carbon atoms. The long-chain alkyl ether-modified polyvinyl alcohol represented by the above general formulae (A-1) to (A-4) is preferred.

(Boric Acid)

In the thermal recording material of the present invention, boric acid, which is a hardening agent for the aforementioned polyvinyl alcohol, is included in order to increase the hardness and strength of the protective layer. The boric acid can be the same as that in the foregoing second embodiment, hence the description, preferred embodiments and specific examples thereof are also the same. The content of boric acid in the thermal recording material is preferably 10 to 30% by mass based on the total amount of polyvinyl alcohol employed in layers provided at a recording surface side of the thermal recording material (i.e., the side where the support's thermal recording layer is provided), more preferably 14 to 28% by mass and most preferably 18 to 24% by mass. Boric acid contained within these ranges based on the total amount of polyvinyl alcohol employed in the thermal recording material can sufficiently harden the protective layer and the like, and can inhibit diffusion of the lubricant when printing thereby preventing a decrease in the hydrophobicity of the surface of the protective layer. Conventionally, loss of hydrophobicity is that cause of deterioration in image quality or glossiness.

(Water-Soluble Zirconium Compound)

In the thermal recording material of the invention, a water-soluble zirconium compound is included, in addition to the above-described boric acid, for the purpose of reducing image unevennness due to loading change and decreasing printing torque, thereby reducing an unevenness in the density. The water-soluble zirconium compound can be the same as that in the second embodiment, hence the description, preferred embodiments and specific examples thereof are also the same. The content of the water-soluble zirconium compound in the thermal recording material is preferably 0.1 to 10% by mass based on the total amount of polyvinyl alcohol employed in layers at a recording surface side of the thermal recording material (i.e., the side where the support's thermal recording layer is provided), more preferably 0.3 to 8% by mass and most preferably 0.5 to 6% by mass. A content within these ranges can sufficiently reduce the printing torque in the protective layer, and can also prevent inducing loss in the glossiness caused by interaction between a dispersion of fine inorganic particles or an emulsion of lubricant fine particles present together.

In the protective layer of the invention, an inorganic layered compound such as mica may be added, or a pigment such as calcium oxide, zinc oxide, titanium oxide, aluminum hydroxide, caolin, a synthetic silicate salt, amorphous silica or an urea-formalin resin powder.

In the present embodiment, configurations besides the protective layer can be the same as those in the foregoing second embodiment, hence the description, preferred embodiments and specific examples thereof are also the same.

In the foregoing, explanations were given with regard to the thermal recording material of the invention, however, the first, second and third embodiments are merely examples of preferred embodiments of the invention and the present invention is not limited thereto. Further, each component in each embodiment may be applied in other embodiments.

### EXAMPLES

Below, the thermal recording material of the present invention will be further clarified with examples, but the invention is not limited by such examples. In the following description, “part” and “%” respectively mean “part by mass” and “% by mass”, unless otherwise specified.

### Example 1

<Preparation of Phthalated Gelatin Aqueous Solution>

32 parts of phthalated gelatin (trade name: MGP gelatin, manufactured by Nippi Collagen Co., Ltd.); 0.7 parts of 1,2-benzothiazolin-3-one (3.5% methanol solution, manufactured by Daito Chemical Industries, Ltd.); and 367.1 parts of ion-exchanged water were mixed and dissolved at 40° C. to obtain a phthalated gelatin aqueous solution.

<Preparation of Alkali-Treated Aqueous Gelatin Solution>

25.5 parts of alkali-treated low-ion content gelatin (trade name: #750 gelatin, manufactured by Nitta Gelatin Inc.); 0.6 parts of 1,2-benzothiazolin-3-one (3.5% methanol solution, manufactured by Daito Chemical Industries, Ltd.); 0.153 parts of calcium hydroxide and 143.6 parts of ion-exchanged water were mixed and dissolved at 50° C. to obtain an alkali-treated gelatin aqueous solution for preparing an emulsion.

(1) Preparation of Coating Solution for Yellow Thermal Recording Layer (a)

<Preparation of Microcapsule Solution (a) Including Diazonium Compound>

To 16.1 parts of ethyl acetate, 3.2 parts of a following diazonium compound (A) (maximum absorption wavelength 420 nm); 1.2 parts of a following diazonium compound (B) (maximum absorption wavelength 420 nm); 4.8 parts of monoisopropylbiphenyl; 4.8 parts of diphenyl phthalate; and 0.4 parts of diphenyl-(2,4,6-trimethylbenzoyl)phosphin oxide (trade name: Lucirin TPO, manufactured by BASF Japan Ltd.) were added and dissolved uniformly by heating at 40° C. To the thus-obtained mixture, 8.6 parts of a mixture of xylylene diisocyanate/trimethylolpropane adduct and xylylene diisocyanate/bisphenol-A adduct (trade name: Takenate D119N (50% solution in ethyl acetate), manufactured by Mitsui-Takeda Chemicals, Inc.) were added as a capsule wall material and were uniformly stirred to obtain a mixture (I).

Separately, 58.6 parts of the above-mentioned phthalated gelatin aqueous solution were added with 16.3 parts of ion-exchanged water and 0.34 parts of a 50% alkylglucoxide surfactant (trade name: Scraph AG-8 manufactured by Nippon Seika Co.) to obtain a mixture (II).

Mixture (I) was added to mixture (II), and was emulsified with a homogenizer (manufactured by NIPPON SEKI Co., Ltd.) at 40° C. The obtained emulsion was added and mixed uniformly with 20 parts of water, and was subjected to an encapsulation reaction for 3 hours while stirring at 40° C. and eliminating the ethyl acetate. Next, 4.1 parts of an ion exchange resin (trade name: Amberlite IRA68, manufactured by Organo Corp.) and 8.2 parts of an ion exchange resin (trade name: Amberlite IRC50, manufactured by Organo Corp.) were added and the mixture was further stirred for 1 hour. Thereafter, the ion exchange resin was eliminated by filtration, and the capsule solution was subjected to an adjustment of concentration so as to obtain a solid content of 20.0%, thereby obtaining a microcapsule solution (a) including the diazonium compound. The result of measurement with a particle size measurement apparatus (trade name: LA-700, manufactured by Horiba Co.) indicated that the obtained microcapsules had a median diameter of 0.36 μm.

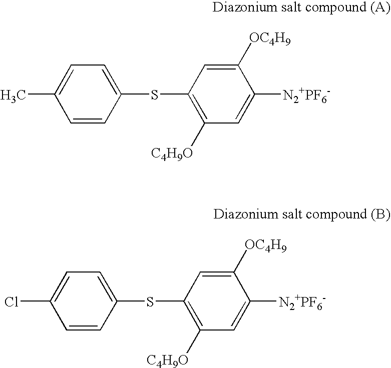

<Preparation of Coupler Compound Emulsion (a)>

7.7 parts of a following coupler compound (C); 9.9 parts of triphenylguanidine (manufactured by Hodogaya Chemical Co., Ltd.); 20.8 parts of 4,4′-(m-phenylenediisopropylidene)-diphenol (trade name: Bisphenol M, manufactured by Mitsui Chemicals Inc.); 3.3 parts of 3,3,3′,3′-tetramethyl-5,5′,6,6′-tetra(1-propyloxy)-1,1′-spirobisindane; 13.6 parts of 4-(2-ethylhexyloxy)benzenesulfonic acid amide (manufactured by Manac Incroporated.); 6.8 parts of 4-n-pentyloxybenzenesulfonic acid amide (manufactured by Manac Incorporated); and 4.2 parts of calcium dodecylbenzenesulfonate (trade name: Pionin A-41-C (70% methanol solution), manufactured by Takemoto Oil & Fat Co., Ltd) were dissolved in 33.0 parts of ethyl acetate to obtain a mixture (III).

Separately, 206.3 parts of the above-mentioned alkali-treated gelatin aqueous solution were mixed with 107.3 parts of ion-exchanged water to obtain a mixture (IV).

Mixture (III) was added to mixture (IV), and was emulsified with a homogenizer (manufactured by NIPPON SEKI Co., Ltd.) at 40° C. The obtained emulsion of the coupler compound was heated under reduced pressure to eliminate ethyl acetate, and was then subjected to an adjustment of concentration so as to obtain a solid content of 26.5%. The result of measurement with a particle size measuring apparatus (trade name LA-700, manufactured by Horiba Co.) indicated that the obtained emulsion of the coupler compound had a median diameter of 0.21 μm.

Then, 9 parts of SBR latex (trade name: SN-307 (48% liquid), manufactured by Sumika ABS Latex Co.), adjusted to a concentration of 26.5%, were added to 100 parts of the aforementioned emulsion of coupler compound and were uniformly stirred to obtain a coupler compound emulsion (a).

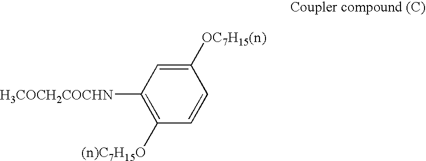

<Preparation of Coating Solution (a) for Yellow Thermal Recording Layer>

The microcapsule solution (a) containing the diazonium compound and the emulsion (a) of the coupler compound were mixed in such a manner that the mass ratio of the included coupler compound/diazonium compound became 2.2/1, thereby obtaining a coating solution (a) for the yellow thermal recording layer.

(2) Preparation of Coating Solution (b) for Magenta Thermal Recording Layer

<Preparation of Microcapsule Solution (b) Including Diazonium Compound>

2.8 parts of a following diazonium compound (D) (maximum absorption wavelength 365 nm); 2.8 parts of diphenyl phthalate; 3.9 parts of phenyl 2-benzoyloxybenzoate; 5.2 parts of a following ester compound (trade name: Light Ester TMP, manufactured by Kyoei Yushi Kagaku Co.); and 0.1 parts of calcium dodecylbenzenesulfonate (trade name: Pionin A-41-C, 70% methanol solution, manufactured by Takemoto Oil & Fat Co., Ltd) were added to 15.1 parts of ethyl acetate and uniformly dissolved under heating. To the thus-obtained mixture, 2.5 parts of a mixture of xylylene diisocyanate/trimethylolpropane adduct and xylylene diisocyanate/bisphenol-A adduct (trade name: Takenate D119N (50% ethyl acetate solution), manufactured by Mitsui Takeda Chemicals, Inc.) and 6.8 parts of a xylylene diisocyanate/trimethylolpropane adduct (trade name: Takenate D110N (75% ethyl acetate solution) manufactured by Mitsui Takeda Chemicals, Inc.) were added as capsule wall materials and uniformly stirred to obtain a mixture (V).

Separately, 55.3 parts of the above-mentioned phthalated gelatin aqueous solution were added to 21.0 parts of ion-exchanged water to obtain a mixture (VI).

Mixture (V) was added to mixture (VI), and was emulsified with a homogenizer (manufactured by NIPPON SEKI Co., Ltd.) at 40° C. The obtained emulsion was mixed uniformly with 24 parts of water, and then subjected to an encapsulation reaction for 3 hours while stirring at 40° C. and under in order to eliminate ethyl acetate. Next, 4.1 parts of an ion exchange resin (trade name: Amberlite IRA68, manufactured by Organo Corp.) and 8.2 parts of an ion exchange resin (trade name: Amberlite IRC50, manufactured by Organo Corp.) were added and the mixture was further stirred for 1 hour. Thereafter, the ion exchange resin was eliminated by filtration, and the capsule solution was subjected to an adjustment of concentration so as to obtain a solid content of 20.0%, thereby obtaining a microcapsule solution (b) containing the diazonium compound. The result of measurement with a particle size measuring apparatus (trade name: LA-700, manufactured by Horiba Co.) indicated that the obtained microcapsules had a median diameter of 0.43 μm.

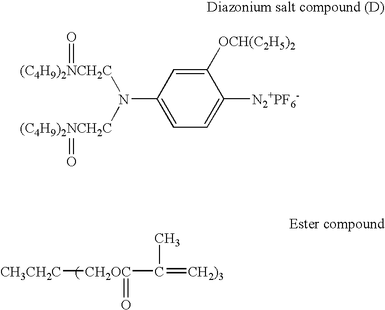

<Preparation of Coupler Compound Emulsion (b)>

10.0 parts of a following coupler compound (E); 14.0 parts of triphenylguanidine (manufactured by Hodogaya Chemical Co., Ltd.); 14.0 parts of 4,4′-(m-phenylenediisopropylidene)-diphenol (trade name: Bisphenol M, manufactured by Mitsui Petrochemicals Inc.); 14 parts of 1,1-(p-hydroxyphenyl)-2-ethylhexane; 3.5 parts of 3,3,3′,3′-tetramethyl-5,5′,6,6′-tetra(1-propyloxy)-1,1′-spirobisindane; 3.5 parts of a following compound (G); 1.7 parts of tricresyl phosphate; 0.8 parts of diethyl maleate; and 4.5 parts of calcium dodecylbenzenesulfonate (trade name: Pionin A-41-C (70% methanol solution) manufactured by Takemoto Oil & Fat Co., Ltd.) were dissolved in 36.9 parts of ethyl acetate to obtain a mixture (VII).

Separately, 206.3 parts of the alkali-treated gelatin aqueous solution were mixed with 107.3 parts of ion-exchanged water to obtain a mixture (VIII).

Mixture (VII) was added to mixture (VIII), and was emulsified with a homogenizer (manufactured by NIPPON SEKI Co., Ltd.) at 40° C. The obtained emulsion of the coupler compound was heated under reduced pressure to eliminate ethyl acetate, and was subjected to an adjustment of concentration so as to obtain a solid content of 24.5%, thereby obtaining a coupler compound emulsion (b). The result of measurement with a particle size measuring apparatus (trade name LA-700, manufactured by Horiba Co.) indicated that the obtained emulsion of the coupler compound had a median diameter of 0.22 μm.

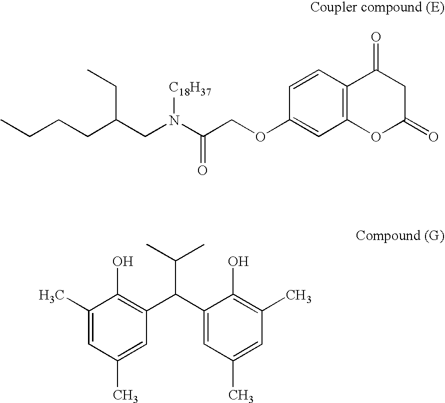

<Preparation of Coating Solution (b) for Magenta Thermal Recording Layer>

The microcapsule solution (b) containing the diazonium compound and the emulsion (b) of the coupler compound were mixed in such a manner that the mass ratio of the included coupler compound/diazonium compound became 3.5/1. Further, an aqueous solution (5%) of polystyrenesulfonic acid (partially neutralized with potassium hydroxide) was mixed in an amount of 0.2 parts with respect to 10 parts of the capsule solution, thereby obtaining a coating solution (b) for the magenta thermal recording layer.

(3) Preparation of Coating Solution (c) for Cyan Thermal Recording Layer

<Preparation of an Electron Donating Colorless Dye Precursor Containing Microcapsule Solution (c)>

In 18.1 parts of ethyl acetate, 7.6 parts of the following electron donating dye (H); 8.0 parts of a mixture of 1-methylpropylphenyl-phenylmethane and 1-(1-methylpropyl-phenyl)-2-phenylethane (trade name: Hysol SAS-310, manufactured by Japan Oil Co., Ltd.) and 8.0 parts of a following compound (I) (trade name: Irgaperm 2140, manufactured by Ciba-Geigy Inc.) were added as capusle wall materials and uniformly dissolved under heating. To the thus-obtained mixture, 7.2 parts of a xylylene diisocyanate/trimethylolpropane adduct (trade name: Takenate D110N (75% ethyl acetate solution) manufactured by Mitsui Takeda Chemicals, Inc.) and 5.3 parts of polymethylene polyphenyl polyisocyanate (trade name: Millionate MR-200, manufactured by Nippon Polyurethane Industries, Co., Ltd.) were added as capusle wall materials and uniformly stirred to obtain a mixture (IX).

Separately, 9.5 parts of ion-exchanged water; 0.17 parts of a 50% alkylglucoxide surfactant (trade name: Scraph AG-8, manufactured by Nippon Seika Co.); and 4.3 parts of sodium dodecylbenzenesulfonate (10% aqueous solution) were added to 28.8 parts of the above-mentioned phthalated gelatin aqueous solution to obtain a mixture (X).

Mixture (IX) was added to mixture (X), and was emulsified with a homogenizer (manufactured by NIPPON SEKI Co., Ltd.) at 40° C. The obtained emulsion was mixed uniformly with 50 parts of water and 0.12 parts of tetraethylene pentamine, and was subjected to an encapsulation reaction for 3 hours while stirring at 65° C. and and eliminating ethyl acetate, and the concentration was adjusted to obtain a solid concentration of 33% in the liquid, thereby obtaining a microcapsule solution. The result of measurement with a particle size measuring apparatus (trade name LA-700, manufactured by Horiba Co.) indicated that the obtained microcapsules had a median diameter of 1.00 μm.

Then 100 parts of the microcapsule solution were added to 2.5 parts of a 25% aqueous solution of sodium dodecylbenzenesulfonate (trade name: NEOPELEX F-25, manufactured by Kao Corp.), and 4.2 parts of a fluorescent whitening agent containing a 4,4′-bistriazinyl-aminostylbene-2,2′-disulfon derivative (trade name: Kaycoll BXNL, manufactured by Nippon Soda Co., Ltd.) and uniformly stirred to obtain a electron donating colorless dye precursor containing microcapsule solution (c).

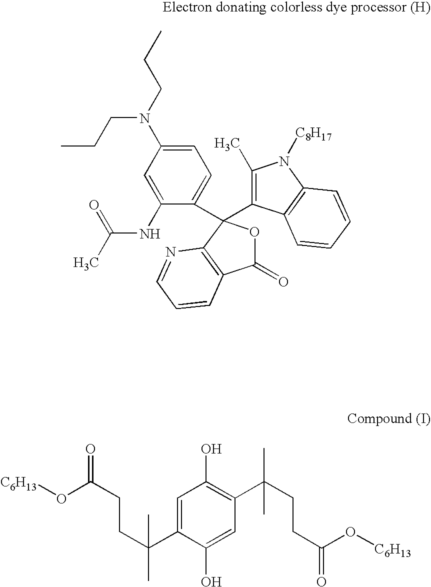

<Preparation of Electron Accepting Compound Dispersion(c)>

30.1 parts of ion-exchanged water; 15 parts of 4,4′-(p-phenylenediisopropylidene)diphenol (trade name: bisphenol P, manufactured by Mitsui Petrochemical Co.); and 3.8 parts of a 2% aqueous solution of sodium 2-ethylhexylsuccinate were added to 11.3 parts of the phthalated gelatin aqueous solution and dispersed overnight with a ball mill to obtain a dispersion. The dispersion had a solid content of 26.6%. 100 parts of the dispersion were added with 45.2 parts of the alkali-treated gelatin aqueous solution, then stirred for 30 minutes, and were next added with ion-exchanged water so as to give a solid content of the dispersion of 23.5% thereby obtaining an electron accepting compound dispersion (c).

<Preparation of Cyan Thermal Recording Layer Coating Solution (c)>

The electron donating colorless dye precursor containing microcapsule solution (c) and electron accepting compound dispersion (c) were mixed such that the mass ratio of the electron accepting compound/electron donating colorless dye precursor became 10/1, thereby obtaining a coating solution (c) for the cyan thermal recording layer.

(4)Preparation of Coating Solution for Intermediate Layer

100.0 parts of alkali-treated low ion content gelatin (trade name: #750 gelatin, manufactured by Nitta Gelatin Inc.); 2.857 parts of 1,2-benzothiazolin-3-one (3.5% methanol solution, manufactured by Daito Chemical Industries, Ltd.); 0.25 parts of calcium hydroxide and 521.643 parts of ion-exchanged water were mixed and dissolved at 50° C. to obtain an aqueous gelatin solution for preparing an intermediate layer.

10.0 parts of the gelatin aqueous solution for preparing the intermediate layer; 0.05 parts of sodium (4-nonylphenoxytrioxyethylene)butylsulfonate (2.0% aqueous solution, manufactured by Sankyo Chemicals Co., Ltd); 2.07 parts of boric acid (4.0% aqueous solution); 0.19 parts of an aqueous solution (5%) of polystyrenesulfonic acid (partially neutralized with potassium hydroxide); 3.42 parts of a 4% aqueous solution of the following compound (J) (manufactured by Wako Pure Chemical Ltd.); 1.13 parts of a 4% aqueous solution of the following compound (J′) (manufactured by Wako Pure Chemical Ltd.); and 0.67 parts of ion-exchanged water were mixed to obtain a coating solution for the intermediate layer.

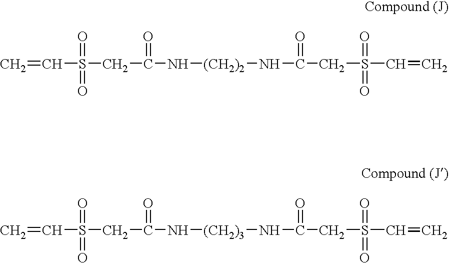

(5) Preparation of Coating Solution for Optical Transmittance Control

<Preparation of Microcapsule Solution of Ultraviolet Absorber Recursor>

14.5 parts of [2-allyl-6-(2H-benzotriazol-2-yl)-4-t-octylphenyl]benzenesulfonate as an ultraviolet absorber precursor; 2.5 parts of 2,2′-t-octylhydroquinone; 1.0 part of tricresyl phosphate; 5.7 parts of α-methylstyrene dimer (trade name: MSD-100, manufactured by Mitsui Chemicals Inc.); and 0.45 parts of calcium dodecylbenzenesulfonate (trade name: Pionin A-41-C, (70% methanol solution) manufactured by Takemoto Oil & Fat Co., Ltd.) were uniformly dissolved in 71 parts of ethyl acetate. To this mixture were added 54.7 parts of a xylylene diisocyanate/trimethylolpropane adduct (trade name: Takenate D110N (75% ethyl acetate solution), manufactured by Mitsui Takeda Chemicals, Inc.) as a capsule wall material, and the mixture was uniformly stirred to obtain a mixture of the ultraviolet absorber precursor.

Separately, 52 parts of itaconic acid-modified polyvinyl alcohol (trade name: KL-318, manufactured by Kuraray Co., Ltd.) were mixed with 8.9 parts of a 30% aqueous solution of phosphoric acid; and 532.6 parts of ion-exchanged water to obtain a polyvinyl alcohol (PVA) aqueous solution for a microcapsule solution of the ultraviolet absorber precursor.

The aforementioned mixture of the ultraviolet absorber precursor was added to 516.06 parts of the aqueous PVA solution for the ultraviolet absorber precursor microcapsule solution, and was emulsified with a homogenizer (manufactured by NIPPON SEKI Co., Ltd.) at 20° C. The obtained emulsion was added and mixed uniformly with 254.1 parts of ion-exchanged water, and was subjected to an encapsulation reaction for 3 hours while stirring at 40° C. Thereafter, 94.3 parts of an ion exchange resin (trade name: Amberlite MB-3, manufactured by Organo Corp.) were added and the mixture was further stirred for 1 hour. Thereafter, the ion exchange resin was eliminated by filtration, and the capsule solution was subjected to an adjustment of concentration so as to obtain a solid content of 13.5%. The result of measurement with a particle size measuring apparatus (trade name: LA-700, manufactured by Horiba Co.) indicated that the obtained microcapsules had a median diameter of 0.23±0.05 μm. 859.1 parts of the microcapsule solution were mixed with 2.416 parts of carboxy-modified styrene-butadiene latex (trade name: SN-307 (48% aqueous solution), manufactured by Sumitomo Norgatta) and 39.5 parts of ion-exchanged water to obtain a microcapsule solution of the ultraviolet absorber precursor.

<Preparation of Coating Solution for Optical Transmittance Control Layer>

1000 parts of the microcapsule solution of the ultraviolet absorber precursor; 7.75 parts of a 4% aqueous solution of sodium hydroxide; and 73.39 parts of sodium (4-nonylphenoxytrioxyethylene)butylsulfonate (2.0% aqueous solution, manufactured by Sankyo Chemicals Co., Ltd.) were mixed to obtain a coating solution for the light transmittance control layer.

(6) Preparation of Coating Blend Solution for Protective Layer

<Preparation of Polyvinyl Alcohol Solution for Protective Layer>

150 parts of a vinyl alcohol-alkylvinyl ether copolymer (trade name: EP-130, manufactured by Denka Corp.); 7.5 parts of a mixture of sodium alkylsulfonate and a polyoxyethylene alkyl ether phosphoric acid ester (trade name: Neoscore CM-57 (54% aqueous solution), manufactured by Toho Chemical Industries, Co., Ltd.); 7.05 parts of an ethylene oxide adduct of acetyelenediol (trade name: Dinol 604, manufactured by Air Products Japan, Inc.); 7.05 parts of a silicone surfactant (trade name: SYLGARD 309, manufactured by Toray-Dow Corning Silicone Ltd.); and 3592 parts of ion-exchanged water were mixed and uniformly dissolved for 1 hour at 90° C. to obtain a polyvinyl alcohol solution for the protective layer.

<Preparation of Pigment Dispersion for Protective Layer>

8 parts of barium sulfate (trade name: BF-21F, barium sulfate content 93% or higher, manufactured by Sakai Chemical Industries, Co.) were mixed with 0.2 parts of an anionic special polycarboxylic acid polymer surfactant (trade name: Poise 532A (40% aqueous solution), manufactured by Kao Corp.) and 11.8 parts of ion-exchanged water and were dispersed in a Dyno mill to prepare a pigment dispersion for the protective layer. The result of measurement with a particle size measuring apparatus (trade name: LA-910, manufactured by Horiba Co.) indicated that the dispersion had a median diameter of 0.15 μm or less.

<Preparation of Dispersion of Matting Agent for Protective Layer>

220 parts of wheat starch (trade name: Wheat starch S, manufactured by Shinshin Shokuryo Kogyo Co.) were mixed with 3.81 parts of an aqueous dispersion of 1-2-benzisothiazolin-3-one (trade name: PROXEL B. D, manufactured by I.C.I. Ltd.) and 1976.19 parts of ion-exchanged water and were dispersed uniformly to obtain a dispersion of the matting agent for the protective layer.

<Preparation of Coating Blend Solution for Protective Layer>

1000 parts of the polyvinyl alcohol solution for the protective layer were uniformly mixed with 50 parts of sodium (4-nonylphenoxytrioxyethylene)butylsulfonate (2.0% aqueous solution, manufactured by Sankyo Chemicals, Co.); 50 parts of the pigment dispersion for the protective layer; 16.65 parts of the dispersion of the matting agent for the protective layer; 48.7 parts of a zinc stearate dispersion (trade name: Himicron LIII, 21% aqueous solution, manufactured by Chukyo Yushi Co.); 20 parts of a carbonate-based zirconium compound (trade name: zirconium potassium carbonate (10% aqueous solution), manufactured by Newtex Co.); and 280 parts of ion-exchanged water to obtain a coating blend solution for the protective layer.

(7) Preparation of Support

<Preparation of Coating Solution for Undercoating Layer>

40 parts of enzyme-decomposed gelatin (average molecular weight: 10,000, viscosity by PAGI method: 1.5 mPa.s (15 mP), jelly strength by PAGI method: 20 g) were mixed with 60 parts of ion-exchanged water and dissolved and stirred at 40° C. to obtain an aqueous gelatin solution for the undercoat layer.

Separately, 8 parts of water-swelling synthetic mica (aspect ratio: 1000, trade name: Somashif ME100, manufactured by Cope Chemical Inc.) were mixed with 82 parts of water and subjected to wet dispersion in a visco mill to obtain a mica dispersion with an average particle size of 2.0 μm. The mica dispersion had water added thereto so as to obtain a mica concentration of 5% and was uniformly mixed to obtain the desired mica dispersion.

To 100 parts of the aforementioned 40% aqueous gelatin solution for a undercoating layer at 40° C., 120 parts of water and 556 parts of methanol were added and sufficiently mixed by stirring, then 208 parts of the 5% mica dispersion were added and sufficiently mixed by stirring, and 9.8 parts of a 1.66% polyethylene oxide surfactant were added thereto. Then, at a liquid temperature maintained at 35° to 40° C., 7.3 parts of a gelatin hardening agent of an epoxy compound were added to obtain a coating solution (5.7%) for the undercoat layer.

<Preparation of Support with Undercoat Layer>

Wood pulp, composed of 50 parts of LBPS and 50 parts of LBPK, was beaten with a disk refiner to a Canadian freeness of 300 ml, then added thereto were 0.5 parts of epoxylated behenate amide; 1.0 part of anionic polyacrylamide; 1.5 parts of aluminum sulfate; 0.1 parts of polyamidepolyamine epichlorohydrin; and 0.5 parts of cationic polyacrylamide, each in absolute dry mass ratios to the pulp, and was subjected to paper making with a long-screen paper mill to form a base paper with a basis weight of 114 g/m², of which thickness was adjusted to 100 μm by a calendaring process.

After a corona discharge treatment of both surfaces of the base paper, polyethylene was coated with a melt extruder so as to obtain a resin thickness of 36 μm thereby forming a resin layer of a matted surface (this surface referred to as a “rear surface”). Next, on the surface opposite to the surface bearing the above-mentioned resin layer, polyethylene containing titanium dioxide of anatase type in 10% and a small amount of Prussian blue was coated with a melt extruder so as to obtain a resin thickness of 50 μm thereby forming a resin layer with a glossy surface (this surface referred to as a “front surface”). On the polyethylene resin coated rear surface, corona discharge treatment was performed, after which aluminum oxide (trade name: Alumina Sol 100, manufactured by Nissan Chemical Industries, Ltd.)/silicon dioxide (trade name: Snowtex-O, manufactured by Nissan Chemical Industries, Ltd.)=1/2 (mass ratio) as an antistatic agent were dispersed in water and after drying, coated with a dry mass amount of 0.2 g/m². Then, on the polyethylene resin coated front surface, after a corona discharge treatment, the above-described coating solution for the undercoat layer was coated with a coating amount of mica of 0.26 g/m² to obtain a support with an undercoat layer.

(8)Preparation of Multi-Color Thermal Recording Material

On the support with the undercoat layer, seven layers were simultaneously and successively coated in order from the bottom, in the following order: the cyan thermal recording layer coating solution (c); the intermediate layer (intermediate layer A) coating solution; the magenta thermal recording layer coating solution (b); the intermediate layer (intermediate layer B) coating solution; the yellow thermal recording layer coating solution (a); the coating solution for the light transmittance control layer; and the coating blend solution for the protective layer. These were dried under conditions of 30° C., 30% RH and then 40° C., 30% RH to obtain a multi-color thermal recording material of an example 1.

In this operation, the yellow thermal recording layer coating solution (a) was coated in such a manner that the diazo compound (A) had a solid coating amount of 0.078 g/m²; the magenta thermal recording layer coating solution (b) was coated in such a manner that the diazo compound (D) had a solid coating amount of 0.206 g/m²; and the cyan thermal recording layer coating solution (c) was coated in such a manner that the electron donating colorless dye precursor (H) had a solid coating amount of 0.355 g/m².

Also, the intermediate layer B coating solution was coated so as to have a solid coating amount of 2.39 g/m²; the intermediate layer A coating solution was coated so as to have a solid coating amount of 3.34 g/m²; the coating solution for the light transmittance control layer was coated so as to have a solid coating amount of 2.35 g/m²; and the coating solution for the protective layer was coated so as to have a solid coating amount of 1.70 g/m².

### Example 2

A multi-color thermal recording material of example 2 was prepared in the same manner as in example 1, except that the 20 parts of the carbonate-based zirconium compound (trade name: zirconium potassium carbonate (10% aqueous solution), manufactured by Newtex Co.), added in the coating blend solution for the protective layer, were replaced with 13.3 parts of a nitrate-based zirconium compound (trade name: Zircosol HA (15% aqueous solution) manufactured by Newtex Co.).

### Example 3

The multi-color thermal recording material of example 3 was prepared in the same manner as in example 1, except that the 20 parts of the carbonate-based zirconium compound (trade name: zirconium potassium carbonate (10% aqueous solution), manufactured by Newtex Co.), added in the coating blend solution for the protective layer, were replaced with 12 parts of a sulfate-based zirconium compound (trade name: zirconium sulfate (18% aqueous solution), manufactured by Newtex Co.).

### Example 4

The multi-color thermal recording material of example 4 was prepared in the same manner as in example 1, except that the 20 parts of the carbonate-based zirconium compound (trade name: zirconium potassium carbonate (10% aqueous solution), manufactured by Newtex Co.), added in the coating blend solution for the protective layer, were replaced with 24 parts of titanium lactate (trade name: Orgatix TC-310 (8.2% aqueous solution), manufactured by Matsumoto Seiyaku Kogyo Co.).

### Comparative Example 1

The multi-color thermal recording material of comparative example 1 was prepared in the same manner as in the example 1, except that 2.7 parts of boric acid (4.0% aqueous solution) were added to the intermediate layer coating solution and the carbonate-based zirconium compound (trade name: zirconium potassium carbonate (10% aqueous solution), manufactured by Newtex Co.) was not added in the coating blend solution for the protective layer.

### Comparative Example 2

The multi-color thermal recording material of comparative example 2 was prepared in the same manner as in comparative example 1, except that the amount of boric acid added to the coating solution for the intermediate layer was changed from 2.7 parts to 7.2 parts.

### Comparative Example 3

The multi-color thermal recording material of comparative example 3 was prepared in the same manner as in example 1, except that the carbonate-based zirconium compound (trade name: zirconium potassium carbonate (10% aqueous solution), manufactured by Newtex Co.) was not added in the coating blend solution for the protective layer.

<<Evaluation>>

The multi-color thermal recording materials of the aforementioned examples and comparative examples were subjected to the following evaluations. The obtained results are shown in Table 4.

<Evaluation of Water-Resistance>

A solid black image was printed on each thermal recording material with a digital printer (trade name: NC370D, manufactured by Fuji Photo Film Co., Ltd.). Water was dropped on the printed surface of the black solid image of each thermal recording material, and immediately wiped off.

After the portion where water was dropped completely dried, evaluation was made by visual observation according to the following criteria:

Criteria

A: almost no trace of water in the water-dropped portion or surrounding area thereof;

B: slight trace of water in the water-dropped portion but no trace in the surrounding area;

C: traces observable in the water-dropped portion or in the surrounding area.

<Evaluation of Image Quality>

An A6-sized thermal head (model: KTJ-13 SAN24-FFA, manufactured by Kyocera Corp.) was mounted on a jig printer equipped with a platen of a diameter of 12%, a hardness of 400 and a pressure of 6 kg/cm (trade name: GX-3, manufactured by Matires Co.). When the temperature in the above-described printer was lowered to room temperature, solid images with print energies of 60 to 100 mJ/mm², changed at a step of 10 mJ/mm², were printed in the thermal head main scanning direction under conditions of a line cycle of 5.29 ms, electric power of 0.32 W, and a transport speed of 16 mm/s.

The printed sample was evaluated by visual observation according to the following:

Criteria

A: no thermalhead trace in a high energy print portion (80-100 mJ/mm²) and in a low energy print portion (60-80 mJ/mm²);

B: a thermalhead trace of a spindle shape with a width of several hundred micrometers and a length of several millimeters, slightly different in gloss from the surrounding area, was generated in a high energy print portion;

C: an area of an amorphous shape slightly different in gloss from the surrounding area was generated in a high energy print portion;

D: a thermalhead trace shaped like B or C was generated in the entire print energy range of 60 to 100 mJ/mm².

<Evaluation of Glossiness>

A black solid image was printed on each thermal recording material with a digital printer (trade name: NC370D, manufactured by Fuji Photo Film Co., Ltd.). On the print surface of the black solid image of each thermal recording material, a mirror surface glossiness was measured by a digital variable angle glossiness meter (trade name: UGV-5D, manufactured by SUGA TEST INSTRUMENTS CO., LTD.) with an incident angle of 200.

<Evaluation of Thermal Sensitivity>

An A6-sized thermal head (model: KTJ-13 SAN24-FFA, manufactured by Kyocera Corp.) was used for printing, with a printing power to the thermal head and a pulse width determined such that the recording energy per unit area was 18, 21 and 25 mJ/mm². Next, the material was irradiated with light of 400±20 nm to decompose unreacted diazonium compounds (A) and (B) contained in the yellow thermal recording layer, and then irradiated with light of 360±20 nm to decompose unreacted diazonium compound (D) contained in the magenta thermal recording layer, thereby fixing the image and causing a color formation only in the yellow thermal recording layer.

The optical density of the color developed portion was measured with a Macbeth densitometer (trade name: RD918, manufactured by Macbeth Inc.).

TABLE 4

| | Added material | | | | | | | | |
|---|---|---|---|---|---|---|---|---|---|
| | | | amount | | | | Thermal sensitivity | | |
| | | | of | water- | | | (color density at | | |
| | | | addition | proof- | image | glossi- | each print energy) | | |
| | type | position | (to PVA) | ness | quality | ness | 18 mJ/mm² | 21 mJ/mm² | 25 mJ/mm² |
| Example 1 | carbonate-based | protective | 5% | A | A | 46 | 0.34 | 0.66 | 1.21 |
| | zirconium compound | layer | | | | | | | |
| Example 2 | nitrate-based | protective | 5% | A | B | 42 | 0.36 | 0.68 | 1.23 |
| | zirconium compound | layer | | | | | | | |
| Example 3 | sulfate-based | protective | 5% | A | A | 48 | 0.42 | 0.72 | 1.27 |
| | zirconium compound | layer | | | | | | | |
| Example 4 | titanium lactate | protective | 5% | B | B | 40 | 0.33 | 0.65 | 1.19 |
| | | layer | | | | | | | |
| Comp. Ex. 1 | boric acid | interme- | 15% | C | C | 42 | 0.32 | 0.63 | 1.17 |
| | | diate | | | | | | | |
| | | layer | | | | | | | |
| Comp. Ex. 2 | boric acid | interme- | 40% | B | B | 30 | 0.28 | 0.59 | 1.14 |
| | | diate | | | | | | | |
| | | layer | | | | | | | |
| Comp. Ex. 3 | — | — | — | D | D | 24 | 0.32 | 0.64 | 1.17 |

The results in Table 4 indicate that examples 1 to 4, in comparison to the comparative examples, exhibit superior water-resistance, image quality and glossiness. In particular, example 1 and example 3, which employs the zirconium sulfate, are superior not only to the comparative examples but also to the other examples in terms of image quality and glossiness. Also, in comparison with the comparative examples, examples 1 to 3 show improved thermal sensitivity, and this tendency is particularly conspicuous in example 3.

### Example 5

<Preparation of Phthalated Gelatin Aqueous Solution>

32 parts of phthalated gelatin (trade name: MGP gelatin, manufactured by Nippi Collagen Co., Ltd.); 0.9143 parts of 1,2-benzothiazolin-3-one (3.5% methanol solution, manufactured by Daito Chemical Industries, Ltd.); and 367.1 parts of ion-exchanged water were mixed and dissolved at 40° C. to obtain a phthalated gelatin aqueous solution.

<Preparation of Alkali-Treated Aqueous Gelatin Solution>

25.5 parts of alkali-treated low-ion content gelatin (trade name: #750 gelatin, manufactured by Nitta Gelatin Inc.); 0.7286 parts of 1,2-benzothiazolin-3-one (3.5% methanol solution, manufactured by Daito Chemical Industries, Ltd.); 0.153 parts of calcium hydroxide; and 143.6 parts of ion-exchanged water were mixed and dissolved at 50° C. to obtain an alkali-treated gelatin aqueous solution for preparing an emulsion.

(1) Preparation of Coating Solution for Yellow Thermal Recording Layer

<Preparation of Diazonium Compound Containing Microcapsule Solution (a-1)>

In 16.6 parts of ethyl acetate, 2.0 parts of a following diazonium compound (A) (maximum absorption wavelength 420 nm); 2.2 parts of a following diazonium compound (B) (maximum absorption wavelength 420 nm); 4.8 parts of monoisopropylbiphenyl; 4.8 parts of diphenyl phthalate; and 0.4 parts of diphenyl-(2,4,6-trimethylbenzoyl)phosphin oxide (trade name: Lucirin TPO, manufactured by BASF Japan Co.) were added and heated to 40° C. and dissolved uniformly. To the thus-obtained mixture, 8.6 parts of a mixture of xylylene diisocyanate/trimethylolpropane adduct and xylylene diisocyanate/bisphenol-A adduct (trade name: Takenate D119N (50% solution in ethyl acetate), manufactured by Mitsui-Takeda Chemicals, Inc.) were added as a capsule wall material and were uniformly stirred to obtain a mixture (1-1).

Separately, 58.6 parts of the above-mentioned phthalated gelatin aqueous solution had added thereto 16.3 parts of ion-exchanged water; and 0.40 parts of a 50% alkylglucoxide surfactant (trade name: Scraph AG-8 manufactured by Nippon Seika Co.) to obtain a mixture (II-1).

Mixture (I-1) was added to mixture (II-1), and was emulsified with a homogenizer (manufactured by NIPPON SEKI Co., Ltd.) at 40° C. 20 parts of water were added to the obtained emulsion and mixed uniformly, and then mixture was subjected to an encapsulation reaction for 3 hours while stirring at 40° C. to eliminate ethyl acetate. Thereafter, 4.1 parts of an ion exchange resin (trade name: Amberlite IRA68, manufactured by Organo Corp.) and 8.2 parts of an ion exchange resin (trade name: Amberlite IRC50, manufactured by Organo Corp.) were added and the mixture was further stirred for 1 hour. Thereafter, the ion exchange resin was eliminated by filtration, and the capsule solution was subjected to an adjustment of concentration so as to obtain a solid content of 20.0%, thereby obtaining a diazonium compound containing microcapsule solution (a-1). The result of measurement with a particle size measuring apparatus (trade name: LA-700, manufactured by Horiba Co.) indicated that the obtained microcapsules had a median diameter of 0.36 μm.

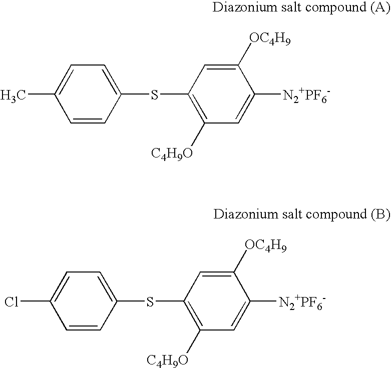

<Preparation of Coupler Compound Emulsion (a-1)>

In 33.0 parts of ethyl acetate, 9.9 parts of the following coupler compound (C); 9.9 parts of triphenylguanidine (manufactured by Hodogaya Chemical Co., Ltd.); 20.8 parts of 4,4′-(m-phenylenediisopropylidene)-diphenol (trade name: Bisphenol M, manufactured by Mitsui Petrochemicals Inc.); 3.3 parts of 3,3,3′,3′-tetramethyl-5,5′,6,6′-tetra(1-propyloxy)-1,1′-spirobisindane; 13.6 parts of 4-(2-ethylhexyloxy)benzenesulfonic acid amide (manufactured by Manac Inc.); 6.8 parts of 4-n-pentyloxybenzenesulfonic acid amide (manufactured by Manac Inc.); and 4.2 parts of calcium dodecylbenzenesulfonate (trade name: Pionin A-41-C (70% methanol solution), manufactured by Takemoto Oil & Fat Co., Ltd) were dissolved to obtain a mixture (III-1).

Separately, 206.3 parts of the above-mentioned alkali-treated gelatin aqueous solution were mixed with 107.3 parts of ion-exchanged water to obtain a mixture (IV-1).

Mixture (III-1) was added to mixture (IV-1), and was emulsified with a homogenizer (manufactured by NIPPON SEKI Co., Ltd.) at 40° C. The obtained emulsion of the coupler compound was heated under reduced pressure to eliminate ethyl acetate, and subjected to an adjustment of concentration so as to obtain a solid content of 26.5%. The result of measurement with a particle size measuring apparatus (trade name LA-700, manufactured by Horiba Co.) indicated that the obtained emulsion of the coupler compound had a median diameter of 0.21 μm.

Further, 9 parts of SBR latex (trade name: SN-307 (48% liquid), manufactured by Sumika ABS Latex Co.), adjusted to a concentration of 26.5%, were added to 100 parts of the aforementioned emulsion of coupler compound and were uniformly stirred to obtain a coupler compound emulsion (a-1).

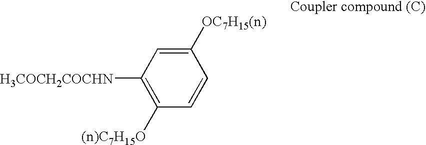

<Preparation of Coating Solution (a-1) for Yellow Thermal Recording Layer>

The diazonium compound containing microcapsule solution (a-1) and the emulsion (a-1) of the coupler compound were mixed in such a manner that the mass ratio of the included coupler compound/diazonium compound became 2.2/1, thereby obtaining a coating solution (a-1) for the yellow thermal recording layer.

(2) Preparation of Coating Solution for Magenta Recording Layer Magenta Thermal Recording Layer Solution

<Preparation of Diazonium Compound Containing Microcapsule Solution (b-1)>

To 15.1 parts of ethyl acetate, 2.8 parts of a following diazonium compound (D) (maximum absorption wavelength 365 nm); 3.8 parts of diphenyl phthalate; 3.9 parts of phenyl 2-benzoyloxybenzoate; 4.2 parts of a following ester compound (trade name: Light Ester TMP, manufactured by Kyoei Yushi Kagaku Co.); and 0.2 parts of calcium dodecylbenzenesulfonate (trade name: Pionin A-41-C, 70% methanol solution, manufactured by Takemoto Oil & Fat Co., Ltd.) were added, heated, and uniformly dissolved by heating. To this mixture, 3.0 parts of a mixture of xylylene diisocyanate/trimethylolpropane adduct and xylylene diisocyanate/bisphenol-A adduct (trade name: Takenate D119N (50% ethyl acetate solution), manufactured by Mitsui Takeda Chemicals, Inc.) and 6.8 parts of a xylylene diisocyanate/trimethylolpropane adduct (trade name: Takenate D110N (75% ethyl acetate solution) manufactured by Mitsui Takeda Chemicals, Inc.) were added as capsule wall materials and uniformly stirred to obtain a mixture (V-1).

Separately, 21.0 parts of ion-exchanged water were added to 55.3 parts of the above-mentioned phthalated gelatin aqueous solution to obtain a mixture (VI-1).

Mixture (V-1) was added to mixture (VI-1), and was emulsified with a homogenizer (manufactured by NIPPON SEKI Co., Ltd.) at 40° C. The obtained emulsion was mixed uniformly with 24 parts of water, and subjected to an encapsulation reaction for 3 hours while stirring at 40° C. to eliminate the ethyl acetate. Thereafter, 4.1 parts of an ion exchange resin (trade name: Amberlite IRA68, manufactured by Organo Corp.) and 8.2 parts of an ion exchange resin (trade name: Amberlite IRC50, manufactured by Organo Corp.) were added and the mixture was further stirred for 1 hour. Thereafter, the ion exchange resin was eliminated by filtration, and the capsule solution was subjected to an adjustment of concentration so as to obtain a solid content of 20.0%, thereby obtaining a diazonium compound containing microcapsule solution (b-1). The result of measurement with a particle size measuring apparatus (trade name: LA-700, manufactured by Horiba Co.) indicated that the obtained microcapsules had a median diameter of 0.43 μm.

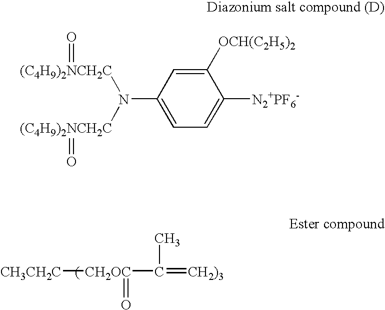

<Preparation of Coupler Compound Emulsion (b-1)>

11.9 parts of a following coupler compound (E); 14.0 parts of triphenylguanidine (manufactured by Hodogaya Chemical Co., Ltd.); 14.0 parts of 4,4′-(m-phenylenediisopropylidene)-diphenol (trade name: Bisphenol M, manufactured by Mitsui Petrochemicals Inc.); 14.0 parts of 1,1-(p-hydroxyphenyl)-2-ethylhexane; 3.5 parts of 3,3,3′,3′-tetramethyl-5,5′,6,6′-tetra(1-propyloxy)-1,1′-spirobisindane; 3.5 parts of a following compound (G); 1.7 parts of tricresyl phosphate; 0.8 parts of diethyl maleate; and 4.5 parts of calcium dodecylbenzenesulfonate (trade name: Pionin A-41-C (70% methanol solution), manufactured by Takemoto Oil & Fat Co., Ltd.) were dissolved in 36.9 parts of ethyl acetate to obtain a mixture (VII-1).

Separately, 206.3 parts of the above-mentioned alkali-treated gelatin aqueous solution were mixed with 107.3 parts of ion-exchanged water to obtain a mixture (VIII-1).

The mixture (VII-1) was added to the mixture (VIII-1), and was emulsified with a homogenizer (manufactured by NIPPON SEKI Co., Ltd.) at 40° C. The obtained emulsion of the coupler compound was heated under reduced pressure to eliminate ethyl acetate, and was subjected to an adjustment of concentration so as to obtain a solid content of 24.5%, thereby obtaining a coupler compound emulsion (b-1). The result of measurement with a particle size measuring apparatus (trade name LA-700, manufactured by Horiba Co.) obtained emulsion of the coupler compound had a median diameter of 0.22 μm.

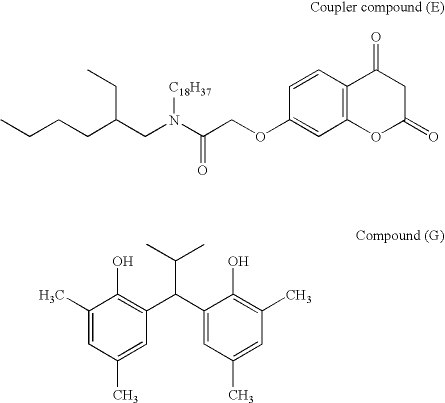

<Preparation of Coating Solution (b-1) for Magenta Thermal Recording Layer>

The diazonium compound containing microcapsule solution (b-1) and the emulsion (b-1) of the coupler compound were mixed in such a manner that the mass ratio of the included coupler compound/diazonium compound became 3.5/1. Further, an aqueous solution (5%) of polystyrenesulfonic acid (partially neutralized with potassium hydroxide) was mixed in an amount of 0.2 parts to 10 parts of the capsule solution, thereby obtaining a coating solution (b-1) for the thermal recording layer.

(3) Preparation of Coating Solution for Cyan Thermal Recording Layer

<Preparation of Electron Donating Dye Precursor Containing Microcapsule Solution (c-1)>

To 18.1 parts of ethyl acetate, 7.6 parts of a following electron donating dye (H); 8.0 parts of a mixture of 1-methylpropylphenyl-phenylmethane and 1-(1-methylpropyl-phenyl)-2-phenylethane (trade name: Hysol SAS-310, manufactured by Japan Oil Co, Ltd.); and 8.0 parts of a following compound (I) (trade name: Irgaperm 2140, manufactured by Ciba-Geigy Inc.) were added, heated, and uniformly dissolved by heating. To this mixture, 7.2 parts of a xylylene diisocyanate/trimethylolpropane adduct (trade name: Takenate D110N (75% ethyl acetate solution) manufactured by Mitsui Takeda Chemicals, Inc.) and 5.3 parts of polymethylene polyphenyl polyisocyanate (trade name: Millionate MR-200, manufactured by Nippon Polyurethane Industries, Co., Ltd.) were added as capsule wall materials and uniformly stirred to obtain a mixture (IX-1).

Separately, to 28.8 parts of the above-mentioned phthalated gelatin aqueous solution, 9.5 parts of ion-exchanged water; 0.17 parts of a 50% alkylglucoxide surfactant (trade name: Scraph AG-8, manufactured by Nippon Seika Co.); and 4.3 parts of sodium dodecylbenzenesulfonate (10% aqueous solution) were added and mixed to obtain a mixture (X-1).

Mixture (IX-1) was added to mixture (X-1), and was emulsified with a homogenizer (manufactured by NIPPON SEKI Co., Ltd.) at 40° C. The obtained emulsion was mixed uniformly with 50 parts of water and 0.12 parts of tetraethylene pentamine, and subjected to an encapsulation reaction for 3 hours while stirring at 65° C. and eliminating ethyl acetate, and the concentration was adjusted to obtain a solid concentration of 33% in the liquid, thereby obtaining a microcapsule solution. The result of measurement with a particle size measuring apparatus (trade name LA-700, manufactured by Horiba Co.) indicated that the obtained microcapsules had a median diameter of 1.00 μm.

Further, to 100 parts of the microcapsule solution, 3.7 parts of a 25% aqueous solution of sodium dodecylbenzenesulfonate (trade name: NEOPELEX F-25, manufactured by Kao Corp.), and 5.0 parts of a fluorescent whitening agent containing a 4,4′-bistriazinyl-aminostylbene-2,2′-disulfon derivative (trade name: Kaycoll BXNL, manufactured by Nippon Soda Co., Ltd.) were added and uniformly stirred to obtain an electron donating dye precursor containing microcapsule dispersion (c-1).

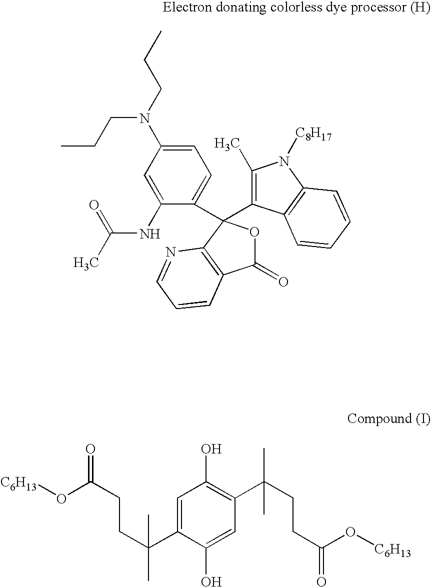

<Preparation of Electron Accepting Compound Dispersion (c-1)>

To 11.3 parts of the phthalated gelatin aqueous solution, 30.1 parts of ion-exchanged water, 15 parts of 4,4′-(p-phenylenediisopropylidene)diphenol (trade name: bisphenol P, manufactured by Mitsui Petrochemical Co.) and 3.8 parts of a 2% aqueous solution of sodium 2-ethylhexylsuccinate were added and dispersed overnight with a ball mill to obtain a dispersion. The dispersion had a solid content of 26.6%.

45.2 parts of the alkali-treated gelatin aqueous solution were added to 100 parts of the dispersion, then stirred for 30 minutes. Next, ion-exchanged water was added so as to obtain a solid content of 23.5% thereby obtaining an electron accepting compound dispersion (c-1).

<Preparation of Coating Solution (c-1) of Cyan Thermal Recording Layer>

The electron donating dye precursor containing microcapsule solution (c-1) and the electron accepting compound dispersion (c-1) were mixed in such a manner that the mass ratio of the electron accepting compound/electron donating dye precursor became 10/1, thereby obtaining a coating solution (c-1).

(4) Preparation of Coating Solution for Intermediate Layer

100.0 parts of alkali-treated low ion content gelatin (trade name: #750 gelatin, manufactured by Nitta Gelatin Inc.); 2.857 parts of 1,2-benzothiazolin-3-one (3.5% methanol solution, manufactured by Daito Chemical Industries, Ltd.); 0.4 parts of calcium hydroxide; and 521.643 parts of ion-exchanged water were mixed and dissolved at 50° C. to obtain an aqueous gelatin solution for preparing an intermediate layer.

10.0 parts of the gelatin aqueous solution for preparing the intermediate layer; 0.05 parts of sodium (4-nonylphenoxytrioxyethylene)butylsulfonate (2.0% aqueous solution, manufactured by Sankyo Chemicals Co., Ltd); 0.19 parts of a 5% aqueous solution of polystyrenesulfonic acid (partially neutralized with potassium hydroxide); 3.6 parts of boric acid (4.0% aqueous solution); 3.42 parts of a 4% aqueous solution of a following compound (J) (manufactured by Wako Pure Chemical Ltd.); 1.13 parts of a 4% aqueous solution of a following compound (J′) (manufactured by Wako Pure Chemical Ltd.); and 0.67 parts of ion-exchanged water were mixed to obtain a coating solution for the intermediate layer.

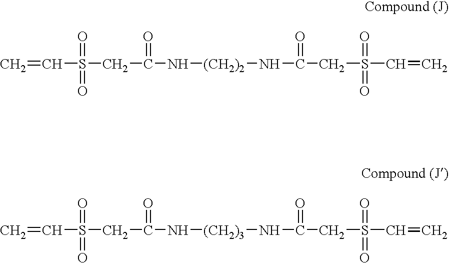

(5) Preparation of Coating Solution for Optical Transmittance Control Layer

<Preparation of Microcapsule Solution of Ultraviolet Absorber Precursor>

For the ultraviolet absorber precursor, 14.5 parts of [2-allyl-6-(2H-benzotriazol-2-yl)-4-t-octylphenyl]benzenesulfonate; 5.0 parts of 2,2′-t-octylhydroquinone; 1.9 parts of tricresyl phosphate; 5.7 parts of α-methylstyrene dimer (trade name: MSD-100, manufactured by Mitsui Chemicals Inc.); and 0.30 parts of calcium dodecylbenzenesulfonate (trade name: Pionin A-41-C, (70% methanol solution) manufactured by Takemoto Oil & Fat Co., Ltd.) were uniformly dissolved in 71 parts of ethyl acetate. To this mixture, 54.7 parts of a xylylene diisocyanate/trimethylolpropane adduct (trade name: Takenate D110N (75% ethyl acetate solution), manufactured by Mitsui Takeda Chemicals, Inc.) were added as a capsule wall material, and the mixture was uniformly stirred to obtain a mixture (VII-1) of the ultraviolet absorber precursor.

Separately, 8.9 parts of a 30% aqueous solution of phosphoric acid, and 532.6 parts of ion-exchanged water were mixed in 52 parts of itaconic acid-modified polyvinyl alcohol (trade name: KL-318, manufactured by Kuraray Co., Ltd) to obtain a polyvinyl alcohol (PVA) aqueous solution for a microcapsule solution of the ultraviolet absorber precursor.

The aforementioned mixture (VII-1) of the ultraviolet absorber precursor was added to 516.06 parts of the aqueous PVA solution for the ultraviolet absorber precursor microcapsule solution, and emulsified with a homogenizer (manufactured by NIPPON SEKI Co., Ltd.) at 20° C. The obtained emulsion was mixed uniformly with 254.1 parts of ion-exchanged water, and then subjected to an encapsulation reaction for 3 hours while stirring at 40° C. Thereafter, 94.3 parts of an ion exchange resin (trade name: Amberlite MB-3, manufactured by Organo Corp.) were added and the mixture was further stirred for 1 hour. Thereafter, the ion exchange resin was eliminated by filtration, and the capsule solution was subjected to an adjustment of concentration so as to obtain a solid content of 13.5%. The result of a particle size measurement with a particle size measuring apparatus (trade name: LA-700, manufactured by Horiba Co.) indicated that the obtained microcapsules had a median diameter of 0.23±0.05 μm. To 859.1 parts of this capsule solution, 2.416 parts of carboxy-modified styrene-butadiene latex (trade name: SN-307 (48% aqueous solution), manufactured by Sumitomo Norgatta) and 39.5 parts of ion-exchanged water were mixed to obtain a microcapsule solution of the ultraviolet absorber precursor.

<Preparation of Coating Solution for Optical Transmittance Control Layer>

1000 parts of the microcapsule solution of the ultraviolet absorber precursor; 7.75 parts of a 4% aqueous solution of sodium hydroxide and 73.39 parts of sodium (4-nonylphenoxytrioxyethylene)butylsulfonate (2.0% aqueous solution, manufactured by Sankyo Chemicals Co., Ltd.) were mixed to obtain a coating solution for the light transmittance control layer.

(6) Preparation of Coating Solution for Protective Layer

<Preparation of Polyvinyl Alcohol Solution for Protective Layer>

150 parts of a vinyl alcohol-alkylvinyl ether copolymer (trade name: EP-130, manufactured by Denka Corp.); 7.5 parts of a mixture of sodium alkylsulfonate and a polyoxyethylene alkyl ether phosphoric acid ester (trade name: Neoscore CM-57 (54% aqueous solution), manufactured by Toho Chemical Industries, Co., Ltd.); 7.05 parts of an ethylene oxide adduct of acetyelenediol (trade name: Dinol 604, manufactured by Air Products Japan, Inc.); 7.05 parts of a silicone surfactant (trade name: SYLGARD 309, manufactured by Toray-Dow Corning Silicone Ltd.); and 3592 parts of ion-exchanged water were mixed and uniformly dissolved for 1 hour at 90° C. to obtain a polyvinyl alcohol solution for the protective layer.

<Preparation of Pigment Dispersion for Protective Layer>

0.2 parts of an anionic special polycarboxylic acid polymer surfactant (trade name: Poise 532A (40% aqueous solution), manufactured by Kao Corp.) and 11.8 parts of ion-exchanged water were mixed in 8 parts of barium sulfate (trade name: BF-21F, barium sulfate content 93% or higher, manufactured by Sakai Chemical Industries, Co.) and dispersed in a Dyno mill to prepare a pigment dispersion for the protective layer. The result of a measurement with a particle size measuring apparatus (trade name: LA-700, manufactured by Horiba Co.) indicated that the dispersion had a median diameter of 0.15 μm.

<Preparation of Matting Agent Dispersion for Protective Layer>

3.81 parts of an aqueous dispersion of 1-2-benzisothiazolin-3-one (trade name: PROXEL B.D, manufactured by I.C.I. Ltd.) and 1976.19 parts of ion-exchanged water were mixed in 220 parts of wheat starch (trade name: Wheat starch S, manufactured by Shinshin Shokuryo Kogyo Co.) and dispersed uniformly to obtain a dispersion of the matting agent for the protective layer.

<Preparation of Coating Solution for Protective Layer>

50 parts of sodium (4-nonylphenoxytrioxyethylene)butylsulfonate (2.0% aqueous solution, manufactured by Sankyo Chemicals, Co.); 55 parts of the pigment dispersion for the protective layer; 16.65 parts of the dispersion of the matting agent for the protective layer; 48.7 parts of a zinc stearate dispersion (trade name: Himicron LIII, 21% aqueous solution, manufactured by Chukyo Yushi Co.); 9.6 parts of zirconium ammonium carbonate (trade name: Zircosol AC7, 13% aqueous solution, manufactured by Newtex Co.); and 280 parts of ion-exchanged water were uniformly mixed with 1000 parts of the polyvinyl alcohol solution for the protective layer to obtain a coating solution for the protective layer.

(7) Preparation of Support

<Preparation of Coating Solution for Undercoating Layer>

40 parts of enzyme-decomposed gelatin (average molecular weight: 10000, viscosity by PAGI method: 1.5 mPa.s (15 mP), jelly strength by PAGI method: 20 g) were added to 60 parts of ion-exchanged water and stirred and dissolved at 40° C. to obtain an aqueous gelatin solution for the undercoat layer.

Separately, 8 parts of water-swelling synthetic mica (aspect ratio: 1000, trade name: Somashif ME100, manufactured by Cope Chemical Inc.) were mixed with 92 parts of water and then subjected to wet dispersion in a visco mill to obtain a mica dispersion with an average particle size of 2.0 μm. Water was added to the mica dispersion so as to obtain a mica concentration of 5% and was uniformly mixed to obtain the desired mica dispersion.

120 parts of water and 556 parts of methanol were added to 100 parts of the aforementioned 40% at 40° C. aqueous gelatin solution for the undercoat layer, and sufficiently mixed and stirred, then 208 parts of the 5% mica dispersion were added and sufficiently mixed and stirred, and 7.5 parts of a 1.66% polyethylene oxide surfactant were added. Then, at a liquid temperature maintained at 35° to 40° C., 7.3 parts of an epoxy compound gelatin hardening agent were added to obtain a coating solution (5.7%) for the undercoat layer.

<Preparation of Support with Undercoat Layer>

Wood pulp, composed of 50 parts of LBPS and 50 parts of LBPK, was beaten with a disk refiner to a Canadian freeness of 300 ml, then had added thereto 0.5 parts of epoxylated behenate amide; 1.0 part of anionic polyacrylamide; 1.0 part of aluminum sulfate; 0.1 part of polyamidepolyamine epichlorohydrin; and 0.5 parts of cationic polyacrylamide, each in absolute dry mass ratios to the pulp, and was subjected to paper making with a long-screen paper mill to form a base paper with a basis weight of 114 g/m², of which the thickness was adjusted to 100 μm by a calendaring process.

After a corona discharge treatment on both surfaces of the base paper, polyethylene was coated with a melt extruder so as to obtain a resin thickness of 36 μm thereby forming a resin layer of a matted surface (referred to as a “rear surface”). Then, on the surface opposite to the surface bearing the above-mentioned resin layer, polyethylene containing titanium dioxide of anatase type in 10% and a small amount of Prussian blue was coated with a melt extruder so as to obtain a resin thickness of 50 μm thereby forming a resin layer with a glossy surface (referred to as a “front surface”). On the polyethylene resin coated rear surface, after a corona discharge treatment, aluminum oxide (trade name: Alumina Sol 100, manufactured by Nissan Chemical Industries, Ltd.)/silicon dioxide (trade name: Snowtex-O, manufactured by Nissan Chemical Industries, Ltd.)=1/2 (mass ratio) as an antistataic agent were dispersed in water and coated with a dry mass amount of 0.2 g/m². Then, on the polyethylene resin coated front surface, after a corona discharge treatment, the above-described coating solution for the undercoat layer was coated with a coating amount of mica of 0.26 g/m² to obtain a support with an undercoat layer.

(8) Preparation of Multi-Color Thermal Recording Material

On the support with the undercoat layer, seven layers were simultaneously and successively coated in order, from the bottom, of the thermal recording layer coating solution (c-1); the intermediate layer coating solution; the thermal recording layer coating solution (b-1); the intermediate layer coating solution; the thermal recording layer coating solution (a-1); the coating solution for the light transmittance control layer; and the coating solution for the protective layer, and were each dried under conditions of 30° C., 30% RH and then 40° C., 30% RH to obtain a multi-color thermal recording material of example 5.

In this operation, the thermal recording layer coating solution (a-1) was coated such that the diazo compound (A) had a solid coating amount of 0.078 g/m², the thermal recording layer coating solution (b-1) was coated such that the diazo compound (D) had a solid coating amount of 0.206 g/m², and the thermal recording layer coating solution (c-1) was coated such that the electron donating dye (H) had a solid coating amount of 0.355 g/m².

Also, the intermediate layer coating solution was coated, between (a-1) and (b-1), so as to have a solid coating amount of 2.50 g/m². The intermediate layer coating solution was coated, between (b-1) and (c-1), so as to have a solid coating amount of 3.45 g/m². Further, the coating solution for the light transmittance control layer was coated so as to have a solid coating amount of 2.35 g/m², and the coating solution for the protective layer was coated so as to have a solid coating amount of 1.60 g/m².

### Comparative Example 4

The multi-color thermal recording material of comparative example 4 was prepared the same as in example 5, except that the ammonium zirconium carbonate (trade name: Zircosol AC7 (13% aqueous solution)), was not added in the coating solution for the protective layer, and, the amount of boric acid (4.0% aqueous solution) added to the coating solution for the intermediate layer was changed from 3.6 parts to 2.7 patrs.

### Comparative Example 5

The multi-color thermal recording material of comparative example 5 was prepared the same as in example 5, except that the boric acid (4.0% aqueous solution), was not added in the coating solution for the intermediate layer.

### Comparative Example 6

The multi-color thermal recording material of comparative example 6 was prepared the same as in example 5, except that the boric acid (4.0% aqueous solution) for the intermediate layer coating solution and the ammonium zirconium carbonate (trade name: Zircosol AC7 (13% aqueous solution)) for the protective layer coating solution were not added in the coating solution for the protective layer.

<<Evaluation>>

The multi-color thermal recording materials of the aforementioned example and comparative examples were subjected to the following evaluations. The obtained results are shown in Table 5.

<Measurement of Glossiness>

A black solid image was printed on each thermal recording material with a digital printer (trade name: NC370D, manufactured by Fuji Photo Film Co., Ltd.). On the print surface of the black solid image of each thermal recording material, the mirror surface glossiness was measured with a digital variable angle glossiness meter (trade name: UGV-5D, manufactured by SUGA TEST INSTRUMENTS CO., LTD.) with an incident angle of 20°.

<Measurement of Printing Torque>

An A5-sized thermal head (model: KTJ-13 SAN24-FFA, manufactured by Kyocera Corp.) was mounted on a jig printer equipped with a platen of a diameter of 12φ, a hardness of 40° and a pressure of 6 kg/cm (trade name: GX-3, manufactured by Matires Co.), and gradation printing was executed with conditions of a line cycle of 5.29 ms, electric power of 0.32 W, a maximum print energy of 105.6 mJ/mm² and a transport speed of 16 mm/s. In this operation, the torque generated between the thermal recording material and the platen roll was measured at print energies of 17, 40 and 95 mJ/mm² and was converted into a dynamic friction coefficient.

<Evaluation of Unevenness Caused by Load Change>

The test pattern including a high energy image (black solid band) and a low energy area (white background area) in succession was printed on each thermal recording material with a digital printer (trade name: NC370D, manufactured by Fuji Photo Film Co., Ltd.) and the level of unevenness in the density was evaluated by visual observation according to the following criteria:

Criteria

AA: unevenness in density not observed;

BB: slight unevenness in density observed in certain portions;

CC: high unevenness in density observed.

TABLE 5

| | Addition | Addition | | | | Unevenness | |
|---|---|---|---|---|---|---|---|
| | amount of | amount of | Printing torque | | | due to load | Glossi- |
| | zirconium^{*)} | boric acid^{*)} | 17 mJ/mm² | 40 mJ/mm² | 95 mJ/mm² | change | ness |
| Example 5 | 3.0% | 10% | 0.28 | 0.16 | 0.17 | AA | 49 |
| Comp. Ex. 4 | — | 15% | 0.31 | 0.19 | 0.20 | BB | 42 |
| Comp. Ex. 5 | 3.0% | — | 0.32 | 0.19 | 0.21 | BB | 44 |
| Comp. Ex. 6 | — | — | 0.40 | 0.26 | 0.25 | CC | 24 |

^{*)}represented in % by mass with respect to PVA resin

According to the results in Table 5, the multi-color thermal recording materials of the present invention (Example 5) which included boric acid and the water-soluble zirconium compound as thermal recording materials, exhibited excellent glossiness and suppressed unevenness due to load change (unevenness in density). Also, the multi-color thermal recording materials of the invention (example 5) showed reduced printing torque, and were capable of printing high-quality images. On the other hand, the multi-color thermal recording materials of the comparative examples that did not include at least one of boric acid and water-soluble zirconium compound (comparative examples 4 to 6) exhibited insufficient glossiness, unevenness due to load change and high printing torque, thereby being inferior in quality.

### Example 6

<Preparation of Phthalated Gelatin Aqueous Solution>

32 parts of phthalated gelatin (trade name: MGP gelatin, manufactured by Nippi Collagen Co., Ltd.); 0.9143 parts of 1,2-benzothiazolin-3-one (3.5% methanol solution, manufactured by Daito Chemical Industries, Ltd.); and 367.1 parts of ion-exchanged water were mixed and dissolved at 40° C. to obtain a phthalated gelatin aqueous solution.

<Preparation of Alkali-Treated Aqueous Gelatin Solution>

25.5 parts of alkali-treated low-ion content gelatin (trade name: #750 gelatin, manufactured by Nitta Gelatin Inc.); 0.7286 parts of 1,2-benzothiazolin-3-one (3.5% methanol solution, manufactured by Daito Chemical Industries, Ltd.); 0.153 parts of calcium hydroxide; and 143.6 parts of ion-exchanged water were mixed and dissolved at 50° C. to obtain an alkali-treated gelatin aqueous solution for preparing an emulsion.

(1) Preparation of Coating Solution for Yellow Thermal Recording Layer

<Preparation of Diazonium Compound Containing Microcapsule Solution (a-2)>

2.2 parts of a following diazonium compound (A) (maximum absorption wavelength 420 nm); 2.2 parts of a following diazonium compound (B) (maximum absorption wavelength 420 nm); 4.8 parts of monoisopropylbiphenyl, 4.0 parts of diphenyl phthalate and 0.4 parts of diphenyl-(2,4,6-trimethylbenzoyl)phosphin oxide (trade name: Lucirin TPO, manufactured by BASF Japan Co.) were added to 16.1 parts of ethyl acetate, and dissolved uniformly by heating at 40° C. To this mixture, 8.6 parts of a mixture of xylylene diisocyanate/trimethylolpropane adduct and xylylene diisocyanate/bisphenol-A adduct (trade name: Takenate D119N (50% solution in ethyl acetate), manufactured by Mitsui-Takeda Chemicals, Inc.) were added as a capsule wall material and were uniformly stirred to obtain a mixture (I-2).

Separately, 16.3 parts of ion-exchanged water and 0.34 parts of a 50% alkylglucoxide surfactant (trade name: Scraph AG-8 manufactured by Nippon Seika Co.) were added to 58.6 parts of the above-mentioned phthalated gelatin aqueous solution to obtain a mixture (II-2).

Mixture (I-2) was added to mixture (II-2), and was emulsified with a homogenizer (manufactured by NIPPON SEKI Co., Ltd.) at 40° C. 20 parts of water were added to the obtained emulsion and mixed uniformly, and then subjected to an encapsulation reaction for 3 hours while stirring 40° C. to eliminate ethyl acetate. Thereafter, 4.1 parts of an ion exchange resin (trade name: Amberlite IRA68, manufactured by Organo Corp.) and 8.2 parts of an ion exchange resin (trade name: Amberlite IRC50, manufactured by Organo Corp.) were added and the mixture was further stirred for 1 hour. Thereafter, the ion exchange resin was eliminated by filtration, and the capsule solution was subjected to an adjustment of concentration so as to obtain a solid content of 20.0%, thereby obtaining a diazonium compound containing microcapsule solution (a-2). The result of measurement with a particle size measuring apparatus (trade name: LA-700, manufactured by Horiba Co.) indicated that the obtained microcapsules had a median diameter of 0.36 μm.

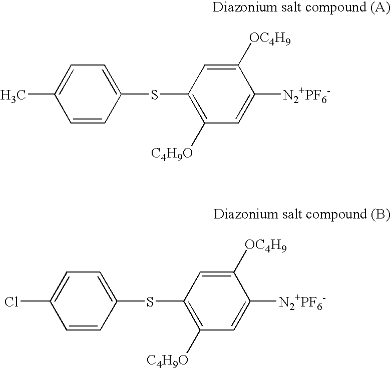

<Preparation of Coupler Compound Emulsion (a-2)>

9.9 parts of a following coupler compound (C); 9.9 parts of triphenylguanidine (manufactured by Hodogaya Chemical Co., Ltd.); 20.8 parts of 4,4′-(m-phenylenediisopropylidene)-diphenol (trade name: Bisphenol M, manufactured by Mitsui Petrochemicals Inc.); 3.3 parts of 3,3,3′,3′-tetramethyl-5,5′,6,6′-tetra(1-propyloxy)-1,1′-spirobisindane; 13.6 parts of 4-(2-ethylhexyloxy)benzenesulfonic acid amide (manufactured by Manac Incroporated.); 6.8 parts of 4-n-pentyloxybenzenesulfonic acid amide (manufactured by Manac Inc.); and 4.2 parts of calcium dodecylbenzenesulfonate (trade name: Pionin A-41-C (70% methanol solution), manufactured by Takemoto Oil & Fat Co., Ltd.) were dissolved in 33.0 parts of ethyl acetate to obtain a mixture (III-2).

Separately, 206.3 parts of the above-mentioned alkali-treated gelatin aqueous solution were mixed with 107.3 parts of ion-exchanged water to obtain a mixture (IV-2).

The mixture (III-2) was added to the mixture (IV-2), and was emulsified with a homogenizer (manufactured by NIPPON SEKI Co., Ltd.) at 40° C. The obtained emulsion of the coupler compound was heated under reduced pressure to eliminate ethyl acetate, and subjected to an adjustment of concentration so as to obtain a solid content of 26.5%. The result of measurement with a particle size measuring apparatus (trade name LA-700, manufactured by Horiba Co.) indicated that the obtained emulsion of the coupler compound had a median diameter of 0.21 μm.

Further, 9 parts of SBR latex (trade name: SN-307 (48% liquid), manufactured by Sumika ABS Latex Co.), adjusted to a concentration of 26.5%, were added to 100 parts of the aforementioned emulsion of coupler compound and were uniformly stirred to obtain a coupler compound emulsion (a-2)

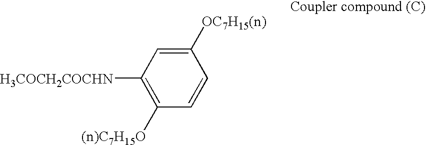

<Preparation of Coating Solution (a-2) for Yellow Thermal Recording Layer>

The diazonium compound containing microcapsule solution (a-2) and the emulsion (a-2) of the coupler compound were mixed such that the mass ratio of the included coupler compound/diazonium compound became 2.2/1, thereby obtaining a coating solution (a-2) for the yellow thermal recording layer.

(2) Preparation of Coating Solution for Magenta Recording Layer

<Preparation of Diazonium Compound Containing Microcapsule Solution (b-2)>

In 15.1 parts of ethyl acetate, 2.8 parts of a following diazonium compound (D) (maximum absorption wavelength 365 nm); 3.8 parts of diphenyl phthalate; 3.9 parts of phenyl 2-benzoyloxybenzoate; 5.2 parts of a following ester compound (trade name: Light Ester TMP, manufactured by Kyoei Yushi Kagaku Co.); and 0.1 parts of calcium dodecylbenzenesulfonate (trade name: Pionin A-41-C, 70% methanol solution, manufactured by Takemoto Oil & Fat Co., Ltd.) were added, and uniformly dissolved by heating. To this mixture, 2.5 parts of a mixture of xylylene diisocyanate/trimethylolpropane adduct and xylylene diisocyanate/bisphenol-A adduct (trade name: Takenate D119N (50% ethyl acetate solution), manufactured by Mitsui Takeda Chemicals, Inc.) and 6.8 parts of a xylylene diisocyanate/trimethylolpropane adduct (trade name: Takenate D110N (75% ethyl acetate solution) manufactured by Mitsui Takeda Chemicals, Inc.) were added as capsule wall materials and uniformly stirred to obtain a mixture (V-2).

Separately, 21.0 parts of ion-exchanged water were added to 55.3 parts of the above-mentioned phthalated gelatin aqueous solution to obtain a mixture (VI-2).

The mixture (V-2) was added to the mixture (VI-2), and was emulsified with a homogenizer (manufactured by NIPPON SEKI Co., Ltd.) at 40° C. The obtained emulsion was mixed uniformly with 24 parts of water, and then subjected to an encapsulation reaction for 3 hours while stirring at 40° C. to eliminate ethyl acetate. Thereafter, 4.1 parts of an ion exchange resin (trade name: Amberlite IRA68, manufactured by Organo Corp.) and 8.2 parts of an ion exchange resin (trade name: Amberlite IRC50, manufactured by Organo Corp.) were added and the mixture was further stirred for 1 hour. Thereafter, the ion exchange resin was eliminated by filtration, and the capsule solution was subjected to an adjustment of concentration so as to obtain a solid content of 20.0%, thereby obtaining a diazonium compound containing microcapsule solution (b-2)

The result of measurement with a particle size measuring apparatus (trade name: LA-700, manufactured by Horiba Co.) indicated that the obtained microcapsules had a median diameter of 0.43 μm.

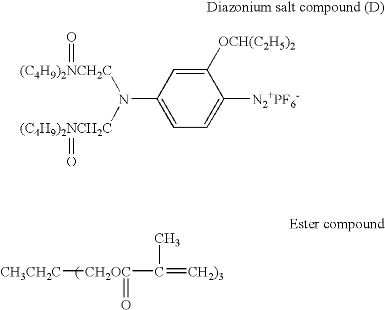

<Preparation of Coupler Compound Emulsion (b-2)>

In 36.9 parts of ethyl acetate, 11.9 parts of a following coupler compound (E); 14.0 parts of triphenylguanidine (manufactured by Hodogaya Chemical Co., Ltd.); 14.0 parts of 4,4′-(m-phenylenediisopropylidene)-diphenol (trade name: Bisphenol M, manufactured by Mitsui Petrochemicals Inc.); 14.0 parts of 1,1-(p-hydroxyphenyl)-2-ethylhexane; 3.5 parts of 3,3,3′,3′-tetramethyl-5,5′,6,6′-tetra(1-propyloxy)-1,1′-spirobisindane; 3.5 parts of a following compound (G); 1.7 parts of tricresyl phosphate; 0.8 parts of diethyl maleate; and 4.5 parts of calcium dodecylbenzenesulfonate (trade name: Pionin A-41-C (70% methanol solution), manufactured by Takemoto Oil & Fat Co., Ltd.) were dissolved to obtain a mixture (VII-2).

Separately, 206.3 parts of the above-mentioned alkali-treated gelatin aqueous solution were mixed with 107.3 parts of ion-exchanged water to obtain a mixture (VIII-2).

Mixture (VII-2) was added to mixture (VIII-2), and emulsified with a homogenizer (manufactured by NIPPON SEKI Co., Ltd.) at 40° C. The obtained emulsion of the coupler compound was heated under reduced pressure to eliminate ethyl acetate, and subjected to an adjustment of concentration so as to obtain a solid content of 24.5%, thereby obtaining an emulsion (b-2) of the coupler compouond. The result of measurement with a particle size measuring apparatus (trade name LA-700, manufactured by Horiba Co.) indicated that the obtained emulsion of the coupler compound had a median diameter of 0.22 μm.

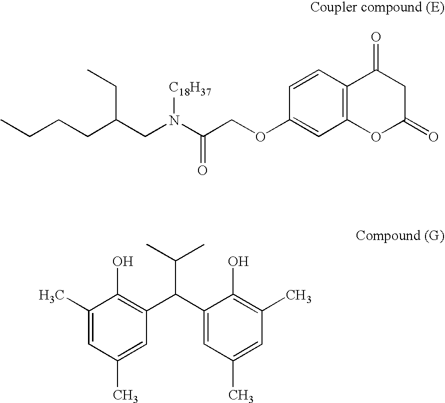

<Preparation of Coating Solution (b-2) for Magenta Thermal Recording Layer>

The diazonium compound containing microcapsule solution (b-2) and the emulsion (b-2) of the coupler compound were mixed such that the mass ratio of the included coupler compound/diazonium compound became 3.5/1. Further, an aqueous solution (5%) of polystyrenesulfonic acid (partially neutralized with potassium hydroxide) was mixed in an amount of 0.2 parts to 10 parts of the capsule solution, thereby obtaining a coating solution (b-2) for the thermal recording layer.

3) Preparation of Coating Solution for Cyan Thermal Recording Layer

<Preparation of Electron Donating Dye Precursor Containing Microcapsule Solution (c-2)>

In 18.1 parts of ethyl acetate, 7.6 parts of a following electron donating dye (H); 8.0 parts of a mixture of 1-methylpropylphenyl-phenylmethane and 1-(1-methylpropyl-phenyl)-2-phenylethane (trade name: Hysol SAS-310, manufactured by Japan Oil Co, Ltd.); and 8.0 parts of a following compound (I) (trade name: Irgaperm 2140, manufactured by Ciba-Geigy Inc.) were added, heated and uniformly dissolved by heating. To this mixture, 7.2 parts of a xylylene diisocyanate/trimethylolpropane adduct (trade name: Takenate D110N (75% ethyl acetate solution) manufactured by Mitsui Takeda Chemicals, Inc.) and 5.3 parts of polymethylene polyphenyl polyisocyanate (trade name: Millionate MR-200, manufactured by Nippon Polyurethane Industries, Co., Ltd.) were added as capsule wall materials and uniformly stirred to obtain a mixture (IX-2).

Separately, 9.5 parts of ion-exchanged water; 0.17 parts of a 50% alkylglucoxide surfactant (trade name: Scraph AG-8, manufactured by Nippon Seika Co.); and 4.3 parts of sodium dodecylbenzenesulfonate (10% aqueous solution) were added with to 28.8 parts of the above-mentioned phthalated gelatin aqueous solution obtain a mixture (X-2).

Mixture (IX-2) was added to mixture (X-2), and was emulsified with a homogenizer (manufactured by NIPPON SEKI Co., Ltd.) at 40° C. The obtained emulsion was mixed uniformly with 50 parts of water and 0.12 parts of tetraethylene pentamine, and was subjected to an encapsulation reaction for 3 hours while stirring at 65° C. to eliminate ethyl acetate, and the concentration was adjusted as to obtain a solid concentration of 33% in the liquid, thereby obtaining a microcapsule solution. The result of measurement with a particle size measuring apparatus (trade name LA-700, manufactured by Horiba Co.) indicated that the obtained microcapsules had a median diameter of 1.00 μm.

Further, 3.7 parts of a 25% aqueous solution of sodium dodecylbenzenesulfonate (trade name: NEOPELEX F-25, manufactured by Kao Corp.) and 4.2 parts of a fluorescent whitening agent containing a 4,4′-bistriazinyl-aminostylbene-2,2′-disulfon derivative (trade name: Kaycoll BXNL, manufactured by Nippon Soda Co., Ltd.) were added to 100 parts of the microcapsule solution and uniformly stirred to obtain a electron donating dye precursor containing microcapsule dispersion (c-2).

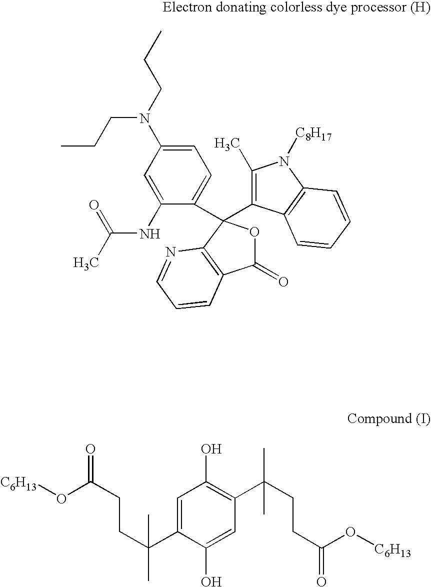

<Preparation of Electron Accepting Compound Dispersion (c-2)>

30.1 parts of ion-exchanged water; 15 parts of 4,4′-(p-phenylenediisopropylidene)diphenol (trade name: bisphenol P, manufactured by Mitsui Petrochemical Co.); and 3.8 parts of a 2% aqueous solution of sodium 2-ethylhexylsuccinate were added to 11.3 parts of the phthalated gelatin aqueous solution and dispersed overnight with a ball mill to obtain a dispersion. The dispersion had a solid content of 26.6%. 100 parts of the dispersion had added thereto 45.2 parts of the alkali-treated gelatin aqueous solution, and was then stirred for 30 minutes, after which ion-exchanged water was added so as to obtain a solid content of 23.5% thereby obtaining an electron accepting compound dispersion (c-2).

<Preparation of Coating Solution (c-2) of Cyan Thermal Recording Layer>

The microcapsule the electron donating dye precursor containing solution (c-2) and the electron accepting compound dispersion (c-2) were mixed such that the mass ratio of the electron accepting compound/electron donating dye precursor became 10/1, thereby obtaining a coating solution (c-2).

(4) Preparation of Coating Solution for Intermediate Layer

100.0 parts of alkali-treated low ion content gelatin (trade name: #750 gelatin, manufactured by Nitta Gelatin Inc.); 2.857 parts of 1,2-benzothiazolin-3-one (3.5% methanol solution, manufactured by Daito Chemical Industries, Ltd.); 0.5 parts of calcium hydroxide; and 521.643 parts of ion-exchanged water were mixed and dissolved at 50° C. to obtain an aqueous gelatin solution for preparing an intermediate layer.

10.0 parts of the gelatin aqueous solution for preparing the intermediate layer; 0.05 parts of sodium (4-nonylphenoxytrioxyethylene)butylsulfonate (2.0% aqueous solution, manufactured by Sankyo Chemicals Co., Ltd.); 0.19 parts of a 5% aqueous solution of polystyrenesulfonic acid (partially neutralized with potassium hydroxide); 2.7 parts of boric acid (4.0% aqueous solution); 3.42 parts of a 4% aqueous solution of a following compound (J) (manufactured by Wako Pure Chemical Ltd.); 1.13 parts of a 4% aqueous solution of a following compound (J′) (manufactured by Wako Pure Chemical Ltd.); and 0.67 parts of ion-exchanged water were mixed to obtain a coating solution for the intermediate layer.

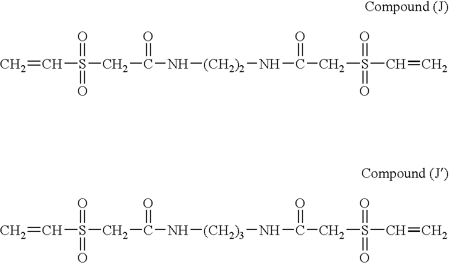

(5) Preparation of Coating Solution for Optical Transmittance Control Layer

<Preparation of Microcapsule Solution of Ultraviolet Absorber Precursor>

14.5 parts of [2-allyl-6-(2H-benzotriazol-2-yl)-4-t-octylphenyl]benzenesulfonate as an ultraviolet absorber precursor; 5.0 parts of 2,2′-t-octylhydroquinone; 1.9 parts of tricresyl phosphate; 5.7 parts of α-methylstyrene dimer (trade name: MSD-100, manufactured by Mitsui Chemicals Inc.); and 0.55 parts of calcium dodecylbenzenesulfonate (trade name: Pionin A-41-C, (70% methanol solution) manufactured by Takemoto Oil & Fat Co., Ltd) were uniformly dissolved in 71 parts of ethyl acetate. To this mixture, 54.7 parts of a xylylene diisocyanate/trimethylolpropane adduct (trade name: Takenate D110N (75% ethyl acetate solution), manufactured by Mitsui Takeda Chemicals, Inc.) were added as a capsule wall material, and the mixture was uniformly stirred to obtain a mixture (VII-2) of the ultraviolet absorber precursor.

Separately, 8.9 parts of a 30% aqueous solution of phosphoric acid, and 532.6 parts of ion-exchanged water were mixed in 52 parts of itaconic acid-modified polyvinyl alcohol (trade name: KL-318, manufactured by Kuraray Co., Ltd) to obtain a polyvinyl alcohol (PVA) aqueous solution for a microcapsule solution of the ultraviolet absorber precursor.

The aforementioned mixture (VII-2) of the ultraviolet absorber precursor was added to 516.06 parts of the aqueous PVA solution for the ultraviolet absorber precursor microcapsule solution, and was emulsified with a homogenizer (manufactured by NIPPON SEKI Co., Ltd.) at 20° C. The obtained emulsion was mixed uniformly with 254.1 parts of ion-exchanged water, and was subjected to an encapsulation reaction for 3 hours while stirring at 40° C. Thereafter, 94.3 parts of an ion exchange resin (trade name: Amberlite MB-3, manufactured by Organo Corp.) were added and the mixture was further stirred for 1 hour. Thereafter the ion exchange resin was eliminated by filtration, and the capsule solution was subjected to an adjustment of concentration so as to obtain a solid content of 13.5%. The result of a particle size measurement with a particle size measuring apparatus (trade name: LA-700, manufactured by Horiba Co.) indicated that the obtained microcapsules had a median diameter of 0.23±0.05 μm. 859.1 parts of the microcapsule solution were mixed with 2.416 parts of carboxy-modified styrene-butadiene latex (trade name: SN-307 (48% aqueous solution), manufactured by Sumitomo Norgatta) and 39.5 parts of ion-exchanged water to obtain a microcapsule solution of the ultraviolet absorber precursor.

<Preparation of Coating Solution for Optical Transmittance Control Layer>

1000 parts of the microcapsule solution of the ultraviolet absorber precursor; 7.75 parts of a 4% aqueous solution of sodium hydroxide; and 73.39 parts of sodium (4-nonylphenoxytrioxyethylene)butylsulfonate (2.0% aqueous solution, manufactured by Sankyo Chemicals Co., Ltd.) were mixed to obtain a coating solution for the light transmittance control layer.

(6) Preparation of Coating Solution for Protective Layer

<Preparation of Polyvinyl Alcohol Solution for Protective Layer>

150 parts of a vinyl alcohol-alkylvinyl ether copolymer (trade name: EP-130, manufactured by Denka Corp.); 7.5 parts of a mixture of sodium alkylsulfonate and a polyoxyethylene alkyl ether phosphoric acid ester (trade name: Neoscore CM-57 (54% aqueous solution), manufactured by Toho Chemical Industries, Co., Ltd.); 7.05 parts of an ethylene oxide adduct of acetyelenediol (trade name: Dinol 604, manufactured by Air Products Japan, Inc.); 7.05 parts of a silicone surfactant (trade name: SYLGARD 309, manufactured by Toray-Dow Corning Silicone Ltd.); and 3592 parts of ion-exchanged water were mixed and uniformly dissolved for 1 hour at 90° C. to obtain a polyvinyl alcohol solution for the protective layer.

<Preparation of Pigment Dispersion for Protective Layer>

0.2 parts of an anionic special polycarboxylic acid polymer surfactant (trade name: Poise 532A (40% aqueous solution), manufactured by Kao Corp.) and 11.8 parts of ion-exchanged water were mixed with 8 parts of barium sulfate (trade name: BF-21F, barium sulfate content 93% or higher, manufactured by Sakai Chemical Industries, Co.) and dispersed in a Dyno mill to prepare a pigment dispersion for the protective layer. The result of a measurement with a particle size measuring apparatus (trade name: LA-700, manufactured by Horiba Co.) indicated that the dispersion had a median diameter of 0.15 μm.

82.0 parts of the barium sulfate dispersion were added with 18.4 parts of colloidal silica (trade name: Snowtex-O, 20% aqueous dispersion, manufactured by Nissan Chemical Industries, Ltd., average particle size 20 nm) to obtain the desired pigment dispersion for the protective layer.

<Preparation of Matting Agent Dispersion for Protective Layer>

3.81 parts of an aqueous dispersion of 1-2-benzisothiazolin-3-one (trade name: PROXEL B.D, manufactured by I.C.I. Ltd.) and 1976.19 parts of ion-exchanged water were mixed in 220 parts of wheat starch (trade name: Wheat starch S, manufactured by Shinshin Shokuryo Kogyo Co.) and dispersed uniformly to obtain a dispersion of the matting agent for the protective layer.

<Preparation of Coating Solution for Protective Layer>

50 parts of sodium (4-nonylphenoxytrioxyethylene)butylsulfonate (2.0% aqueous solution, manufactured by Sankyo Chemicals, Co.); 61.2 parts of the pigment dispersion for the protective layer; 16.65 parts of the dispersion of the matting agent for the protective layer; 48.7 parts of a zinc stearate dispersion (trade name: Himicron LIII, 21% aqueous solution, manufactured by Chukyo Yushi Co.); 4.8 parts of zirconium ammonium carbonate (trade name: Zircosol AC7, 13% aqueous solution, manufactured by Newtex Co.); and 280 parts of ion-exchanged water were uniformly mixed in 1000 parts of the polyvinyl alcohol solution for the protective layer to obtain a coating solution for the protective layer.

(7)Preparation of Support

<Preparation of Coating Solution for Undercoating Layer>

40 parts of enzyme-decomposed gelatin (average molecular weight: 10000, viscosity by PAGI method: 1.5 mPa.s (15 mP), jelly strength by PAGI method: 20 g) were mixed with 60 parts of ion-exchanged water and dissolved while stirring at 40° C. to obtain an aqueous gelatin solution for the undercoat layer.

Separately, 8 parts of water-swelling synthetic mica (aspect ratio: 1000, trade name: Somashif ME100, manufactured by Cope Chemical Inc.) were mixed with 92 parts of water and subjected to wet dispersion in a visco mill to obtain a mica dispersion with an average particle size of 2.0 μm. The mica dispersion had water added thereto so as to obtain a mica concentration of 5% and was uniformly mixed to obtain a desired mica dispersion.

To 100 parts of the aforementioned 40% aqueous gelatin solution for the undercoat layer at 40° C., 120 parts of water and 556 parts of methanol were added and sufficiently mixed and stirred, then 208 parts of the 5% mica dispersion were added and sufficiently mixed and stirred, and 9.8 parts of a 1.66% polyethylene oxide surfactant were added. Then, at a liquid temperature maintained at 35 to 40° C., 7.3 parts of an epoxy compound gelatin hardening agent were added to obtain a coating solution (5.7%) for the undercoat layer.

<Preparation of Support with Undercoat Layer>

Wood pulp, composed of 50 parts of LBPS and 50 parts of LBPK, was beaten with a disk refiner to a Canadian freeness of 300 ml, then had added thereto 0.5 parts of epoxylated behenate amide; 1.0 part of anionic polyacrylamide; 1.0 part of aluminum sulfate; 0.1 part of polyamidepolyamine epichlorohydrin; and 0.5 parts of cationic polyacrylamide, each in absolute dry mass ratios to the pulp, and was subjected to paper making with a long-screen paper mill to form a base paper with a basis weight of 114 g/m² and the thickness was adjusted to 100 μm by a calendaring process.

After a corona discharge treatment on both surfaces of the base paper, polyethylene was coated with a melt extruder so as to obtain a resin thickness of 36 μm thereby forming a resin layer of a matted surface (referred to as a “rear surface”). Then, on the surface opposite to the surface bearing the above-mentioned resin layer, polyethylene containing titanium dioxide of anatase type in 10% and a small amount of Prussian blue were coated with a melt extruder so as to obtain a resin thickness of 50 μm thereby forming a resin layer with a glossy surface (referred to as a “front surface”). On the polyethylene resin coated rear surface, after a corona discharge treatment, aluminum oxide (trade name: Alumina Sol 100, manufactured by Nissan Chemical Industries, Ltd.)/silicon dioxide (trade name: Snowtex-O, manufactured by Nissan Chemical Industries, Ltd.)=1/2 (mass ratio) as an antistatic agent were dispersed in water and coated with a dry mass amount of 0.2 g/m². Then, on the polyethylene resin coated front surface, after a corona discharge treatment, the above-described coating solution for the undercoat layer was coated with a coating amount of mica of 0.26 g/m² to obtain a support with an undercoat layer.

(8) Preparation of Multi-Color Thermal Recording Material

On the support with the undercoat layer, seven layers were simultaneously and successively coated in the following order from the bottom, of the thermal recording layer coating solution (c-2); the intermediate layer coating solution; the thermal recording layer coating solution (b-2); the intermediate layer coating solution; the thermal recording layer coating solution (a-2); the coating solution for the light transmittance control layer; and the coating solution for the protective layer and were dried under conditions of 30° C., 30% RH and then 40° C., 30% RH to obtain a multi-color thermal recording material of example 6.

In this operation, the thermal recording layer coating solution (a-2) was coated such that the diazo compound (A) had a solid coating amount of 0.078 g/m²; the thermal recording layer coating solution (b-2) was coated such that the diazo compound (D) had a solid coating amount of 0.206 g/m²; and the thermal recording layer coating solution (c-2) was coated such that the electron donating dye (H) had a solid coating amount of 0.355 g/m².

Further, the intermediate layer coating solution was coated, between (a-2) and (b-2), so as to have a solid coating amount of 2.50 g/m². The intermediate layer coating solution was coated, between (b-2) and (c-2), so as to have a solid coating amount of 3.45 g/m². Further, the coating solution for the light transmittance control layer was coated so as to have a solid coating amount of 2.35 g/m², and the coating solution for the protective layer was coated so as to have a solid coating amount of 1.60 g/m².

### Example 7

The multi-color thermal recording material of example 7 was prepared the same as in example 6, except that, in the preparation of the pigment dispersion for the protective layer, 29.0 parts of colloidal silica (trade name: Snowtex-O, manufactured by Nissan Chemical Industries, Ltd.) were added to 76.8 parts of the barium sulfate dispersion.

### Comparative Example 7

The multi-color thermal recording material of comparative example 7 was prepared the same as in example 8, except that, in the preparation of the pigment dispersion for the protective layer, the colloidal silica (trade name: Snowtex-O, manufactured by Nissan Chemical Industries, Ltd.) was not added.

### Comparative Example 8

The multi-color thermal recording material of comparative example 8 was prepared the same as in example 8, except that, in the preparation of the coating solution for the protective layer, zirconium ammonium carbonate (trade name: Zircosol AC7, manufactured by Newtex Co.) was not added.

### Comparative Example 9

The multi-color thermal recording material of comparative example 9 was prepared the same as in example 8, except that, in the preparation of the coating solution for the intermediate layer, boric acid (4.0% aqueous solution) was not added.

### Comparative Example 10

The multi-color thermal recording material of comparative example 10 was prepared the same as in example 8, except that, in the preparation of the coating solution for the intermediate layer, boric acid (4.0% aqueous solution) was not added, and that, in the preparation of the coating solution for the protective layer, zirconium ammonium carbonate (trade name: Zircosol AC7, manufactured by Newtex Co.) was not added.

<<Evaluation>>

The multi-color thermal recording materials of the aforementioned examples and comparative examples were subjected to the following evaluations. The obtained results are shown in Table 6.

<Measurement of Glossiness>

A black solid image was printed on each thermal recording material with a digital printer (trade name: NC370D, manufactured by Fuji Photo Film Co., Ltd.). On a print surface of the black solid image of each thermal recording material, the mirror surface glossiness was measured with a digital variable angle glossiness meter (trade name: UGV-5D, manufactured by SUGA TEST INSTRUMENTS CO., LTD.) with an incident angle of 200.

<Measurement of Printing Torque>

An A5-sized thermal head (model: KTJ-13 SAN24-FFA, manufactured by Kyocera Corporation.) was mounted on a jig printer equipped with a platen of a diameter of 12φ, a hardness of 40° and a pressure of 6 kg/cm (trade name: GX-3, manufactured by Matires Co.), and gradation printing was executed with conditions of a line cycle of 5.29 ms, an electric power of 0.32 W, a maximum print energy of 105.6 mJ/mm² and a transport speed of 16 mm/s. In this operation, the torque generated between the thermal recording material and the platen roll was measured at print energies of 17, 40 and 95 mJ/mm² and was converted into a coefficient of dynamic friction.

<Evaluation of Unevenness Due to Load Change>

A test pattern including a high energy image (black solid band) and a low energy area (white background area) in succession was printed on each thermal recording material with a digital printer (trade name: NC370D, manufactured by Fuji Photo Film Co., Ltd.), and the level of unevenness in the density was evaluated by visual observation according to the following criteria:

Criteria

AA: unevenness in density not observed;

BB: slight unevenness in density observed in certain portions;

CC: high unevenness in density observed.

<Dirt of Thermal Head>

With a digital printer (trade name: NC-300, manufactured by Fuji Photo Film Co., Ltd.), an A5-sized solid black image was printed continuously for 10000 sheets by randomly applying print energy (9 to 105 mJ/mm²). Regarding Dirt of the thermal head after printing, changes in the shape of a surface of the resistor element of the thermal head before and after the printing were measured with a needle-contact surface shape measuring apparatus (trade name: P-11, manufactured by KAL Tencor Corp.). The amount of dirt was calculated from the measured changes and normalized. A smaller value signifies less dirt of the thermal head.

<Evaluation of Image Quality>

With a PX printer (trade name: NC-600D, manufactured by Fuji Photo Film Co., Ltd.), an A6-sized test image including areas of different print energies of 9 to 105 mJ/mm² was continuously printed for 30000 sheets. Image quality after printing was observed visually and evaluated according to the following criteria:

Criteria

+: uneven density, step differences, scratches, etc. not observed;

density uneven: slight density unevenness observed in certain portions;

print failure: extreme density unevenness, step differences, scratches, etc. observed.

TABLE 6

| | | | Barium | | | | | Unevenness | | | Image |
|---|---|---|---|---|---|---|---|---|---|---|---|
| | Addition | Addition | sulfate/ | Silica | | | | due to | | Dirt | quality^{**)} |
| | amount of | amount of | silica | particle | Printing torque | | | load | Glossi- | of | (30000 |
| | zirconium^{*)} | boric acid^{*)} | ratio | size | 17 mJ/mm² | 40 mJ/mm² | 95 mJ/mm² | change | ness | head | prints) |
| Example 6 | 3.0% | 15% | 90/10 | 20 nm | 0.26 | 0.16 | 0.16 | AA | 48 | 0.3 | + |
| Example 7 | 3.0% | 15% | 84/16 | 20 nm | 0.27 | 0.16 | 0.17 | AA | 50 | 0.4 | + |
| Comp. Ex. 7 | 3.0% | 15% | 100/0 | 20 nm | 0.27 | 0.16 | 0.16 | AA | 48 | 12.0 | print |
| | | | | | | | | | | | failure |
| Comp. Ex. 8 | — | 15% | 84/16 | 20 nm | 0.31 | 0.19 | 0.20 | BB | 42 | 2.0 | density |
| | | | | | | | | | | | unevenness |
| Comp. Ex. 9 | 3.0% | — | 84/16 | 20 nm | 0.32 | 0.19 | 0.20 | BB | 44 | 3.0 | density |
| | | | | | | | | | | | unevenness |
| Comp. | — | — | 84/16 | 20 nm | 0.42 | 0.27 | 0.26 | CC | 24 | 45.0 | print |
| Ex. 10 | | | | | | | | | | | failure |

^{*)}Represented in % by mass with respect to PVA resin
^{**)}Image quality evaluation after 30,000 prints

According to the results in Table 6, multi-color thermal recording materials of the invention, which have a protective layer including polyvinyl alcohol and two or more kinds of ultrafine inorganic particles with different average particle sizes, and further includes boric acid and a water-soluble zirconium compound (examples 6 and 7) had excellent glossiness and suppressed unevenness due to load change (unevenness in density). Further, the multi-color thermal recording materials of the invention (examples 6 and 7) showed reduced printing torque and reduced dirt of the thermal head, thereby being capable of printing high-quality image.

In contrast, the thermal recording material of the comparative example including ultrafine inorganic particles of one average particle size only in the protective layer (comparative example 7) was inferior in that dirt accumulated on the recording head and image quality was poor. The thermal recording materials of the comparative example not including boric acid and/or water-soluble zirconium compound (comparative examples 8 to 10) were insufficient in glossiness, exhibited unevenness due to load change and the printing torque was high, thereby being inferior in quality.

As explained in the foregoing, the present invention can provide a thermal recording material having high water-resistance and high glossiness, and is capable of preventing deterioration in the surface condition of an image, thereby stably outputting high-quality images.

Furthermore, the present invention can provide a thermal recording material which, when printing multiple times on the same surface at high speed and with high energy, provides high glossiness and is capable of reducing printing torque and unevenness in density, thereby enabling the recording of high-quality images.

Moreover, the present invention can provide a thermal recording material which, when printing multiple times on the same surface at high speed and with high energy, provides high glossiness and is capable of reducing printing torque, unevenness in the density, and dirt of the thermal head, thereby improving the durability thereof and recording high-quality images.

What is claimed is:

1. A thermal recording material comprising, on a support, at least a thermal recording layer and a protective layer containing a water-soluble resin, wherein the thermal recording material comprises a water-soluble or oil-soluble compound of a transition element of the group IV in the long-form periodic table.

2. The thermal recording material of claim 1, wherein the protective layer contains ultrafine inorganic particles.

3. The thermal recording material of claim 1, wherein the compound of a transition element of the group IV in the long-form periodic table is a water-soluble zirconium compound.

4. The thermal recording material of claim 3, wherein the water-soluble zirconium compound is contained in the protective layer in an amount of 0.1 to 25% by mass based on the water-soluble resin.

5. The thermal recording material of claim 1, wherein the water-soluble resin is a long-chain alkyl ether-modified polyvinyl alcohol.

6. The thermal recording material of claim 1, wherein water-soluble resin is a long-chain alkyl ether-modified polyvinyl alcohol, which is modified with an alkyl ether group having 8 to 20 carbon atoms.

7. The thermal recording material of claim 1, wherein the water-soluble resin is a long-chain alkyl ether-modified polyvinyl alcohol which comprises monomer units represented by the following general formulae (A-1) to (A-4): 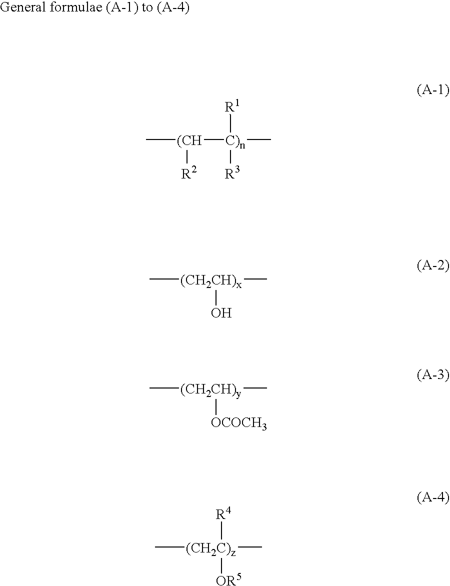
wherein in general formulae (A-1) to (A-4), R¹ represents a hydrogen atom, a methyl group or —CH₂CO₂M; R² represents a hydrogen atom, or —CO₂M; R³ represents a hydrogen atom, —CO₂M, an amino group, an amido group, a substituted amido group, a hydroxyl group, a glycidyl group, a sulfonic acid group, a polyethylene oxide group, a polypropylene oxide group or a group having at least one of these functional groups; R⁴ represents a hydrogen atom or a methyl group; R⁵ represents an alkyl group having 8 to 20 carbon atoms; M represents a hydrogen atom, an alkyl group, an aryl group, an aralkyl group, Na, K or Li; and n, x, y and z each represent a degree of polymerization.

8. A thermal recording material comprising, on a support, a thermal recording layer and a protective layer which comprises at least polyvinyl alcohol and ultrafine inorganic particles, wherein the thermal recording material comprises boric acid and a water-soluble zirconium compound.

9. The thermal recording material of claim 8, wherein the ultrafine inorganic particles are barium sulfate particles having an average particle size of 0.05 to 0.20 μm.

10. The thermal recording material of claim 8, wherein the polyvinyl alcohol is a long-chain alkyl ether-modified polyvinyl alcohol.

11. The thermal recording material of claim 8, wherein the polyvinyl alcohol is a long-chain alkyl ether-modified polyvinyl alcohol, which is modified with an alkyl ether group having 8 to 20 carbon atoms.

12. The thermal recording material of claim 8, wherein the polyvinyl alcohol is a long-chain alkyl ether-modified polyvinyl alcohol which comprises monomer units represented by the following general formulae (A-1) to (A-4): 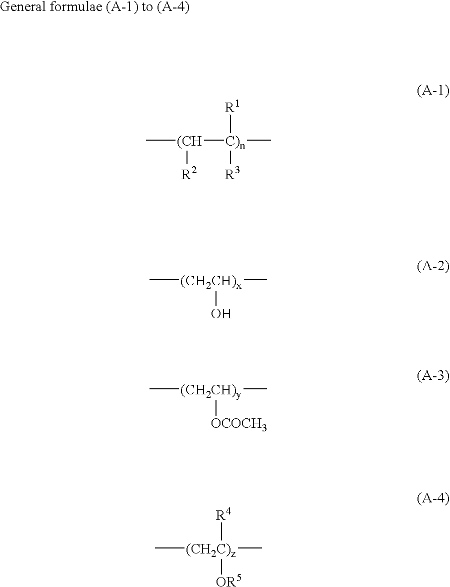
wherein in general formulae (A-1) to (A-4), R¹ represents a hydrogen atom, a methyl group or —CH₂CO₂M; R² represents a hydrogen atom, or —CO₂M; R³ represents a hydrogen atom, —CO₂M, an amino group, an amido group, a substituted amido group, a hydroxyl group, a glycidyl group, a sulfonic acid group, a polyethylene oxide group, a polypropylene oxide group or a group having at least one of these functional groups; R⁴ represents a hydrogen atom or a methyl group; R⁵ represents an alkyl group having 8 to 20 carbon atoms; M represents a hydrogen atom, an alkyl group, an aryl group, an aralkyl group, Na, K or Li; and n, x, y and z each represent a degree of polymerization.

13. The thermal recording material of claim 8, wherein a content of the boric acid is 10 to 30% by mass based on a content of the entire polyvinyl alcohol contained in a recording surface side of the thermal recording material, and a content of the water-soluble zirconium compound is 0.1 to 10% by mass based on a content of the entire polyvinyl alcohol contained in the recording surface side of the thermal recording material.

14. A thermal recording material comprising, on a support, a thermal recording layer and a protective layer which comprises at least polyvinyl alcohol and two or more kinds of ultrafine inorganic particles having different average particle sizes, wherein the thermal recording material further comprises boric acid and a water-soluble zirconium compound.

15. The thermal recording material of claim 14, wherein at least one kind of the ultrafine inorganic particles is colloidal silica having an average particle size of 10 to 50 nm.

16. The thermal recording material of claim 15, wherein the other kind of the ultrafine inorganic particles is barium sulfate particles having an average particle size of 0.05 to 0.20 nm, and a composition ratio of the colloidal silica to the barium sulfate is 8 to 24% by mass.

17. The thermal recording material of claim 14, wherein the polyvinyl alcohol is a long-chain alkyl ether-modified polyvinyl alcohol.

18. The thermal recording material of claim 14, wherein the polyvinyl alcohol is a long-chain alkyl ether-modified polyvinyl alcohol, which is modified with an alkyl ether group having 8 to 20 carbon atoms.

19. The thermal recording material of claim 14, wherein the polyvinyl alcohol is a long-chain alkyl ether-modified polyvinyl alcohol which is comprised monomer units represented by the following general formulae (A-1) to (A-4): 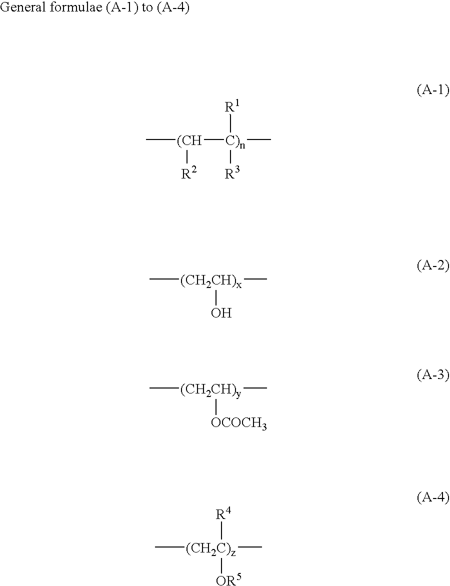
wherein in general formulae (A-1) to (A-4), R¹ represents a hydrogen atom, a methyl group or —CH₂CO₂M; R² represents a hydrogen atom, or —CO₂M; R³ represents a hydrogen atom, —CO₂M, an amino group, an amido group, a substituted amido group, a hydroxyl group, a glycidyl group, a sulfonic acid group, a polyethylene oxide group, a polypropylene oxide group or a group having at least one of these functional groups; R⁴ represents a hydrogen atom or a methyl group; R⁵ represents an alkyl group having 8 to 20 carbon atoms; M represents a hydrogen atom, an alkyl group, an aryl group, an aralkyl group, Na, K or Li; and n, x, y and z each represent a degree of polymerization.

20. The thermal recording material of claim 14, wherein a content of the boric acid is 10 to 30% by mass based on a content of the entire polyvinyl alcohol contained in a recording surface side of the thermal recording material, and a content of the water-soluble zirconium compound is 0.1 to 10% by mass based on a content of the entire polyvinyl alcohol contained in the recording surface side of the thermal recording material.
